(19) United States
(12) Patent Application Publication
(10) Pub. No.: US 2023/0212460 A1
(43) Pub. Date: Jul. 6, 2023

(54) COMPOSITION FOR FORMING PHOTO-ALIGNMENT FILM, PHOTO-ALIGNMENT FILM, AND OPTICAL LAMINATE

(71) Applicant: FUJIFILM Corporation, Tokyo (JP)

(72) Inventors: Hiroshi MATSUYAMA, Kanagawa (JP); Yoshiaki TAKADA, Kanagawa (JP); Wataru HOSHINO, Kanagawa (JP); Naoki KOITO, Kanagawa (JP)

(73) Assignee: FUJIFILM Corporation, Tokyo (JP)

(21) Appl. No.: 18/185,055

(22) Filed: Mar. 16, 2023

Related U.S. Application Data
(63) Continuation of application No. PCT/JP2021/034718, filed on Sep. 22, 2021.

(30) Foreign Application Priority Data
Sep. 30, 2020 (JP) 2020-165235

(51) Int. Cl. C09K 19/56; C08F 220/32; G02B 5/30

(52) U.S. Cl. CPC C09K 19/56; C08F 220/32; G02B 5/3016

(57) ABSTRACT

Provided is a composition for forming a photo-alignment film that improves a surface state of a liquid crystal layer having excellent liquid crystal alignment properties of the liquid crystal layer provided on a photo-alignment film, and an optical laminate formed of the composition. The composition includes a polymer A which has a repeating unit A1 containing a photo-aligned group and a repeating unit A2 containing a cationically polymerizable group, a polymer B which has a repeating unit B1 containing a cationically polymerizable group and does not contain a photo-aligned group, and at least one acid generator selected from the group consisting of a photoacid generator and a thermal acid generator, in which the polymer B has 90% by mass or greater of a repeating unit, in which a hydrogen bond element of a Hansen solubility parameter is less than 10.0, with respect to all repeating units of the polymer B.

### CROSS-REFERENCE TO RELATED APPLICATIONS

This application is a Continuation of PCT International Application No. PCT/JP2021/034718 filed on Sep. 22, 2021, which claims priority under 35 U.S.C. § 119(a) to Japanese Patent Application No. 2020-165235 filed on Sep. 30, 2020. The above applications are hereby expressly incorporated by reference, in its entirety, into the present application.

### BACKGROUND OF THE INVENTION

### 1. Field of the Invention

The present invention relates to a composition for forming a photo-alignment film, a photo-alignment film, and an optical laminate.

### 2. Description of the Related Art

Optical films such as optical compensation sheets and phase difference films are used in various image display devices from the viewpoints of eliminating image coloration and expanding a viewing angle.

A stretched birefringence film has been used as an optical film. However, in recent years, it has been suggested to use an optically anisotropic layer formed of a liquid crystal compound in place of the stretched birefringence film.

Such an optically anisotropic layer is known to be provided with an alignment film on a support that forms an optically anisotropic layer to align a liquid crystal compound, and a photo-alignment film subjected to a photo-alignment treatment in place of a rubbing treatment is known as the alignment film.

For example, WO2019/225632A describes a photo-alignment film which has a repeating unit A containing a predetermined photo-aligned group and a repeating unit B containing a predetermined crosslinkable group and is formed of a composition for forming a photo-alignment film which contains a photo-aligned copolymer ([Claim 1] and [Claim 17]).

### SUMMARY OF THE INVENTION

As a result of examination on the photo-alignment film described in WO2019/225632A, the present inventors found that a liquid crystal layer provided on the photo-alignment film has excellent aligning properties (hereinafter, also referred to as “liquid crystal alignment properties”), but there is room for improvement in the surface state of the liquid crystal layer provided on the photo-alignment film depending on the composition of the composition for forming a photo-alignment film.

Therefore, an object of the present invention is to provide a composition for forming a photo-alignment film which is capable of improving a surface state of a liquid crystal layer while maintaining excellent liquid crystal alignment properties of the liquid crystal layer provided on a photo-alignment film, and a photo-alignment film and an optical laminate which are formed of the composition.

As a result of intensive examination conducted by the present inventors in order to achieve the above-described object, it was found that the above-described object can be achieved by using a composition for forming a photo-alignment film obtained by blending a polymer A (copolymer) which has a repeating unit containing a photo-aligned group and a repeating unit containing a cationically polymerizable group with a specific polymer B which has a repeating unit containing a cationically polymerizable group and does not contain a photo-aligned group, thereby completing the present invention.

That is, the present inventors found that the above-described object can be achieved by employing the following configurations.

[1] A composition for forming a photo-alignment film, comprising: a polymer A which has a repeating unit A1 containing a photo-aligned group and a repeating unit A2 containing a cationically polymerizable group; a polymer B which has a repeating unit B1 containing a cationically polymerizable group but does not contain a photo-aligned group; and at least one acid generator selected from the group consisting of a photoacid generator and a thermal acid generator, in which the polymer B has 90% by mass or greater of a repeating unit, in which a hydrogen bond element of a Hansen solubility parameter is less than 10.0, with respect to all repeating units of the polymer B.

[2] The composition for forming a photo-alignment film according to [1], in which the photo-aligned group contained in the repeating unit A1 is a cinnamoyl group.

[3] The composition for forming a photo-alignment film according to [1] or [2], in which the cationically polymerizable group of the repeating unit B1 is an epoxy group or an oxetanyl group.

[4] The composition for forming a photo-alignment film according to any one of [1] to [3], in which the polymer B has greater than 60% by mass of a repeating unit, in which a dispersion element of the Hansen solubility parameter is 16.0 or greater, with respect to all repeating units of the polymer B.

[5] The composition for forming a photo-alignment film according to any one of [1] to [4], in which the polymer B has 10% by mass or greater of a repeating unit having a Log P value of 2.2 or greater, with respect to all repeating units of the polymer B.

[6] The composition for forming a photo-alignment film according to any one of [1] to [5], in which a content of the polymer B is greater than 40 parts by mass with respect to 100 parts by mass of the polymer A.

[7] The composition for forming a photo-alignment film according to any one of [1] to [6], in which the polymer B has 10% by mass or greater of a repeating unit, in which the hydrogen bond element of the Hansen solubility parameter is 7.0 or greater and less than 10.0, with respect to all repeating units of the polymer B.

[8] The composition for forming a photo-alignment film according to any one of [1] to [7], in which the repeating unit B1 is a repeating unit represented by any of Formulae (1) to (4).

[9] The composition for forming a photo-alignment film according to any one of [1] to [8], in which the repeating unit B1 is a repeating unit represented by any of Formulae (5) to (7).

[10] A photo-alignment film which is formed of the composition for forming a photo-alignment film according to any one of [1] to [9].

[11] An optical laminate comprising: a photo-alignment film; and a liquid crystal layer, in which the photo-alignment film is the photo-alignment film according to [10], and the liquid crystal layer is a light absorption anisotropic layer containing a dichroic substance.

According to the present invention, it is possible to provide a composition for forming a photo-alignment film which is capable of improving a surface state of a liquid crystal layer while maintaining excellent liquid crystal alignment properties of the liquid crystal layer provided on a photo-alignment film, and a photo-alignment film and an optical laminate which are formed of the composition.

### DESCRIPTION OF THE PREFERRED EMBODIMENTS

Hereinafter, the present invention will be described in detail.

The description of constituent requirements described below may be made based on typical embodiments of the present invention, but the present invention is not limited to such embodiments.

In addition, in the present specification, a numerical range shown using “to” indicates a range including numerical values described before and after “to” as a lower limit and an upper limit.

Further, in the present specification, the terms parallel, orthogonal, horizontal, and vertical do not indicate parallel, orthogonal, horizontal, and vertical in a strict sense, but indicate a range of parallel ±10°, a range of orthogonal ±10°, a range of horizontal ±10°, and a range of vertical ±10° respectively.

Further, in the present specification, materials corresponding to respective components may be used alone or in combination of two or more kinds thereof. Here, in a case where two or more kinds of substances corresponding to respective components are used in combination, the content of the components indicates the total content of the combined substances unless otherwise specified.

Further, in the present specification, “(meth)acrylate” is a notation representing “acrylate” or “methacrylate”, “(meth)acryl” is a notation representing “acryl” or “methacryl”, and “(meth)acryloyl” is a notation representing “acryloyl” or “methacryloyl”.

[Composition for Forming Photo-Alignment Film]

A composition for forming a photo-alignment film according to the embodiment of the present invention is a composition including a polymer A which has a repeating unit A1 containing a photo-aligned group and a repeating unit A2 containing a cationically polymerizable group, a polymer B which has a repeating unit containing a cationically polymerizable group and does not contain a photo-aligned group, and at least one acid generator selected from the group consisting of a photoacid generator and a thermal acid generator.

Further, the composition for forming a photo-alignment film according to the embodiment of the present invention is a composition in which the polymer B has 90% by mass or greater of a repeating unit, in which a hydrogen bond element of a Hansen solubility parameter is less than 10.0, with respect to all repeating units of the polymer B.

Here, the details of the Hansen solubility parameter (hereinafter, also referred to as “HSP value”) are described in Hansen, Charles (2007), Hansen Solubility Parameters: A user's handbook, Second Edition. Boca Raton, Fla.: CRC Press. ISBN 9780849372483.

Further, a hydrogen bond element (δh), a dispersion element (δd), and a polarity element (δp) of the HSP value are calculated by inputting a structural formula of a compound into the following software. As the software, Hansen Solubility Parameters in Practice (HSPiP) ver 4.1.07 is used.

In the present invention, excellent liquid crystal alignment properties of a liquid crystal layer provided on a photo-alignment film to be formed are maintained and the surface state is also enhanced by using a composition for forming a photo-alignment film which contains the polymer A and the polymer B.

The reason for this is not clear, but the present inventors presume as follows.

That is, in the polymer A and the polymer B contained in the composition for forming a photo-alignment film according to the embodiment of the present invention, the present inventors have considered that in a case where the polymer B has 90% by mass or greater of a repeating unit, in which the hydrogen bond element of the HSP value is less than 10.0, with respect to all repeating units, a larger amount of the polymer B is present in a lower portion (base material side) of the polymer A, the photo-aligned group of the polymer A is uniformly aligned on the surface of the photo-alignment film (air interface side), and as a result, excellent liquid crystal alignment properties of the liquid crystal layer provided on the photo-alignment film are maintained and the surface state is also enhanced.

[Polymer A]

The polymer A contained in the composition for forming a photo-alignment film according to the embodiment of the present invention is a copolymer having a repeating unit A1 containing a photo-aligned group and a repeating unit A2 containing a cationically polymerizable group.

<Repeating Unit A1 (Photo-Aligned Group)>

From the viewpoint of enhancing the thermal stability and the chemical stability of a monomer containing a photo-aligned group, a group in which at least of dimerization or isomerization occurs due to an action of light is preferable as the photo-aligned group contained in the repeating unit A1.

Specific suitable examples of the group that is dimerized due to an action of light include a group having a skeleton of at least one derivative selected from the group consisting of a cinnamic acid derivative, a coumarin derivative, a chalcone derivative, a maleimide derivative, and a benzophenone derivative.

In addition, specific suitable examples of the group that is isomerized due to an action of light include a group having a skeleton of at least one compound selected from the group consisting of an azobenzene compound, a stilbene compound, a spiropyran compound, a cinnamic acid compound, and a hydrazono-p-ketoester compound.

Among the above-described photo-aligned groups, a group having a skeleton of at least one derivative or compound selected from the group consisting of a cinnamic acid derivative, a coumarin derivative, a chalcone derivative, a maleimide derivative, an azobenzene compound, a stilbene compound, and a spiropyran compound is preferable, a group having a skeleton of a cinnamic acid derivative or an azobenzene compound is more preferable, and a group having a skeleton of a cinnamic acid derivative (hereinafter, also referred to as “cinnamoyl group”) is still more preferable.

The structure of the main chain of the repeating unit A1 containing a photo-aligned group is not particularly limited, and examples thereof include known structures. Preferred examples of the known structures include a skeleton selected from the group consisting of a (meth)acrylic skeleton, a styrene-based skeleton, a siloxane-based skeleton, a cycloolefin-based skeleton, a methylpentene-based skeleton, an amide-based skeleton, and an aromatic ester-based skeleton.

Among these, a skeleton selected from the group consisting of a (meth)acrylic skeleton, a siloxane-based skeleton, and a cycloolefin-based skeleton is more preferable, and a (meth)acrylic skeleton is still more preferable.

From the viewpoint of further enhancing the liquid crystal alignment properties, a repeating unit represented by Formula (A) is preferable as the repeating unit A1 containing a photo-aligned group.

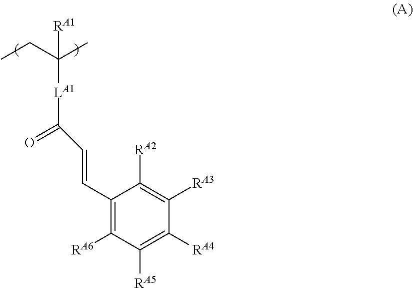

In Formula (A), R^{A1} represents a hydrogen atom or a substituent.

Further, L^{A1} represents a single bond or a divalent linking group.

Further, R^{A2}, R^{A3}, R^{A4}, R^{A5}, and R^{A6} each independently represent a hydrogen atom or a substituent. Two adjacent groups from among R^{A2}, R^{A3}, R^{A4}, R^{A5}, and R^{A6} may be bonded to each other to form a ring.

In Formula (A), R^{A1} represents a hydrogen atom or a substituent.

The kind of the substituent represented by an aspect of R^{A1} is not particularly limited, and examples thereof include known substituents.

Examples of the substituent include a monovalent aliphatic hydrocarbon group and a monovalent aromatic hydrocarbon group, and more specific examples thereof include an alkyl group, an alkenyl group, an alkynyl group, an aryl group, an amino group, an alkoxy group, an aryloxy group, an aromatic heterocyclic oxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, an aromatic heterocyclic thio group, a sulfonyl group, a sulfinyl group, a ureido group, a phosphoric acid amide group, a hydroxy group, a mercapto group, a halogen atom, a cyano group, a sulfo group, a carboxyl group, a nitro group, a hydroxamic acid group, a sulfino group, a hydrazino group, an imino group, a heterocyclic group (such as a heteroaryl group), a silyl group, and a group obtained by combining these groups. Further, the substituent may be further substituted with a substituent.

Among the substituents represented by an aspect of R^{A1}, an alkyl group is preferable, and a methyl group is more preferable.

Further, it is preferable that R^{A1} represents a hydrogen atom or a methyl group.

In Formula (A), L^{A1} represents a single bond or a divalent linking group.

Examples of the divalent linking group represented by an aspect of L^{A1} include a divalent hydrocarbon group which may have a substituent, a divalent heterocyclic group, —O—, —S—, —N(Q)-, —CO—, and a group obtained by combining these groups. Q represents a hydrogen atom or a substituent.

Examples of the divalent hydrocarbon group include a divalent aliphatic hydrocarbon group such as an alkylene group having 1 to 10 carbon atoms (preferably 1 to 5 carbon atoms), an alkenylene group having 1 to 10 carbon atoms, or an alkynylene group having 1 to 10 carbon atoms, and a divalent aromatic hydrocarbon group such as an arylene group.

Examples of the divalent heterocyclic group include a divalent aromatic heterocyclic group, and specific examples thereof include a pyridylene group (pyridine-diyl group), a pyridazine-diyl group, an imidazole-diyl group, a thienylene group (thiophene-diyl group), and a quinolylene group (quinoline-diyl group).

Further, examples of the group obtained by combining these groups include a group obtained by combining at least two or more selected from the group consisting of a divalent hydrocarbon group, a divalent heterocyclic group, —O—, —S—, —N(Q)-, and —CO—, and specific examples thereof include —O-divalent hydrocarbon group-, —(O-divalent hydrocarbon group)ₚ-O— (p represents an integer of 1 or greater), and -divalent hydrocarbon group-O—CO—.

From the viewpoint of enhancing the liquid crystal alignment properties, among the above-described divalent linking groups, a divalent linking group obtained by combining at least two or more groups selected from the group consisting of a linear alkylene group having 1 to 10 carbon atoms which may have a substituent, a branched alkylene group having 3 to 10 carbon atoms which may have a substituent, a cyclic alkylene group having 3 to 10 carbon atoms which may have a substituent, an arylene group having 6 to 12 carbon atoms which may have a substituent, —O—, —CO—, and —N(Q)- is preferable. Q represents a hydrogen atom or a substituent.

Here, examples of the substituent that the alkylene group and the arylene group may have and the substituent represented by Q include a halogen atom, an alkyl group, an alkoxy group, an aryl group, an aryloxy group, a cyano group, a carboxy group, an alkoxycarbonyl group, and a hydroxyl group.

Examples of the halogen atom include a fluorine atom, a chlorine atom, a bromine atom, and an iodine atom. Among these, a fluorine atom or a chlorine atom is preferable.

As the alkyl group, for example, a linear alkyl group having 1 to 18 carbon atoms, a branched chain-like alkyl group having 3 to 18 carbon atoms, or a cyclic alkyl group having 3 to 18 carbon atoms is preferable, a linear alkyl group having 1 to 8 carbon atoms, a branched chain-like alkyl group having 3 to 8 carbon atoms, or a cyclic alkyl group having 3 to 8 carbon atoms (such as a methyl group, an ethyl group, a propyl group, an isopropyl group, an n-butyl group, an isobutyl group, a sec-butyl group, a t-butyl group, or a cyclohexyl group) is more preferable, a linear alkyl group having 1 to 4 carbon atoms is still more preferable, and a methyl group or an ethyl group is particularly preferable.

As the alkoxy group, for example, an alkoxy group having 1 to 18 carbon atoms is preferable, an alkoxy group having 1 to 8 carbon atoms (such as a methoxy group, an ethoxy group, an n-butoxy group, or a methoxyethoxy group) is more preferable, an alkoxy group having 1 to 4 carbon atoms is still more preferable, and a methoxy group or an ethoxy group is particularly preferable.

Examples of the aryl group include an aryl group having 6 to 12 carbon atoms, and specific examples thereof include a phenyl group, an α-methylphenyl group, and a naphthyl group. Among these, a phenyl group is preferable.

Examples of the aryloxy group include a phenoxy group, a naphthoxy group, an imidazolyloxy group, a benzoimidazoyloxy group, a pyridine-4-yloxy group, a pyrimidinyloxy group, a quinazolinyloxy group, a prinyloxy group, and a thiophene-3-yloxy group.

Examples of the alkoxycarbonyl group include a methoxycarbonyl group and an ethoxycarbonyl group.

Examples of the linear alkylene group having 1 to 10 carbon atoms which may have a substituent include a methylene group, an ethylene group, a propylene group, a butylene group, a pentylene group, a hexylene group, and a decylene group.

Examples of the branched chain-like alkylene group having 3 to 10 carbon atoms which may have a substituent include a dimethylmethylene group, a methylethylene group, a 2,2-dimethylpropylene group, and a 2-ethyl-2-methylpropylene group.

Examples of the cyclic alkylene group having 3 to 10 carbon atoms which may have a substituent include a cyclopropylene group, a cyclobutylene group, a cyclopentylene group, a cyclohexylene group, a cyclooctylene group, a cyclodecylene group, an adamantane-diyl group, a norbornane-diyl group, and an exo-tetrahydrodicyclopentadiene-diyl group.

Examples of the arylene group having 6 to 12 carbon atoms include a phenylene group, a xylylene group, a biphenylene group, a naphthylene group, and a 2,2′-methylenebisphenyl group. Among these, a phenylene group is preferable.

Among these, from the viewpoint of further enhancing the liquid crystal alignment properties, as L^{A1} in Formula (A), a divalent linking group containing at least any of a linear alkylene group having 1 to 10 carbon atoms which may have a substituent, a cyclic alkylene group having 3 to 10 carbon atoms which may have a substituent, or an arylene group having 6 to 12 carbon atoms which may have a substituent is preferable, a divalent linking group containing at least a linear alkylene group having 1 to 10 carbon atoms which may have a substituent or a cyclic alkylene group having 3 to 10 carbon atoms which may have a substituent is more preferable, and a divalent linking group containing an unsubstituted linear alkylene group having 2 to 6 carbon atoms or unsubstituted trans-1,4-cyclohexylene is still more preferable.

Further, in a case where a divalent linking group containing at least a linear alkylene group having 1 to 10 carbon atoms which may have a substituent is compared with a divalent linking group containing at least a cyclic alkylene group having 3 to 10 carbon atoms which may have a substituent, the effects are more excellent in the case of the divalent linking group containing at least a cyclic alkylene group having 3 to 10 carbon atoms which may have a substituent.

In Formula (A), R^{A2}, R^{A3}, R^{A4}, R^{A5}, and R^{A6} each independently represent a hydrogen atom or a substituent. The kind of the substituent is not particularly limited, and examples thereof include known substituents such as the groups exemplified as the substituent represented by an aspect of R^{A1}.

Two adjacent groups from among R^{A2}, R^{A3}, R^{A4}, R^{A5}, and R^{A6} may be bonded to each other to form a ring.

From the viewpoint of further enhancing the liquid crystal alignment properties, as the substituents represented by R^{A2}, R^{A3}, R^{A4}, R^{A5}, and R^{A6}, each independently, a halogen atom, a linear alkyl group having 1 to 20 carbon atoms, a branched chain-like or cyclic alkyl group having 3 to 20 carbon atoms, a linear halogenated alkyl group having 1 to 20 carbon atoms, an alkoxy group having 1 to 20 carbon atoms, an aryl group having 6 to 20 carbon atoms, an aryloxy group having 6 to 20 carbon atoms, a hydroxy group, a cyano group, an amino group, or a group represented by Formula (4) is preferable. Further, the substituent may contain a linking group represented by —(CH₂)ₙₐ— or —O—(CH₂)ₙₐ—. na represents an integer of 1 to 10.

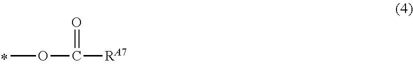

Here, in Formula (4), * represents a bonding position.

R^{A7} represents a monovalent organic group.

Examples of the halogen atom include a fluorine atom, a chlorine atom, a bromine atom, and an iodine atom. Among these, a fluorine atom or a chlorine atom is preferable.

An alkyl group having 1 to 6 carbon atoms is preferable as the linear alkyl group, and examples thereof include a methyl group, an ethyl group, and an n-propyl group.

An alkyl group having 3 to 6 carbon atoms is preferable as the branched chain-like alkyl group, and examples thereof include an isopropyl group and a tert-butyl group.

An alkyl group having 3 to 6 carbon atoms is preferable as the cyclic alkyl group, and examples thereof include a cyclopropyl group, a cyclopentyl group, and a cyclohexyl group.

As the linear halogenated alkyl group having 1 to 20 carbon atoms, a fluoroalkyl group having 1 to 4 carbon atoms is preferable, and examples thereof include a trifluoromethyl group, a perfluoroethyl group, a perfluoropropyl group, a perfluorobutyl group, a 2,2,3,3,4,4,5,5-octafluoropentyl group, and a 2,2,3,3,4,4,5,5,6,6,7,7-dodecafluoroheptyl group. Among these, from the viewpoint of enhancing both the liquid crystal alignment properties and the upper layer coating properties, a 2,2,3,3,4,4,5,5-octafluoropentyl group or a 2,2,3,3,4,4,5,5,6,6,7,7-dodecafluoroheptyl group is preferable.

As the alkoxy group having 1 to 20 carbon atoms, an alkoxy group having 1 to 18 carbon atoms is preferable, an alkoxy group having 3 to 18 carbon atoms is more preferable, and an alkoxy group having 6 to 18 carbon atoms is still more preferable. Examples thereof include a methoxy group, an ethoxy group, an n-butoxy group, a methoxyethoxy group, an n-hexyloxy group, an n-octyloxy group, an n-decyloxy group, an n-dodecyloxy group, and an n-tetradecyloxy group.

Further, an aryl group having 6 to 12 carbon atoms is preferable as the aryl group having 6 to 20 carbon atoms, and examples thereof include a phenyl group, an α-methylphenyl group, and a naphthyl group.

An aryloxy group having 6 to 12 carbon atoms is preferable as the aryloxy group having 6 to 20 carbon atoms, and examples thereof include a phenyloxy group and a 2-naphthyloxy group.

Examples of the amino group include a primary amino group (—NH₂), a secondary amino group such as a methylamino group, and a tertiary amino group such as a dimethylamino group, a diethylamino group, a dibenzylamino group, or a group having a nitrogen atom of a nitrogen-containing heterocyclic compound (for example, pyrrolidine, piperidine, or piperazine) as a bonding site.

Examples of the monovalent organic group represented by R^{A7} in Formula (4) include a linear or cyclic alkyl group having 1 to 20 carbon atoms.

As the linear alkyl group, an alkyl group having 1 to 6 carbon atoms is preferable, and examples thereof include a methyl group, an ethyl group, and an n-propyl group. Among these, a methyl group or an ethyl group is preferable.

As the cyclic alkyl group, an alkyl group having 3 to 6 carbon atoms is preferable, and examples thereof include a cyclopropyl group, a cyclopentyl group, and a cyclohexyl group. Among these, a cyclohexyl group is preferable.

Further, as the monovalent organic group represented by R^{A7} in Formula (4), a group obtained by combining a plurality of the linear alkyl groups and a plurality of the cyclic alkyl groups described above directly or via a single bond may be used.

It is preferable that at least R^{A4} from among R^{A2}, R^{A3}, R^{A4}, R^{A5}, and R^{A6} in Formula (A) represents the above-described substituent (preferably an alkoxy group having 1 to 20 carbon atoms or a halogenated alkyl group) from the viewpoint that the photo-aligned group easily interacts with the liquid crystal compound and the liquid crystal alignment properties are further enhanced and more preferable that all R^{A2}, R^{A3}, R^{A5}, and R^{A6} represent a hydrogen atom from the viewpoint that the linearity of a photo-aligned polymer to be obtained is improved, the photo-aligned polymer easily interacts with the liquid crystal compound, and the liquid crystal alignment properties are further enhanced.

From the viewpoint of improving the reaction efficiency of the photo-aligned group, it is preferable that R^{A4} in Formula (A) represents an electron-donating substituent.

Here, the electron-donating substituent (electron-donating group) is a substituent having a Hammett's value (Hammett's substituent constant σp value) of 0 or less, and among the above-described substituents, an alkyl group, a halogenated alkyl group, and an alkoxy group are exemplified.

Among these, from the viewpoint of further enhancing the liquid crystal alignment properties, an alkoxy group is preferable, an alkoxy group having 4 to 18 carbon atoms is more preferable, an alkoxy group having 6 to 18 carbon atoms is still more preferable, and an alkoxy group having 8 to 18 carbon atoms is particularly preferable.

Specific examples of the repeating unit A1 containing a photo-aligned group include repeating units represented by Formulae A-1 to A-30.

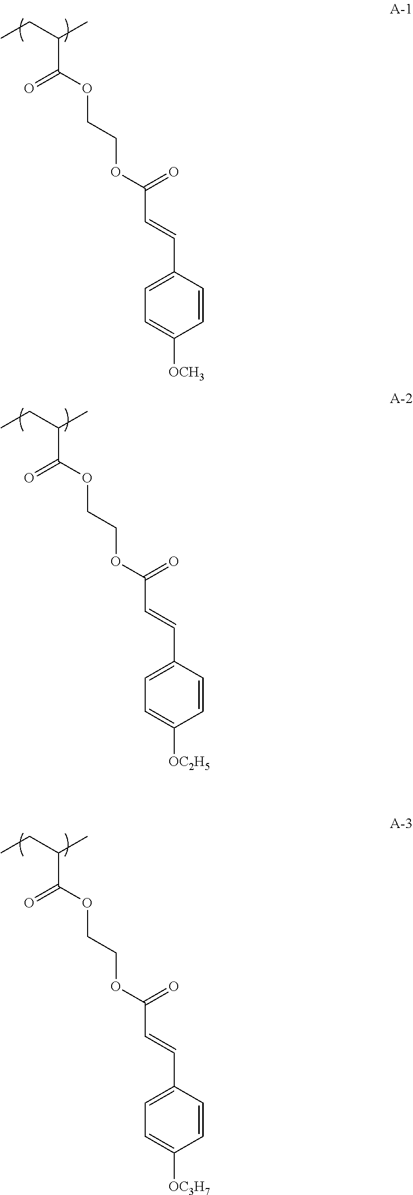

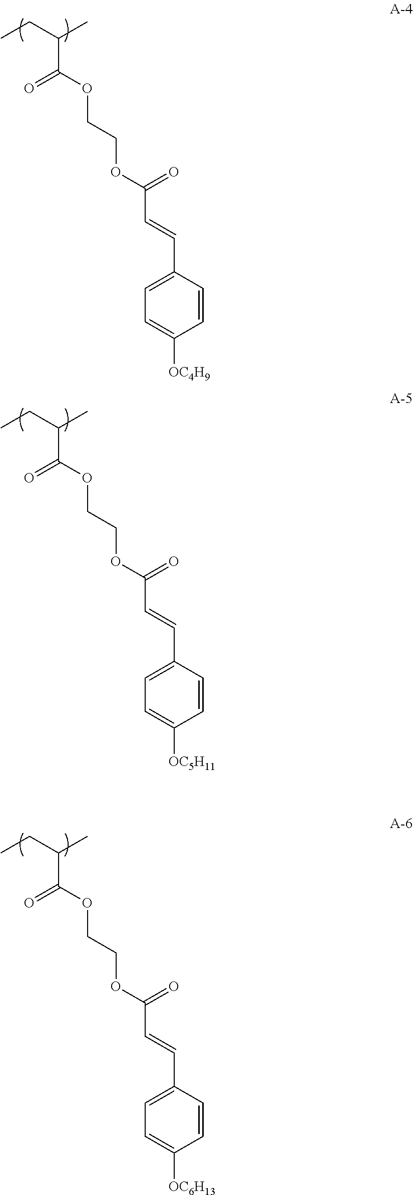

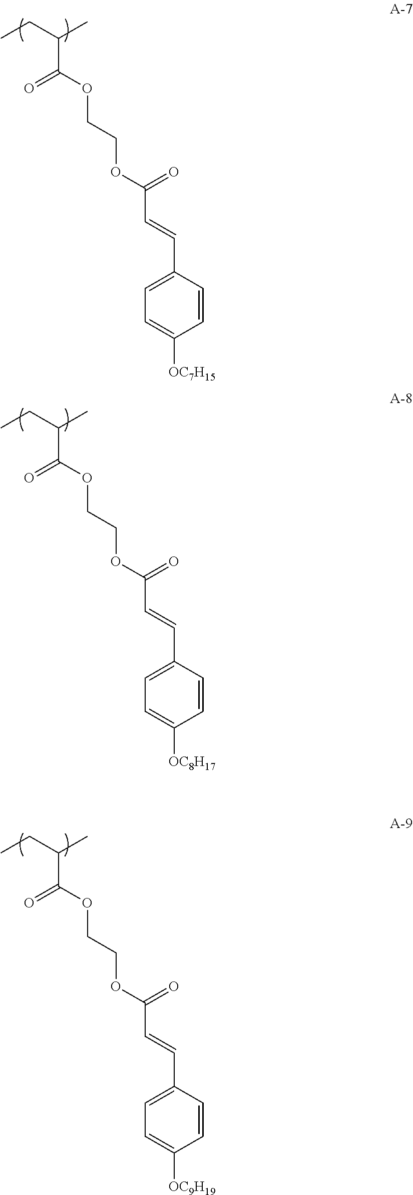

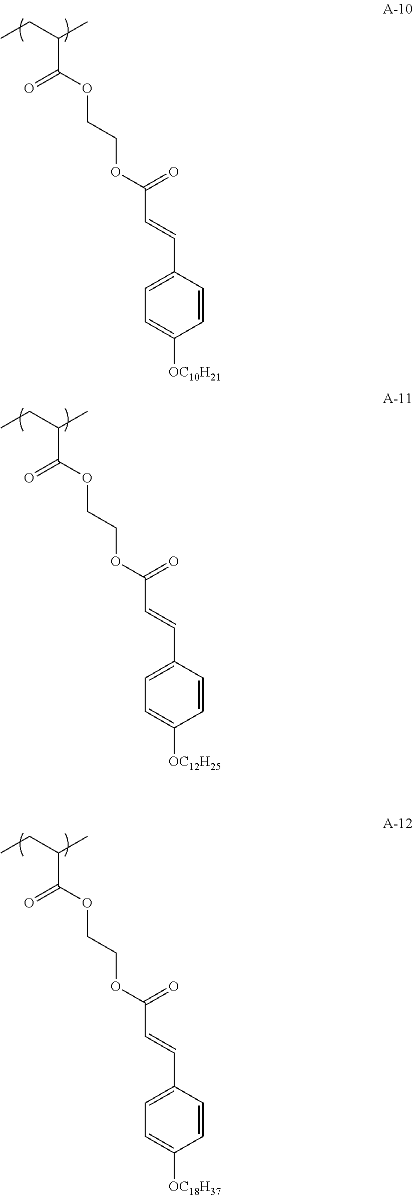

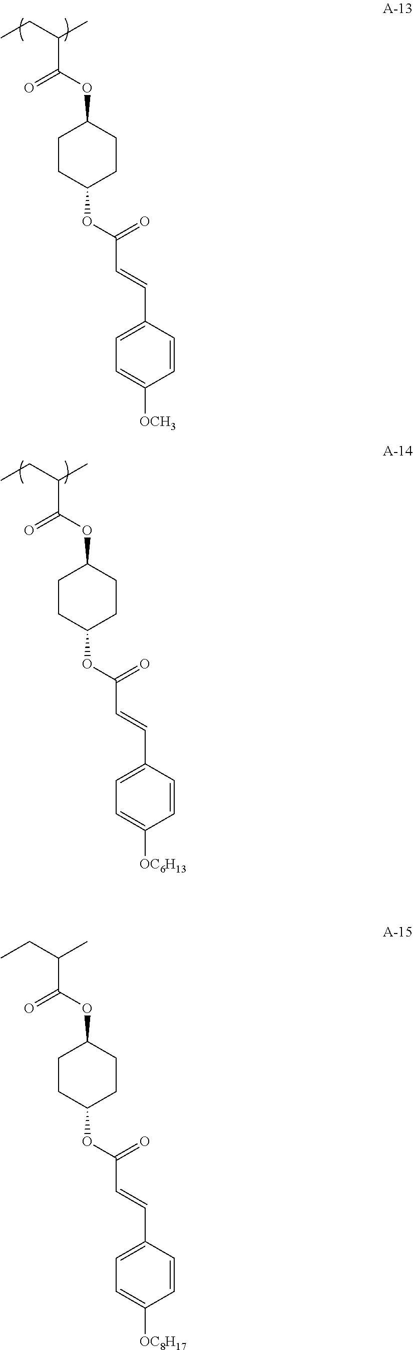

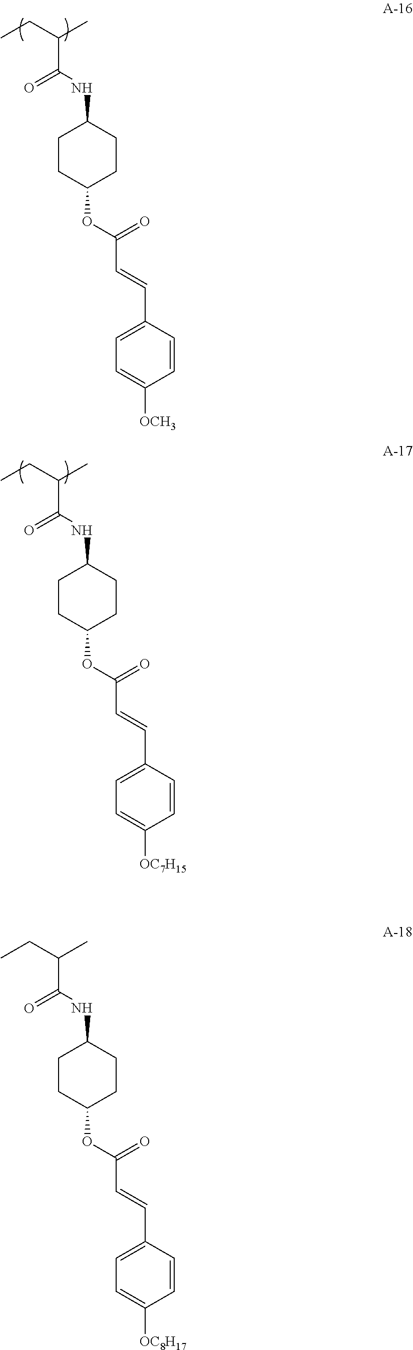

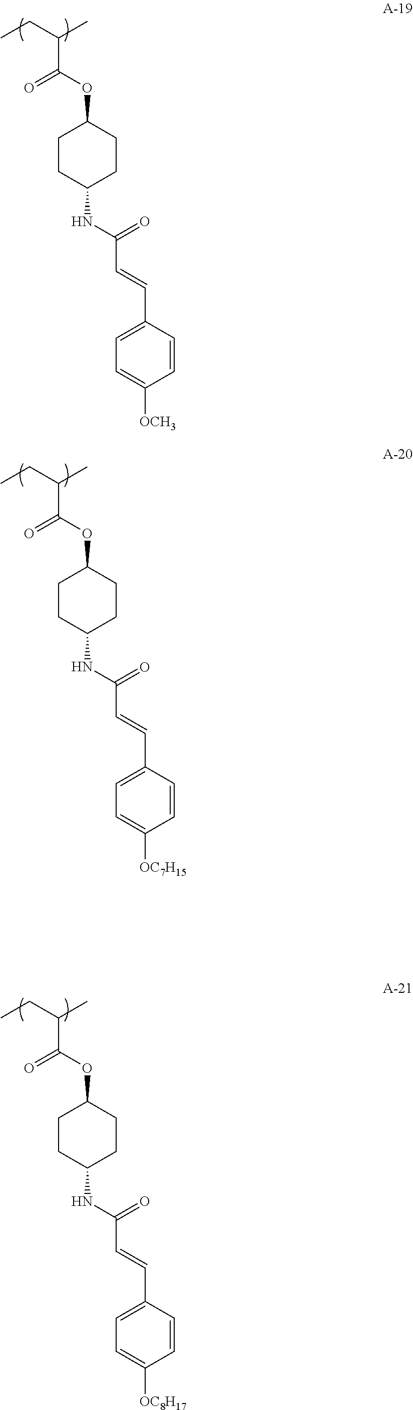

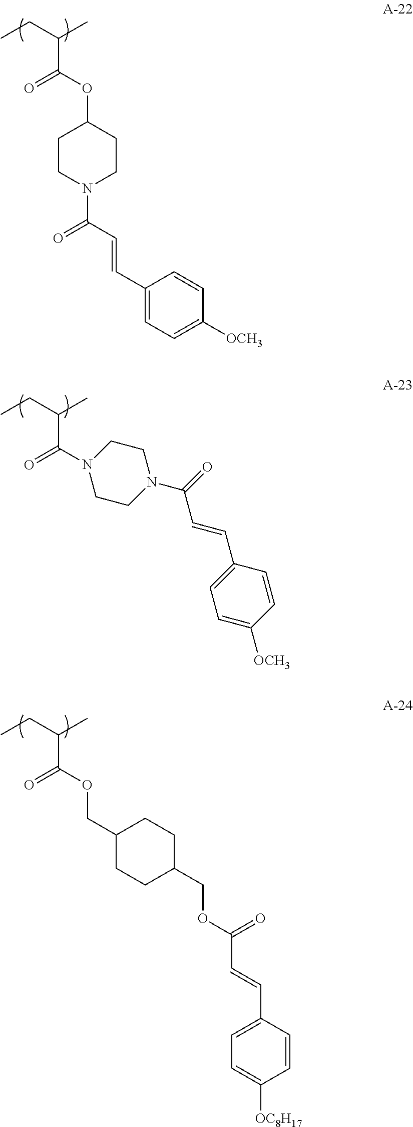

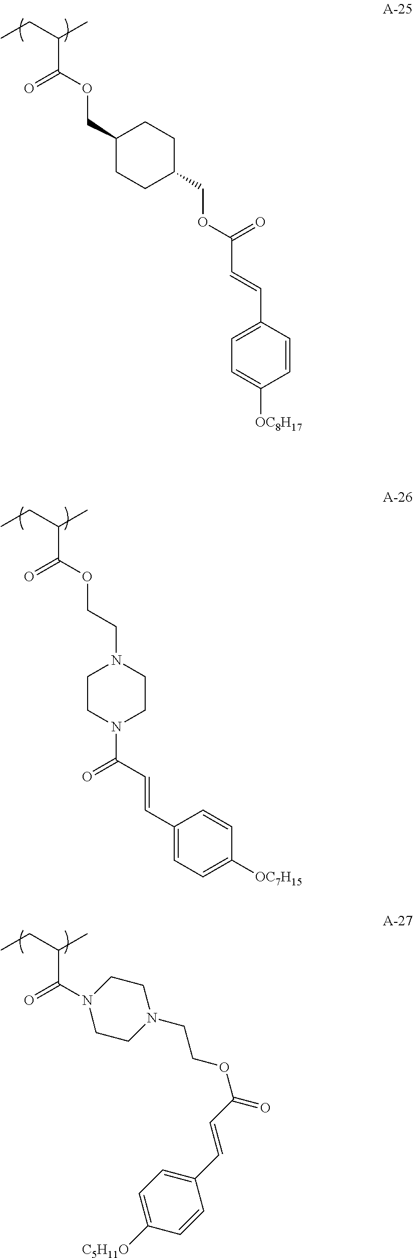

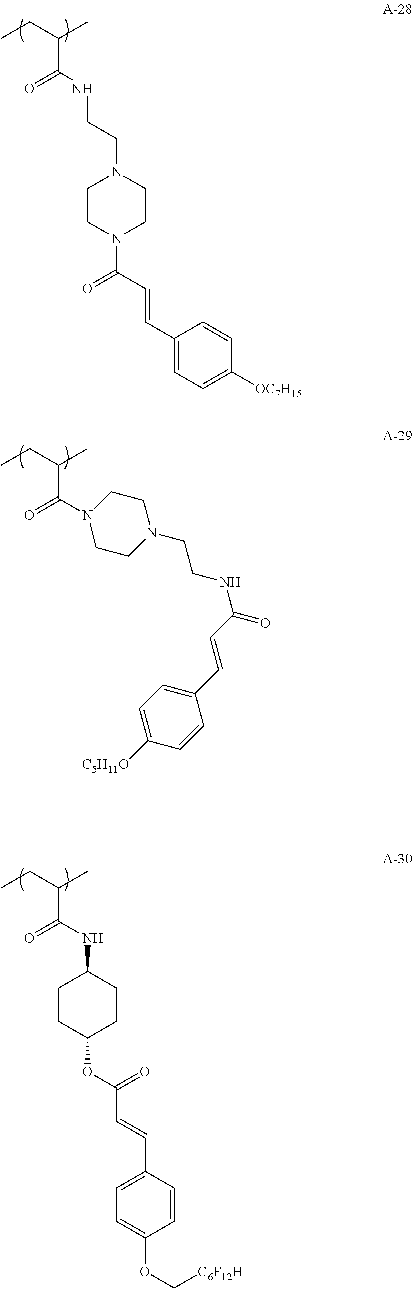

The content of the repeating unit A1 in the polymer A is not particularly limited, but is preferably in a range of 5% to 50% by mass and more preferably in a range of 10% to 40% by mass with respect to all the repeating units of the polymer A from the viewpoint of further enhancing the liquid crystal alignment properties.

<Repeating Unit A2 (Cationically Polymerizable Group)>

Examples of the cationically polymerizable group of the repeating unit A2 include an epoxy group, an epoxycyclohexyl group, and an oxetanyl group, and a group represented by any of Formulae (C1) to (C3) is preferable.

Further, * in Formulae (C1) to (C3) represents a bonding position, and R^{C2} in Formula (C3) represents a hydrogen atom, a methyl group, or an ethyl group.

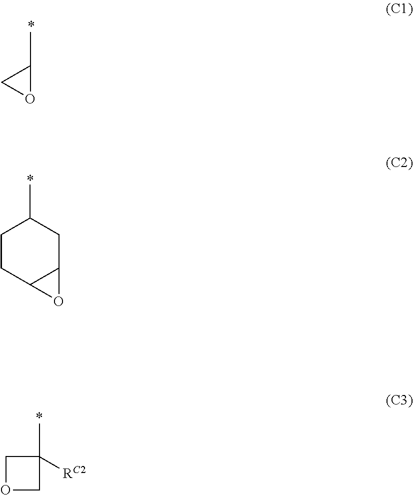

The structure of the main chain of the repeating unit A2 containing a cationically polymerizable group is not particularly limited, and examples thereof include known structures. Preferred examples of the known structures include a skeleton selected from the group consisting of a (meth)acrylic skeleton, a styrene-based skeleton, a siloxane-based skeleton, a cycloolefin-based skeleton, a methylpentene-based skeleton, an amide-based skeleton, and an aromatic ester-based skeleton.

Among these, a skeleton selected from the group consisting of a (meth)acrylic skeleton, a siloxane-based skeleton, and a cycloolefin-based skeleton is more preferable, and a (meth)acrylic skeleton is still more preferable.

From the viewpoint of further enhancing the liquid crystal alignment properties, a repeating unit represented by Formula (C) is preferable as the repeating unit A2 containing a cationically polymerizable group.

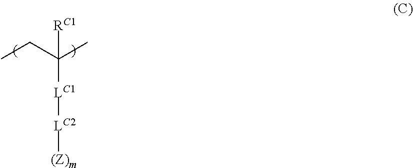

In Formula (C), R^{C1} represents a hydrogen atom or a substituent.

Further, L^{C1} represents a single bond or a divalent linking group.

Further, L^{C2} represents an (m+1)-valent linking group.

Further, Z represents a cationically polymerizable group.

Further, m represents an integer of 1 or greater, and in a case where m represents an integer of 2 or greater, a plurality of Z's may be the same as or different from each other.

In Formula (C), R^{C1} represents a hydrogen atom or a substituent.

Examples of the substituent represented by an aspect of R^{C1} include the groups exemplified as the substituent represented by an aspect of R^{A1} in Formula (A). Among these, an alkyl group is preferable, and a methyl group is more preferable.

Further, it is preferable that R^{C1} represents a hydrogen atom or a methyl group.

In Formula (C), L^{C1} represents a single bond or a divalent linking group.

Examples of the divalent linking group represented by an aspect of L^{C1} include those exemplified as the divalent linking group represented by an aspect of L^{A1} in Formula (A).

Among these, from the viewpoint of further enhancing the liquid crystal alignment properties, as the divalent linking group represented by an aspect of L^{C1}, a divalent linking group obtained by combining at least two or more groups selected from the group consisting of a linear alkylene group having 1 to 10 carbon atoms which may have a substituent, a branched alkylene group having 3 to 10 carbon atoms which may have a substituent, a cyclic alkylene group having 3 to 10 carbon atoms which may have a substituent, an arylene group having 6 to 12 carbon atoms which may have a substituent, —O—, —CO—, and —N(Q)- is preferable. Q represents a hydrogen atom or a substituent.

The definition of each group is the same as the definition of each group described in the section of the divalent linking group represented by LA1.

L^{C2} represents an (m+1)-valent linking group.

From the viewpoint of further enhancing the liquid crystal alignment properties, as the (m+1)-valent linking group, a hydrocarbon group which is an (m+1)-valent hydrocarbon group having 1 to 24 carbon atoms which may have a substituent and in which some carbon atoms constituting the hydrocarbon group may be substituted with heteroatoms is preferable, and an aliphatic hydrocarbon group having 1 to 10 carbon atoms which may have oxygen atoms or nitrogen atoms is more preferable.

The number of carbon atoms in the (m+1)-valent linking group is not particularly limited, but is preferably in a range of 1 to 24 and more preferably in a range of 1 to 10 from the viewpoint of further enhancing the liquid crystal alignment properties.

A divalent linking group is preferable as the (m+1)-valent linking group. Examples of the divalent linking group include those exemplified as the divalent linking group represented by an aspect of L^{A1} in Formula (A).

Z represents a cationically polymerizable group. Examples of the cationically polymerizable group are as described above.

m represents an integer of 1 or greater. From the viewpoint of further enhancing the liquid crystal alignment properties, m represents preferably an integer of 1 to 5, more preferably an integer of 1 to 3, and still more preferably 1.

Specific examples of the repeating unit A2 containing a cationically polymerizable group include repeating units represented by Formulae C-1 to C-8.

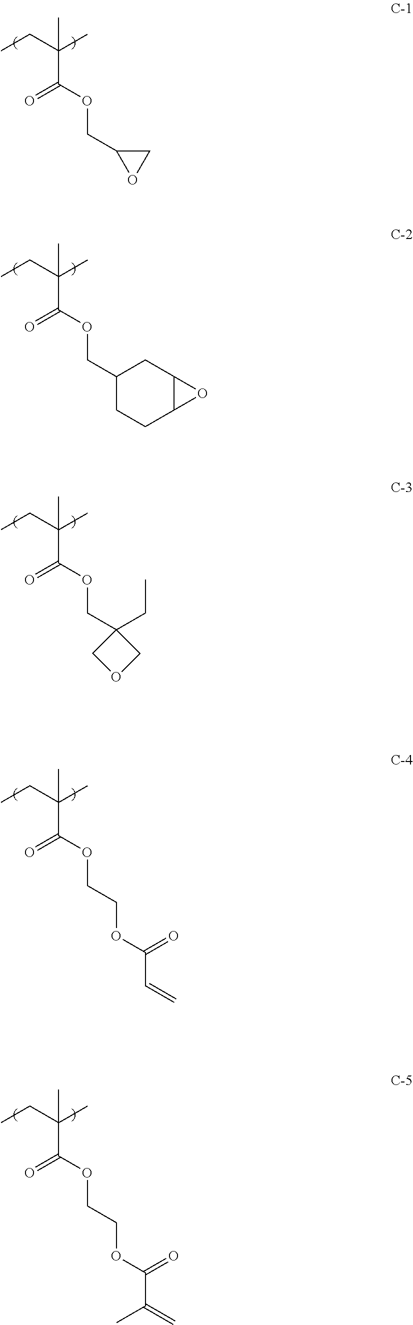

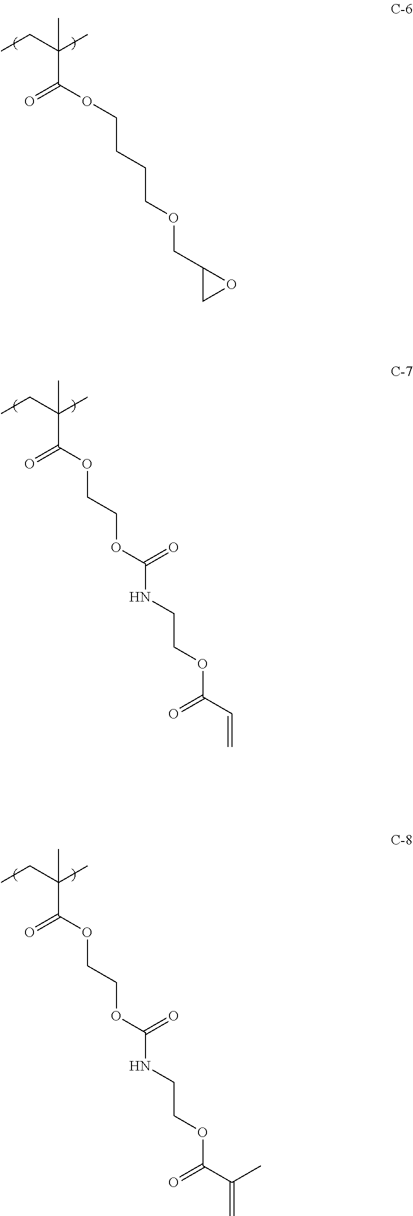

The content of the repeating unit A2 in the polymer A is not particularly limited, but is preferably in a range of 10% to 60% by mass and more preferably in a range of 10% to 40% by mass with respect to all the repeating units of the polymer A from the viewpoint of further enhancing the liquid crystal alignment properties.

The polymer A may have other repeating units in addition to the above-described repeating units.

Examples of the monomer (radically polymerizable monomer) forming the other repeating units include an acrylic acid ester compound, a methacrylic acid ester compound, a maleimide compound, an acrylamide compound, acrylonitrile, a maleic acid anhydride, a styrene compound, and a vinyl compound.

A method of synthesizing the polymer A is not particularly limited, and for example, the polymer can be synthesized by mixing a monomer forming the repeating unit A1 described above, a monomer forming the repeating unit A2 described above, and monomer forming any other repeating units and polymerizing the mixture in an organic solvent using a radically polymerization initiator.

The weight-average molecular weight (Mw) of the polymer A is not particularly limited, but is preferably in a range of 10000 to 500000, more preferably in a range of 10000 to 300000, and still more preferably in a range of 30000 to 150000 from the viewpoint of enhancing the liquid crystal alignment properties.

Here, the weight-average molecular weight and the number average molecular weight in the present invention are values measured by gel permeation chromatography (GPC) under the following conditions.
Solvent (eluent): tetrahydrofuran (THF)
Device name: TOSOH HLC-8320GPC
Column: Connect and use three of TOSOH TSKgel Super HZM-H (4.6 mm×15 cm)
Column temperature: 40° C.
Sample concentration: 0.1% by mass
Flow rate: 1.0 mL/min
Calibration curve: TSK standard polystyrene (manufactured by TOSOH Corporation), calibration curves of 7 samples with Mw of 2800000 to 1050 (Mw/Mn=1.03 to 1.06) are used.

The content of the polymer A in the composition for forming a photo-alignment film according to the embodiment of the present invention is not particularly limited, but in a case where the composition for forming a photo-alignment film according to the embodiment of the present invention contains a solvent described below, the content thereof is preferably in a range of 1 to 50 parts by mass and more preferably in a range of 2 to 40 parts by mass with respect to 100 parts by mass of the solvent.

[Polymer B]

The polymer B of the composition for forming a photo-alignment film according to the embodiment of the present invention is a polymer which has a repeating unit B1 containing a cationically polymerizable group and does not contain a photo-aligned group.

The polymer B of the composition for forming a photo-alignment film according to the embodiment of the present invention is a polymer having 90% by mass or greater of a repeating unit, in which the hydrogen bond element (δh) of the Hansen solubility parameter (HSP value) is less than 10.0 (hereinafter, also referred to as “repeating unit BH”), with respect to all the repeating units of the polymer B.

Here, from the viewpoint of further enhancing the liquid crystal alignment properties of the liquid crystal layer to be provided on the photo-alignment film to be formed and further enhancing the surface state, the content of the repeating unit BH in the polymer B is preferably greater than 90% by mass and 100% by mass or less with respect to all the repeating units of the polymer B.

Further, the repeating unit BH may be the repeating unit B1 containing a cationically polymerizable group or may be a repeating unit different from the repeating unit B1 containing a cationically polymerizable group.

From the viewpoint of further enhancing the liquid crystal alignment properties of the liquid crystal layer to be provided on the photo-alignment film to be formed, it is preferable that the polymer B of the composition for forming a photo-alignment film according to the embodiment of the present invention has greater than 60% by mass of a repeating unit, in which the dispersion element (δd) of the Hansen solubility parameter (HSP value) is 16.0 or greater (hereinafter, also referred to as “repeating unit BD”), with respect to all the repeating units of the polymer B.

Here, the content of the repeating unit BD in the polymer B is preferably in a range of 70% to 100% by mass with respect to all the repeating units of the polymer B.

Further, the repeating unit BD may be the repeating unit B1 containing a cationically polymerizable group or may be a repeating unit different from the repeating unit B1 containing a cationically polymerizable group.

<Repeating Unit B1 (Cationically Polymerizable Group)>

Examples of the cationically polymerizable group of the repeating unit B1 include an epoxy group, an epoxycyclohexyl group, and an oxetanyl group.

In the present invention, from the viewpoint of further enhancing the liquid crystal alignment properties of the liquid crystal layer to be provided on the photo-alignment film to be formed, it is preferable that the cationically polymerizable group of the repeating unit B1 is an epoxy group or an oxetanyl group.

The structure of the main chain of the repeating unit B1 is not particularly limited, and examples thereof include known structures. Preferred examples of the known structures include a skeleton selected from the group consisting of a (meth)acrylic skeleton, a styrene-based skeleton, a siloxane-based skeleton, a cycloolefin-based skeleton, a methylpentene-based skeleton, an amide-based skeleton, and an aromatic ester-based skeleton.

Among these, a skeleton selected from the group consisting of a (meth)acrylic skeleton, a siloxane-based skeleton, and a cycloolefin-based skeleton is more preferable, and a (meth)acrylic skeleton is still more preferable.

In the present invention, from the viewpoint of further enhancing the liquid crystal alignment properties of the liquid crystal layer to be provided on the photo-alignment film to be formed, the repeating unit B1 is preferably a repeating unit represented by any of Formulae (1) to (4) and more preferably a repeating unit represented by any of Formulae (5) to (7).

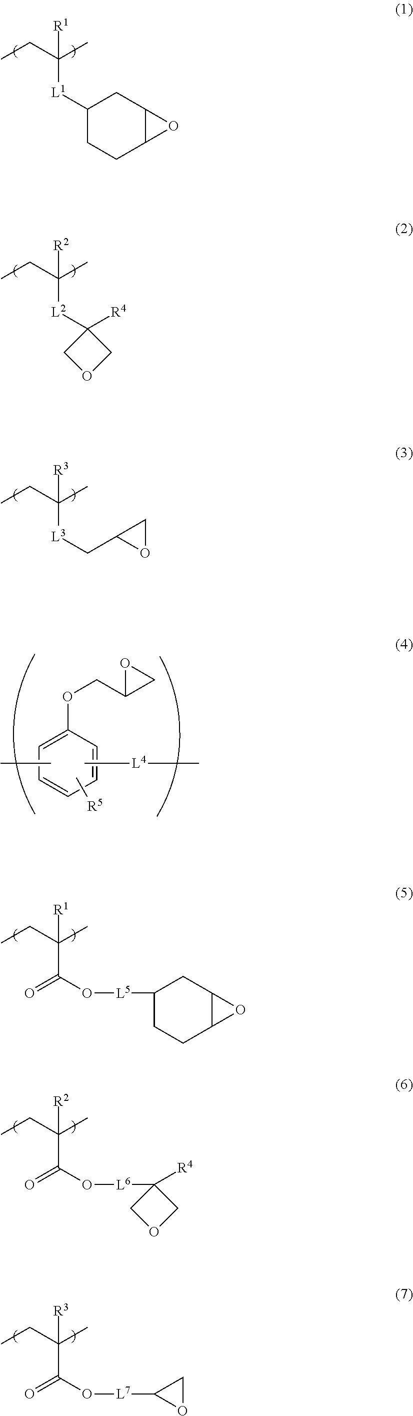

Here, in Formulae (1) to (7), R¹, R², R³, R⁴, and R⁵ each independently represent a hydrogen atom or a substituent.

Further, in Formulae (1) to (7), L¹, L², L³, L⁴, L⁵, L⁶, and L⁷ each independently represent a divalent linking group.

In Formulae (1) to (7), R¹, R², R³, R⁴, and R⁵ each independently represent a hydrogen atom or a substituent.

Here, examples of the substituent represented by an aspect of R¹, R², R³, R⁴, and R⁵ include those exemplified as the substituent represented by an aspect of R^{A1} in Formula (A).

Among these, R¹, R², and R³ represent preferably a hydrogen atom or an alkyl group and more preferably a hydrogen atom or a methyl group.

Further, R⁴ represents preferably a hydrogen atom or an alkyl group and more preferably a hydrogen atom, a methyl group, or an ethyl group.

Further, it is preferable that R⁵ represents a hydrogen atom or a methyl group.

In Formulae (1) to (7), L¹, L², L³, L⁴, L⁵, L⁶, and L⁷ each independently represent a divalent linking group.

Examples of the divalent linking group represented by L¹, L², L³, L⁴, L⁵, L⁶, and L⁷ include those exemplified as the divalent linking group represented by an aspect of L^{A1} in Formula (A).

Among these, from the viewpoint of further enhancing the liquid crystal alignment properties, as the divalent linking group represented by L¹, L², and L³, a divalent linking group obtained by combining at least two or more groups selected from the group consisting of a linear alkylene group having 1 to 10 carbon atoms which may have a substituent, a branched alkylene group having 3 to 10 carbon atoms which may have a substituent, a cyclic alkylene group having 3 to 10 carbon atoms which may have a substituent, an arylene group having 6 to 12 carbon atoms which may have a substituent, —O—, —CO—, and —N(Q)- is preferable. Q represents a hydrogen atom or a substituent.

The definition of each group is the same as the definition of each group described in the section of the divalent linking group represented by LA1.

Further, as the divalent linking group represented by L⁴, a linear alkylene group having 1 to 10 carbon atoms which may have a substituent, a branched alkylene group having 3 to 10 carbon atoms which may have a substituent, or a divalent linking group in which one or more —CH₂-'s constituting these alkylene groups are substituted with —O—, —S—, —NH—, —N(Q)-, or —CO— is preferable, and a methylene group is most preferable. Q represents a hydrogen atom or a substituent.

Further, as the divalent linking group represented by L⁵, L⁶, and L⁷, a linear alkylene group having 1 to 10 carbon atoms which may have a substituent, a branched alkylene group having 3 to 10 carbon atoms which may have a substituent, or a divalent linking group in which one or more —CH₂-'s constituting these alkylene groups are substituted with —O—, —S—, —NH—, —N(Q)-, or —CO— is preferable. Q represents a hydrogen atom or a substituent.

The definition of each group is the same as the definition of each group described in the section of the divalent linking group represented by LA1.

Specific examples of the repeating unit B1 containing a cationically polymerizable group include the repeating units represented by Formulae C-1 to C-8, described as specific examples of the repeating unit A2 containing a cationically polymerizable group.

The content of the repeating unit B1 in the polymer B is not particularly limited, but is preferably in a range of 20% to 100% by mass, more preferably in a range of 30% to 90% by mass, and still more preferably in a range of 40% to 80% by mass with respect to all the repeating units of the polymer from the viewpoint of further enhancing the liquid crystal alignment properties.

<Repeating Unit B2 (Other Repeating Units)>

The polymer B of the composition for forming a photo-alignment film according to the embodiment of the present invention may have other repeating units (hereinafter, also referred to as “repeating unit B2”) in addition to the repeating unit B1.

In the present invention, from the viewpoint of improving the durability of the optical laminate including a photo-alignment film to be formed, the polymer B has preferably a repeating unit having a Log P value of 2.2 or greater and more preferably a repeating unit having a Log P value of 2.2 to 4.5 as the repeating unit B2.

Further, the content of the repeating unit having a Log P value of 2.2 or greater is preferably 10% by mass or greater, more preferably in a range of 20% to 80% by mass, and still more preferably in a range of 40% to 60% by mass with respect to all the repeating units of the polymer B.

Here, the Log P value is an index for expressing the properties of the hydrophilicity and hydrophobicity of a chemical structure and is also referred to as a hydrophilic-hydrophobic parameter. The Log P value can be calculated using software such as ChemBioDraw Ultra or HSPiP (Ver. 4.1.07). Further, the Log P value can be acquired experimentally by the method of the OECD Guidelines for the Testing of Chemicals, Sections 1, Test No. 117 or the like. In the present invention, a value calculated by inputting the structural formula of a compound to HSPiP (Ver. 4.1.07) is employed as the Log P value unless otherwise specified.

Specific examples of the repeating unit having a Log P value of 2.2 or greater include repeating units represented by Formulae D-1 to D-4.

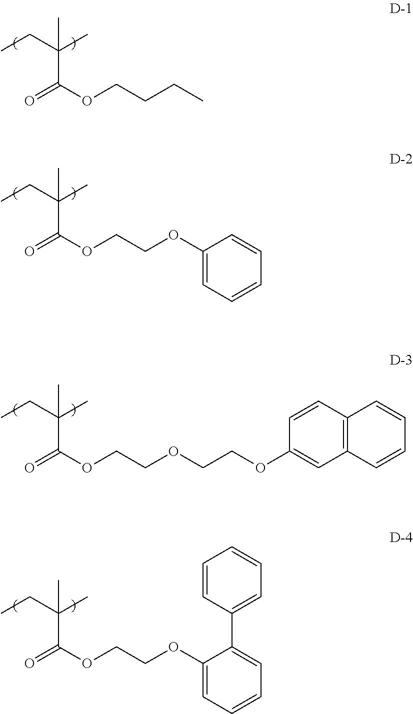

From the viewpoint of further enhancing the liquid crystal alignment properties of the liquid crystal layer to be provided on the photo-alignment film to be formed and further enhancing the surface state, it is preferable that the polymer B of the composition for forming a photo-alignment film according to the embodiment of the present invention of the present invention has a repeating unit in which the hydrogen bond element of the Hansen solubility parameter is 7.0 or greater and less than 10.0.

Further, the content of the repeating unit in which the hydrogen bond element of the Hansen solubility parameter is 7.0 or greater and less than 10.0 is preferably 10% by mass or greater, more preferably 10% by mass or greater and less than 50% by mass, and still more preferably in a range of 10% to 40% by mass with respect to all the repeating units of the polymer B.

Further, the repeating unit in which the hydrogen bond element of the Hansen solubility parameter is 7.0 or greater and less than 10.0 may be the repeating unit B1 containing a cationically polymerizable group or may be a repeating unit different from the repeating unit B1 containing a cationically polymerizable group, and from the viewpoints of handleability and manufacturing suitability, a repeating unit different from the repeating unit B1 is preferable.

A method of synthesizing the polymer B is not particularly limited, and for example, the polymer B can be synthesized by mixing a monomer forming the repeating unit B1 described above and a monomer forming an optional repeating unit B2 and polymerizing the mixture in an organic solvent using a radically polymerization initiator.

The weight-average molecular weight (Mw) of the polymer B is not particularly limited, but is preferably 500 or greater, more preferably in a range of 1000 to 500000, still more preferably in a range of 3000 to 100000, and particularly preferably in a range of 5000 to 50000 from the viewpoint of further enhancing the liquid crystal alignment properties.

In the present invention, from the viewpoint of further enhancing the surface state of the liquid crystal layer provided on the photo-alignment film to be formed and improving the durability of the optical laminate including the photo-alignment film to be formed, the content of the polymer B is preferably greater than 40 parts by mass, more preferably in a range of 50 to 600 parts by mass, and still more preferably in a range of 100 to 500 parts by mass with respect to 100 parts by mass of the polymer A.

The content of the polymer B in the composition for forming a photo-alignment film according to the embodiment of the present invention is not particularly limited, but in a case where the composition for forming a photo-alignment film according to the embodiment of the present invention contains a solvent described below, the content thereof is preferably in a range of 30 to 300 parts by mass and more preferably in a range of 50 to 200 parts by mass with respect to 100 parts by mass of the solvent.

[Acid Generator]

The acid generator contained in the composition for forming a photo-alignment film according to the embodiment of the present invention is at least one acid generator selected from the group consisting of a photoacid generator and a thermal acid generator.

<Photoacid Generator>

The photoacid generator is not particularly limited, and a compound that is sensitive to actinic rays having a wavelength of 300 nm or greater and preferably a wavelength of 300 to 450 nm and generates an acid is preferable. Further, even a photoacid generator that is not directly sensitive to actinic rays having a wavelength of 300 nm or greater can be preferably used by being combined with a sensitizer as long as the photoacid generator is a compound that is sensitive to actinic rays having a wavelength of 300 nm or greater and generates an acid by being used in combination with a sensitizer.

As the photoacid generator, a photoacid generator that generates an acid having a pKa of 4 or less is preferable, a photoacid generator that generates an acid having a pKa of 3 or less is more preferable, and a photoacid generator that generates an acid having a pKa of 2 or less is still more preferable. In the present invention, the pKa basically denotes a pKa of an acid in water at 25° C. In a case where the pKa cannot be measured in water, the pKa denotes a pKa of an acid measured by changing water to a solvent suitable for the measurement. Specifically, the pKa described in Chemistry Handbook or the like can be referred to. As the acid having a pKa of 3 or less, sulfonic acid or phosphonic acid is preferable, and sulfonic acid is more preferable.

Examples of the photoacid generator include an onium salt compound, trichloromethyl-s-triazines, a sulfonium salt, an iodonium salt, quaternary ammonium salts, a diazomethane compound, an imide sulfonate compound, and an oxime sulfonate compound. Among these, an onium salt compound, an imide sulfonate compound, or an oxime sulfonate compound is preferable, and an onium salt compound or an oxime sulfonate compound is more preferable. The photoacid generator may be used alone or in combination of two or more kinds thereof.

<Thermal Acid Generator>

The thermal acid generator is a compound that generates an acid by heat.

Specific examples of the thermal acid generator include known thermal acid generators of the related art, and examples of the known thermal acid generators include benzyl-p-hydroxyphenyl methyl sulfonium hexafluoroantimonate, cinnamyl tetramethylene sulfonium hexafluoroantimonate, benzhydryl dimethyl sulfonium hexafluoroantimonate, and commercially available products such as K-PURE TAG Series and K-PURE CXC Series (sold by King Industries, Inc.).

Further, an onium salt such as a sulfonium salt, an ammonium salt, or a phosphonium salt is known as the thermal acid generator. Examples of the thermal acid generator which is an onium salt include the compounds described in JP2003-277353A, JP1990-1470A (JP-H2-1470A), JP1990-255646A (JP-H2-255646A), JP1991-11044A (JP-H3-11044A), JP2003-183313, and JP2003-277352A.

The thermal acid generator may be used alone or in combination of two or more kinds thereof.

The content of the acid generator in the composition for forming a photo-alignment film according to the embodiment of the present invention is not particularly limited, but is preferably in a range of 1 to 30 parts by mass and more preferably in a range of 2 to 20 parts by mass with respect to 100 parts by mass of the total amount of the polymer A and the polymer B.

[Solvent]

From the viewpoint of the workability for preparing a photo-alignment film, it is preferable that the composition for forming a photo-alignment film according to the embodiment of the present invention contains a solvent.

Specific examples of the solvent include ketones (such as acetone, 2-butanone, methyl isobutyl ketone, cyclohexanone, and cyclopentanone), ethers (such as dioxane and tetrahydrofuran), aliphatic hydrocarbons (such as hexane), alicyclic hydrocarbons (such as cyclohexane), aromatic hydrocarbons (such as toluene, xylene, and trimethylbenzene), carbon halides (such as dichloromethane, dichloroethane, dichlorobenzene, and chlorotoluene), esters (such as methyl acetate, ethyl acetate, and butyl acetate), water, alcohols (such as ethanol, isopropanol, butanol, and cyclohexanol), cellosolves (such as methylcellosolve and ethyl cellosolve), cellosolve acetates, sulfoxides (such as dimethylsulfoxide), and amides (such as dimethylformamide and dimethylacetamide), and such solvents may be used alone or in combination of two or more kinds thereof.

The composition for forming a photo-alignment film according to the embodiment of the present invention may contain other components in addition to the above-described components, and examples thereof include a crosslinking catalyst, an adhesion improver, a leveling agent, a surfactant, and a plasticizer.

[Method of Producing Photo-Alignment Film]

The photo-alignment film according to the embodiment of the present invention can be produced by a known production method of the related art except for using the above-described composition for forming a photo-alignment film according to the embodiment of the present invention, and for example, the photo-alignment film can be prepared by a production method including a coating step of coating a surface of a base material with the above-described composition for forming a photo-alignment film according to the embodiment of the present invention and a light irradiation step of irradiating the coating film of the composition for forming a photo-alignment film with polarized light or non-polarized light in an oblique direction with respect to the surface of the coating film.

Further, the base material will be described below in the section of the optical laminate according to the embodiment of the present invention.

<Coating Step>

The coating method in the coating step is not particularly limited and can be appropriately selected depending on the purpose thereof, and examples thereof include spin coating, die coating, gravure coating, flexographic printing, and ink jet printing.

<Light Irradiation Step>

The polarized light to be applied to the coating film of the composition for forming a photo-alignment film in the light irradiation step is not particularly limited, and examples thereof include linearly polarized light, circularly polarized light, and elliptically polarized light. Among these, linearly polarized light is preferable.

Further, the “diagonal direction” in which non-polarized light is applied is not particularly limited as long as the direction is inclined at a polar angle θ (0<θ<90°) with respect to the normal direction of the surface of the coating film, and the polar angle θ can be appropriately selected depending on the purpose thereof, but is preferably in a range of 200 to 80°.

The wavelength of the polarized light or the non-polarized light is not particularly limited as long as an alignment control ability for a liquid crystal molecule can be imparted to the coating film of the composition for forming a photo-alignment film, and examples thereof include ultraviolet rays, near-ultraviolet rays, and visible rays. Among these, near-ultraviolet rays having a wavelength of 250 nm to 450 nm are particularly preferable.

Further, examples of a light source for applying polarized light or non-polarized light include a xenon lamp, a high-pressure mercury lamp, an ultra-high pressure mercury lamp, and a metal halide lamp. The wavelength range of irradiation can be controlled by using an interference filter, a color filter, or the like for ultraviolet rays or visible rays obtained from such a light source. Further, linearly polarized light can be obtained by using a polarizing filter or a polarizing prism for light from such a light source.

The integrated light amount of polarized light or non-polarized light is not particularly limited as long as the alignment control ability for a liquid crystal molecule can be imparted to the coating film of the composition for forming a photo-alignment film, but is preferably in a range of 1 to 300 mJ/cm² and more preferably in a range of 5 to 100 mJ/cm².

The illuminance of polarized light or non-polarized light is not particularly limited as illuminance is not particularly limited as long as the alignment control ability for a liquid crystal molecule can be imparted to the coating film of the composition for forming a photo-alignment film, but is preferably in a range of 0.1 to 300 mW/cm² and more preferably in a range of 1 to 100 mW/cm².

[Photo-Alignment Film]

The photo-alignment film according to the embodiment of the present invention is a photo-alignment film formed of the above-described composition for forming a photo-alignment film according to the embodiment of the present invention, which is a film whose surface has an alignment control ability for a liquid crystal molecule.

The film thickness of the photo-alignment film is not particularly limited and may be appropriately selected depending on the purpose thereof, and the film thickness thereof is preferably in a range of 10 to 1000 nm and more preferably in a range of 10 to 700 nm.

[Optical Laminate]

An optical laminate according to the embodiment of the present invention is an optical laminate including a photo-alignment film and a liquid crystal layer, which is a light absorption anisotropic layer in which the photo-alignment film is the above-described photo-alignment film according to the embodiment of the present invention and the liquid crystal layer contains a dichroic substance.

Further, the optical laminate according to the embodiment of the present invention may have a base material for supporting the optically anisotropic layer.

[Base Material]

The optional base material that the optical laminate according to the embodiment of the present invention may have is a base material for supporting the above-described photo-alignment film, and examples thereof include a base material to be coated with the above-described composition for forming a photo-alignment film in a case where a photo-alignment film is formed by being coated with the above-described composition for forming a photo-alignment film.

It is preferable that such a base material is transparent, and in the present invention, the light transmittance is preferably 80% or greater. Further, in the present invention, the term “transparent” denotes that the transmittance of visible light is 60% or greater.

It is preferable that the base material is a polymer film, and examples of the polymer material of the polymer film include a cellulose-based polymer such as triacetyl cellulose (TAC), diacetyl cellulose, or cellulose acetate propionate, an acrylic polymer such as polymethacrylic acid ester or polyacrylic acid ester, a polycarbonate-based polymer, a polyester-based polymer such as polyethylene terephthalate or polyethylene naphthalate, a styrene-based polymer such as polystyrene or an acrylonitrile-styrene copolymer (AS resin), a polyolefin-based polymer such as polyethylene, polypropylene, or an ethylene-propylene copolymer, a polymer having an alicyclic structure such as a norbornene-based polymer, a monocyclic cyclic olefin polymer, a cyclic conjugated diene polymer, or a vinyl alicyclic hydrocarbon polymer, a vinyl chloride-based polymer, an amide-based polymer such as nylon or aromatic polyamide, an imide-based polymer, a sulfone-based polymer, a polyether sulfone-based polymer, a polyether ether ketone-based polymer, a polyphenylene sulfide-based polymer, a vinylidene chloride-based polymer, a vinyl alcohol-based polymer, a vinyl butyral-based polymer, an arylate-based polymer, a polyoxymethylene-based polymer, an epoxy-based polymer, and a polymer obtained by mixing such polymers.

Among these materials, a cellulose-based polymer or a polymer having an alicyclic structure is preferable, and a cellulose-based polymer is more preferable.

[Liquid Crystal Layer (Light Absorption Anisotropic Layer)]

The liquid crystal layer of the optical laminate according to the embodiment of the present invention is a light absorption anisotropic layer containing a dichroic substance.

In the present invention, it is preferable that the light absorption anisotropic layer is formed of a composition containing a dichroic substance (hereinafter, also referred to as “composition for forming a light absorption anisotropic layer”).

<Dichroic Substance>

The dichroic substance of the light absorption anisotropic layer and the composition for forming a light absorption anisotropic layer is not particularly limited.

A dichroic azo coloring agent compound is preferable as the dichroic substance, and a dichroic azo coloring agent compound typically used for a so-called coating type polarizer can be used. The dichroic azo coloring agent compound is not particularly limited, and known dichroic azo coloring agent compounds of the related art can be used, but the compounds described below are preferably used.

In the present invention, the dichroic azo coloring agent compound denotes a coloring agent having different absorbances depending on the direction.

The dichroic azo coloring agent compound may or may not exhibit liquid crystallinity.

In a case where the dichroic azo coloring agent compound exhibits liquid crystallinity, the dichroic azo coloring agent compound may exhibit any of nematic liquid crystallinity or smectic liquid crystallinity. The temperature at which the liquid crystal phase is exhibited is preferably in a range of room temperature (approximately 20° C. to 28° C.) to 300° C. and from the viewpoints of handleability and manufacturing suitability, more preferably in a range of 50° C. to 200° C.

In the present invention, from the viewpoint of adjusting the tint, the light absorption anisotropic layer contains preferably at least one coloring agent compound having a maximum absorption wavelength in a wavelength range of 560 to 700 nm (hereinafter, also referred to as “first dichroic azo coloring agent compound”) and at least one coloring agent compound having a maximum absorption wavelength in a wavelength range of 455 nm or greater and less than 560 nm (hereinafter, also referred to as “second dichroic azo coloring agent compound”) and specifically more preferably at least a dichroic azo coloring agent compound represented by Formula (1) and a dichroic azo coloring agent compound represented by Formula (2).

In the present invention, three or more kinds of dichroic azo coloring agent compounds may be used in combination. For example, from the viewpoint of making the color of the light absorption anisotropic layer close to black, it is preferable to use a first dichroic azo coloring agent compound, a second dichroic azo coloring agent compound, and at least one coloring agent compound having a maximum absorption wavelength in a wavelength range of 380 nm or greater and less than 455 nm (preferably in a wavelength range of 380 to 454 nm)(hereinafter, also referred to as “third dichroic azo coloring agent compound”) in combination.

In the present invention, from the viewpoint of further enhancing pressing resistance, it is preferable that the dichroic azo coloring agent compound contains a crosslinkable group.

Specific examples of the crosslinkable group include a (meth)acryloyl group, an epoxy group, an oxetanyl group, and a styryl group. Among these, a (meth)acryloyl group is preferable.

(First Dichroic Azo Coloring Agent Compound)

It is preferable that the first dichroic azo coloring agent compound is a compound having a chromophore which is a nucleus and a side chain bonded to a terminal of the chromophore.

Specific examples of the chromophore include an aromatic ring group (such as an aromatic hydrocarbon group or an aromatic heterocyclic group) and an azo group. In addition, a structure containing both an aromatic ring group and an azo group is preferable, and a bisazo structure containing an aromatic heterocyclic group (preferably a thienothiazole group) and two azo groups is more preferable.

The side chain is not particularly limited, and examples thereof include a group represented by L3, R2, or L4 in Formula (1).

From the viewpoint adjusting the tint of the polarizer, it is preferable that the first dichroic azo coloring agent compound is a dichroic azo coloring agent compound having a maximum absorption wavelength in a wavelength range of 560 nm or greater and 700 nm or less (more preferably 560 to 650 nm and particularly preferably 560 to 640 nm).

The maximum absorption wavelength (nm) of the dichroic azo coloring agent compound in the present specification is acquired from an ultraviolet visible spectrum in a wavelength range of 380 to 800 nm measured by a spectrophotometer using a solution prepared by dissolving the dichroic azo coloring agent compound in a good solvent.

In the present invention, from the viewpoint of further improving the alignment degree of the light absorption anisotropic layer to be formed, it is preferable that the first dichroic azo coloring agent compound is a compound represented by Formula (1).

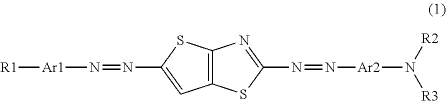

In Formula (1), Ar1 and Ar2 each independently represent a phenylene group which may have a substituent or a naphthylene group which may have a substituent. Among these, a phenylene group is preferable.

In Formula (1), R1 represents a hydrogen atom, a linear or branched alkyl group having 1 to 20 carbon atoms which may have a substituent, an alkoxy group, an alkylthio group, an alkylsulfonyl group, an alkylcarbonyl group, an alkyloxycarbonyl group, an acyloxy group, an alkylcarbonate group, an alkylamino group, an acylamino group, an alkylcarbonylamino group, an alkoxycarbonylamino group, an alkylsulfonylamino group, an alkylsulfamoyl group, an alkylcarbamoyl group, an alkylsulfinyl group, an alkylureido group, an alkylphosphoric acid amide group, an alkylimino group, or an alkylsilyl group.

Further, —CH₂— constituting the alkyl group may be substituted with —O—, —CO—, —C(O)—O—, —O—C(O)—, —Si(CH₃)₂—O—Si(CH₃)₂—, —N(R1′)—, —N(R1′)-CO—, —CO—N(R1′)—, —N(R1′)-C(O)—O—, —O—C(O)—N(R1′)—, —N(R1′)-C(O)—N(R1′)—, —CH═CH—, —C≡C—, —N═N—, —C(R1′)=CH—C(O)—, or —O—C(O)—O—.

In a case where R1 represents a group other than a hydrogen atom, the hydrogen atom in each group may be substituted with a halogen atom, a nitro group, a cyano group, —N(R1′)₂, an amino group, —C(R1′)═C(R1′)-NO₂, —C(R1′)═C(R1′)-CN, or —C(R1′)═C(CN)₂.

R1′ represents a hydrogen atom or a linear or branched alkyl group having 1 to 6 carbon atoms. In a case where a plurality of R1's are present in each group, these may be the same as or different from one another.

In Formula (1), R2 and R3 each independently represent a hydrogen atom, a linear or branched alkyl group having 1 to 20 carbon atoms which may have a substituent, an alkoxy group, an acyl group, an alkyloxycarbonyl group, an alkylamide group, an alkylsulfonyl group, an aryl group, an arylcarbonyl group, an arylsulfonyl group, an aryloxycarbonyl group, or an arylamide group.

Further, —CH₂— constituting the alkyl group may be substituted with —O—, —S—, —C(O)—, —C(O)—O—, —O—C(O)—, —C(O)—S—, —S—C(O)—, —Si(CH₃)₂—O—Si(CH₃)₂—, —NR2′-, —NR2′-CO—, —CO—NR2′-, —NR2′-C(O)—O—, —O—C(O)—NR2′-, —NR2′-C(O)—NR2′-, —CH═CH—, —C≡C—, —N═N—, —C(R2′)=CH—C(O)—, or —O—C(O)—O—.

In a case where R2 and R3 represent a group other than a hydrogen atom, the hydrogen atom of each group may be substituted with a halogen atom, a nitro group, a cyano group, a —OH group, —N(R2′)₂, an amino group, —C(R2′)═C(R2′)-NO₂, —C(R2′)═C(R2′)-CN, or —C(R2′)═C(CN)₂.

R2′ represents a hydrogen atom or a linear or branched alkyl group having 1 to 6 carbon atoms. In a case where a plurality of R2's are present in each group, these may be the same as or different from one another.

R2 and R3 may be bonded to each other to form a ring, or R2 or R3 may be bonded to Ar2 to form a ring.

From the viewpoint of the light resistance, it is preferable that R1 represents an electron-withdrawing group and that R2 and R3 represent a group having a low electron-donating property.

Specific examples of such groups as R1 include an alkylsulfonyl group, an alkylcarbonyl group, an alkyloxycarbonyl group, an acyloxy group, an alkylsulfonylamino group, an alkylsulfamoyl group, an alkylsulfinyl group, and an alkylureido group, and examples of such groups as R2 and R3 include groups having the following structures. In addition, the groups having the following structures are shown in the form having a nitrogen atom to which R2 and R3 are bonded in Formula (1).

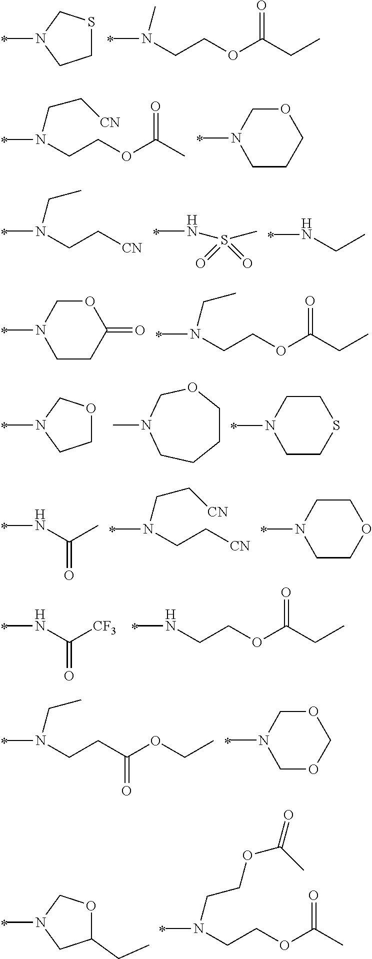

Specific examples of the first dichroic azo coloring agent compound are shown below, but the present invention is not limited thereto.

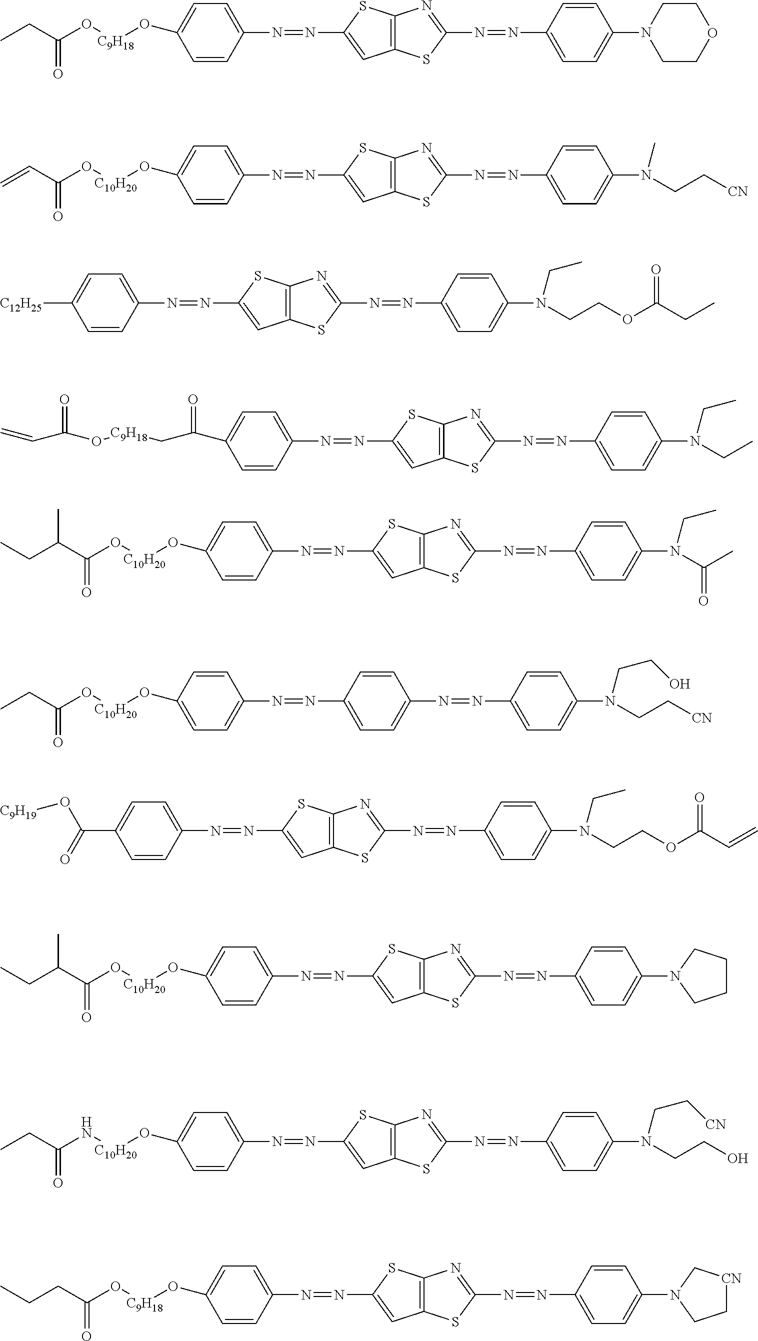

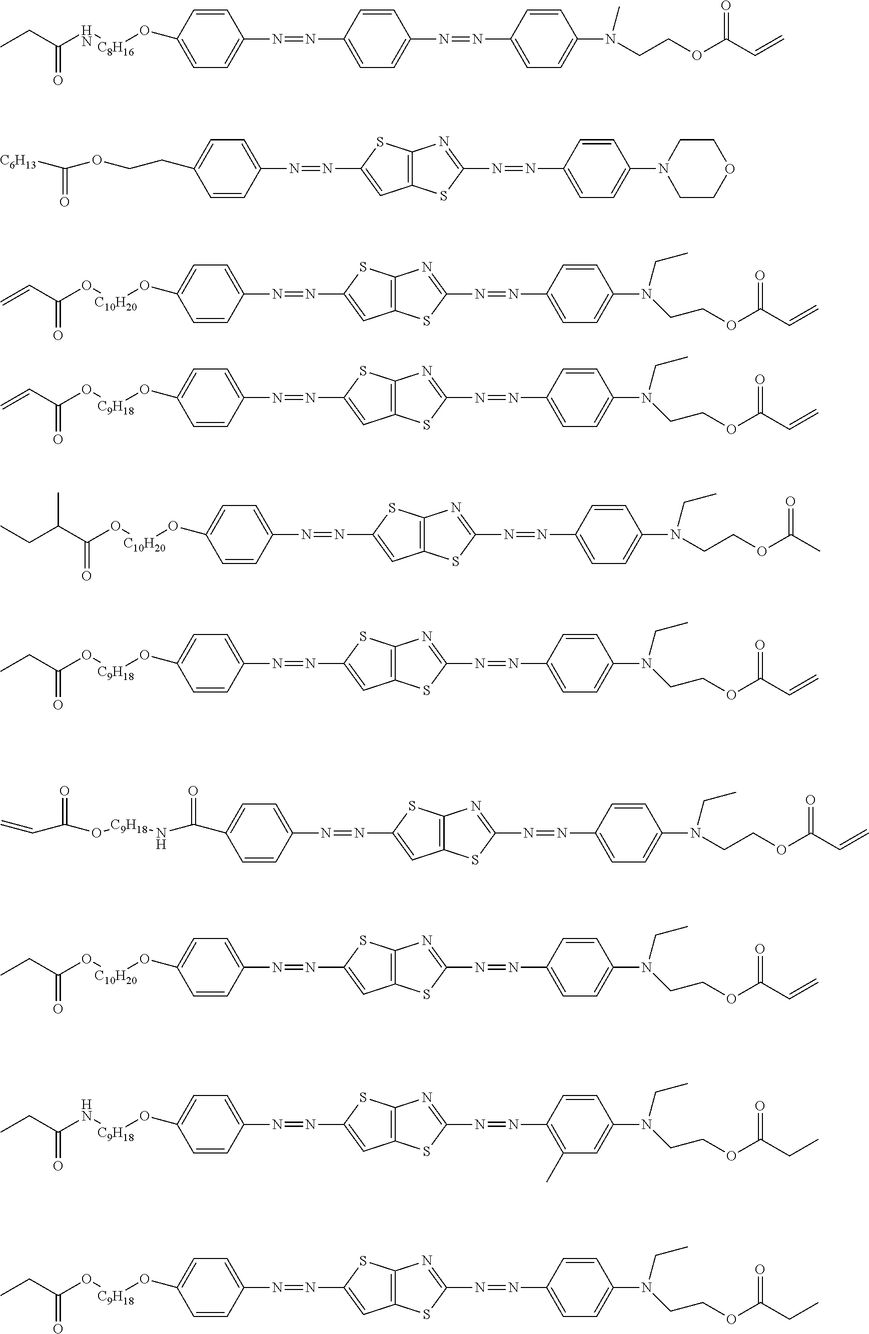

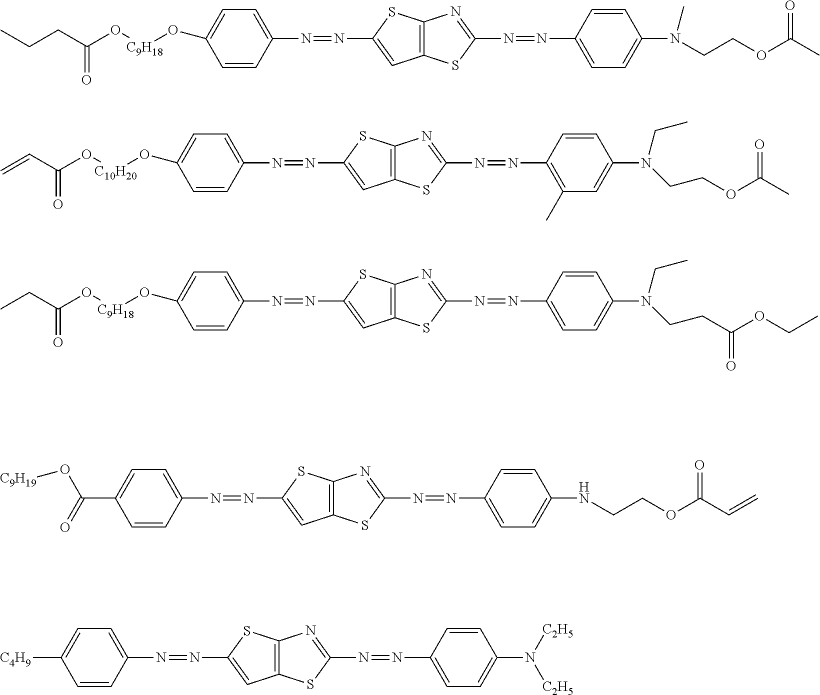

(Second Dichroic Azo Coloring Agent Compound)

The second dichroic azo coloring agent compound is a compound different from the first dichroic azo coloring agent compound, and specifically, the chemical structure thereof is different from that of the first dichroic azo coloring agent compound.

It is preferable that the second dichroic azo coloring agent compound is a compound having a chromophore which is a nucleus of a dichroic azo coloring agent compound and a side chain bonded to a terminal of the chromophore.

Specific examples of the chromophore include an aromatic ring group (such as an aromatic hydrocarbon group or an aromatic heterocyclic group) and an azo group. In addition, a structure containing both an aromatic hydrocarbon group and an azo group is preferable, and a bisazo or trisazo structure containing an aromatic hydrocarbon group and two or three azo groups is more preferable.

The side chain is not particularly limited, and examples thereof include a group represented by R4, R5, or R6 in Formula (2).

The second dichroic azo coloring agent compound is a dichroic azo coloring agent compound having a maximum absorption wavelength in a wavelength range of 455 nm or greater and less than 560 nm. From the viewpoint of adjusting the tint of the polarizer, the second dichroic azo coloring agent compound is preferably a dichroic azo coloring agent compound having a maximum absorption wavelength in a wavelength range of 455 nm to 555 nm and more preferably a dichroic azo coloring agent compound having a maximum absorption wavelength in a wavelength range of 455 to 550 nm.

In particular, the tint of the polarizer is easily adjusted by using a first dichroic azo coloring agent compound having a maximum absorption wavelength of 560 to 700 nm and a second dichroic azo coloring agent compound having a maximum absorption wavelength of 455 nm or greater and less than 560 nm.

From the viewpoint of further improving the alignment degree of the polarizer, it is preferable that the second dichroic azo coloring agent compound is a compound represented by Formula (2).

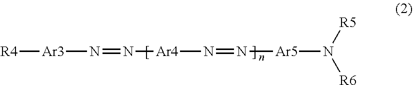

In Formula (2), n represents 1 or 2.

In Formula (2), Ar3, Ar4, and Ar5 each independently represent a phenylene group which may have a substituent, a naphthylene group which may have a substituent, or a heterocyclic group which may have a substituent.

The heterocyclic group may be aromatic or non-aromatic.

The atoms other than carbon constituting the aromatic heterocyclic group include a nitrogen atom, a sulfur atom, and an oxygen atom. In a case where the aromatic heterocyclic group has a plurality of atoms constituting a ring other than carbon, these may be the same as or different from each other.

Specific examples of the aromatic heterocyclic group include a pyridylene group (pyridine-diyl group), a pyridazine-diyl group, an imidazole-diyl group, a thienylene group (thiophene-diyl group), a quinolylene group (quinoline-diyl group), an isoquinolylene group (isoquinoline-diyl group), an oxazole-diyl group, a thiazole-diyl group, an oxadiazole-diyl group, a benzothiazole-diyl group, a benzothiadiazole-diyl group, a phthalimido-diyl group, a thienothiazole-diyl group, a thiazolothiazole-diyl group, a thienothiophene-diyl group, and a thienooxazole-diyl group.

In Formula (2), R4 has the same definition as that for R1 in Formula (1).

In Formula (2), R5 and R6 each have the same definition as that for R2 and R3 in Formula (1).

From the viewpoint of the light resistance, it is preferable that R4 represents an electron-withdrawing group and that R5 and R6 represent a group having a low electron-donating property.

Among such groups, specific examples of the electron-withdrawing group as R4 are the same as the specific examples of the electron-withdrawing group as R1, and specific examples of the group having a low electron-donating property as R5 and R6 are the same as the specific examples of the group having a low electron-donating property as R2 and R3.

Specific examples of the second dichroic azo coloring agent compound are shown below, but the present invention is not limited thereto.

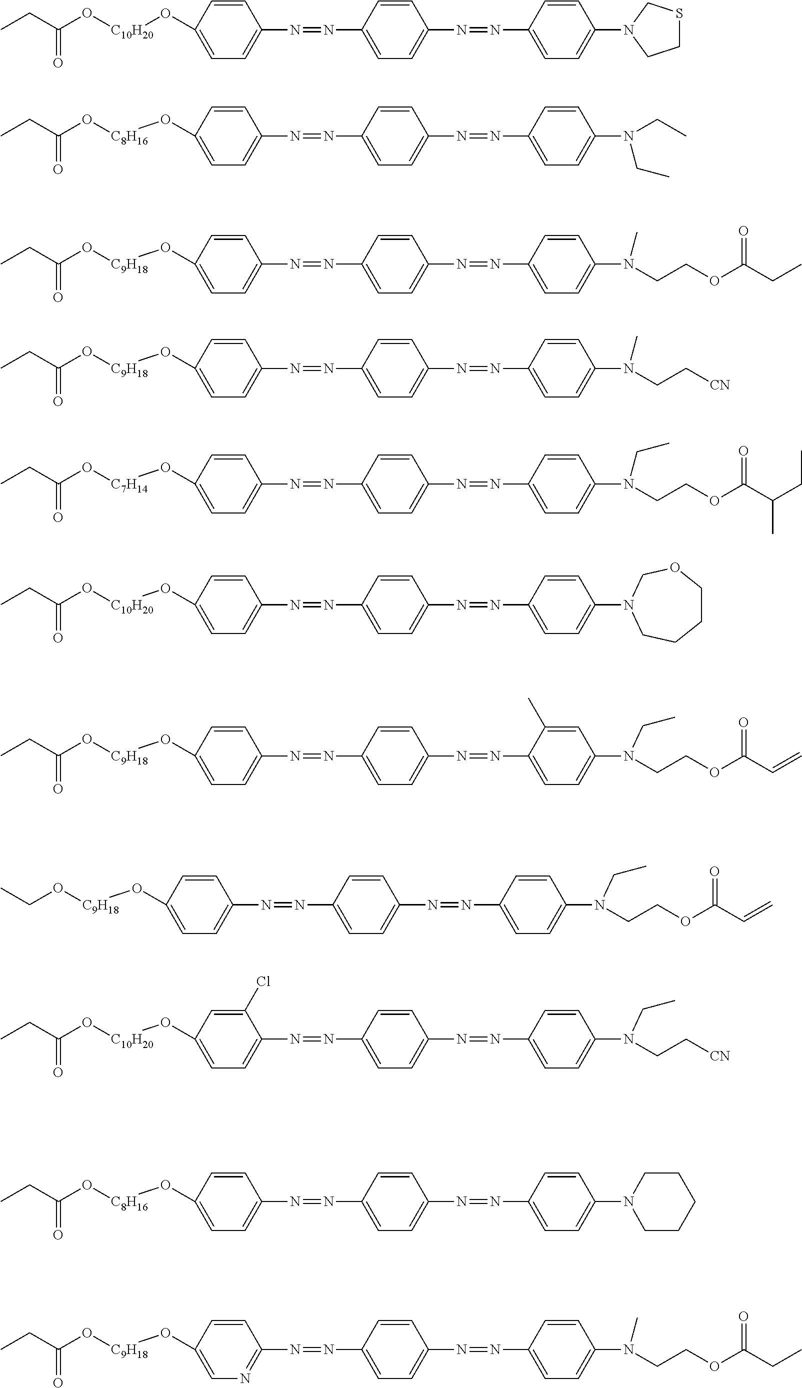

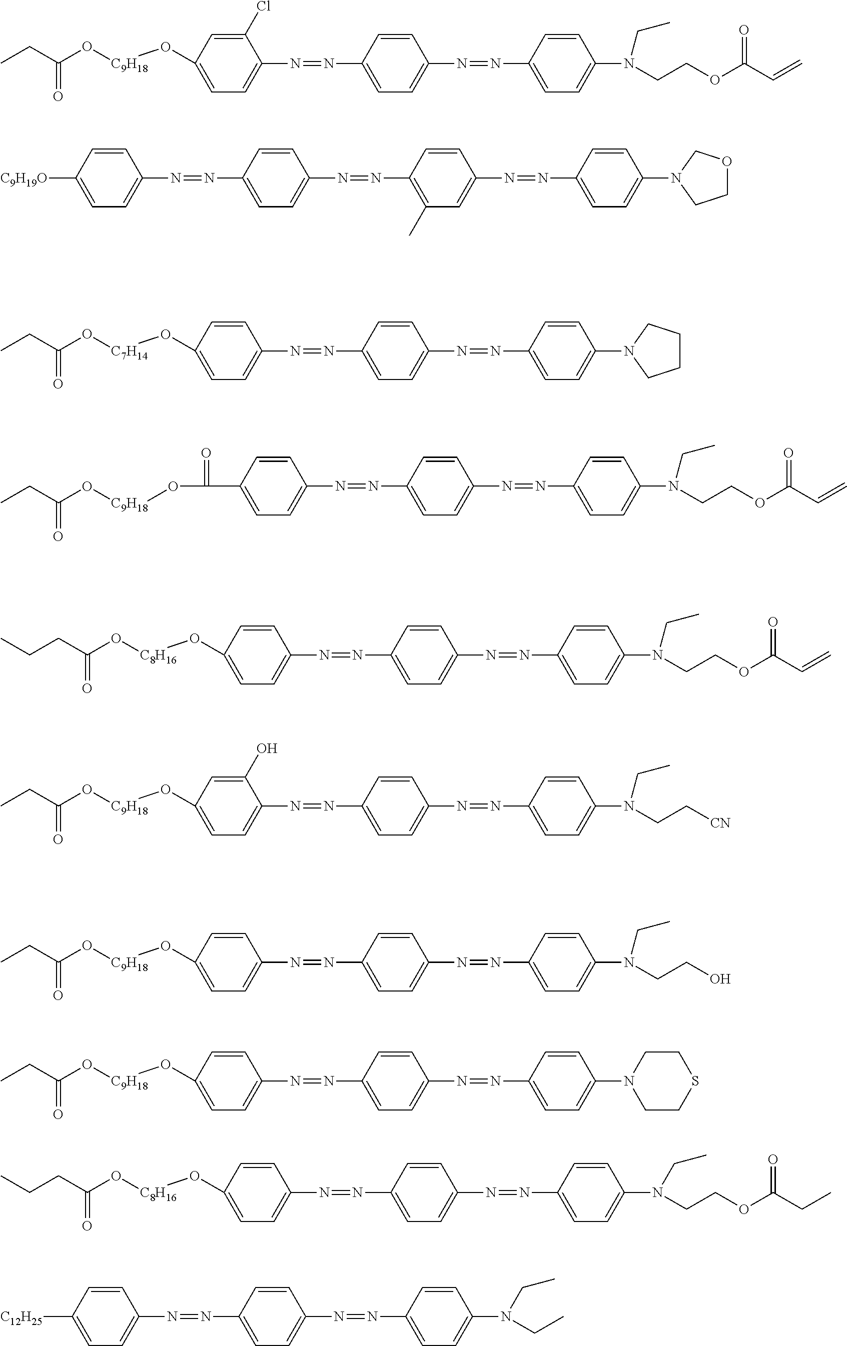

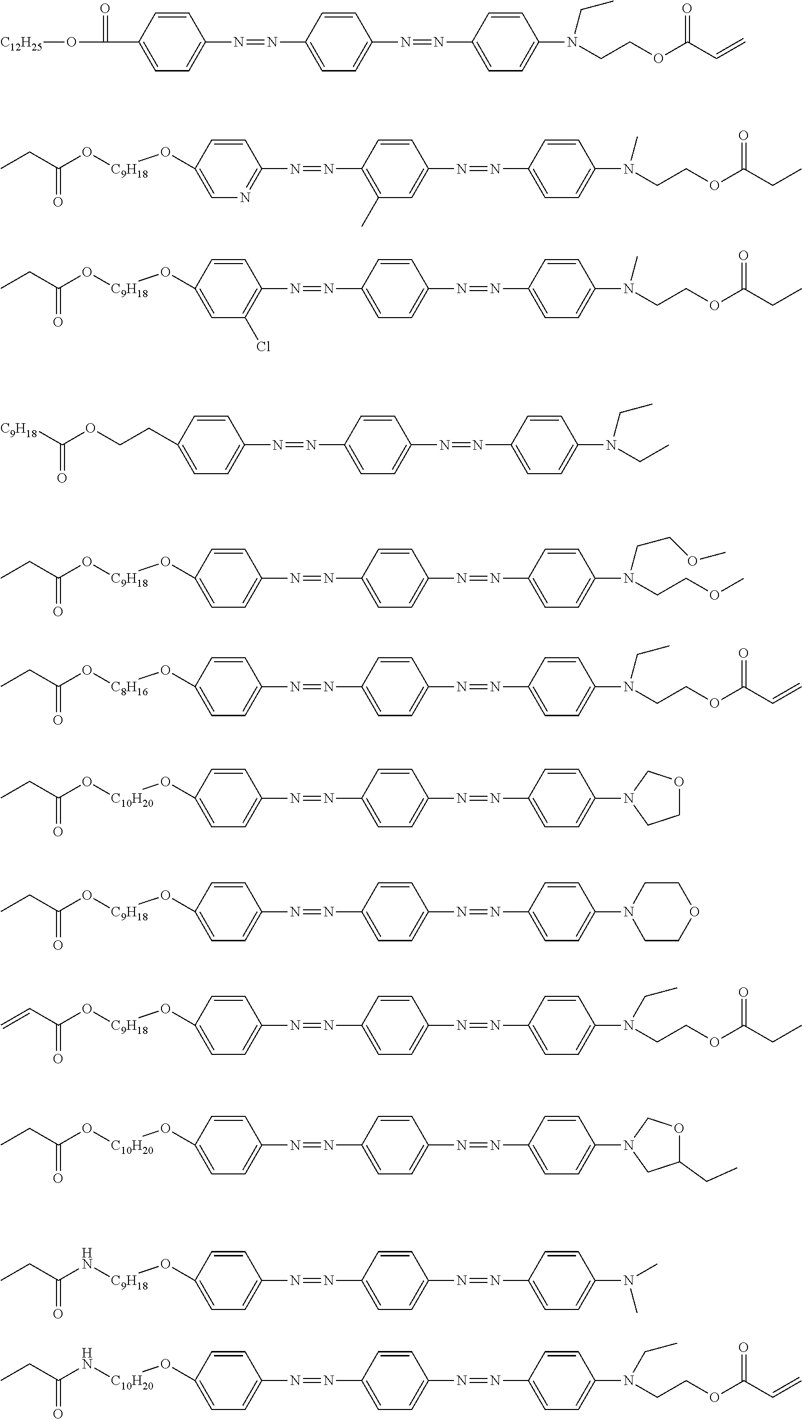

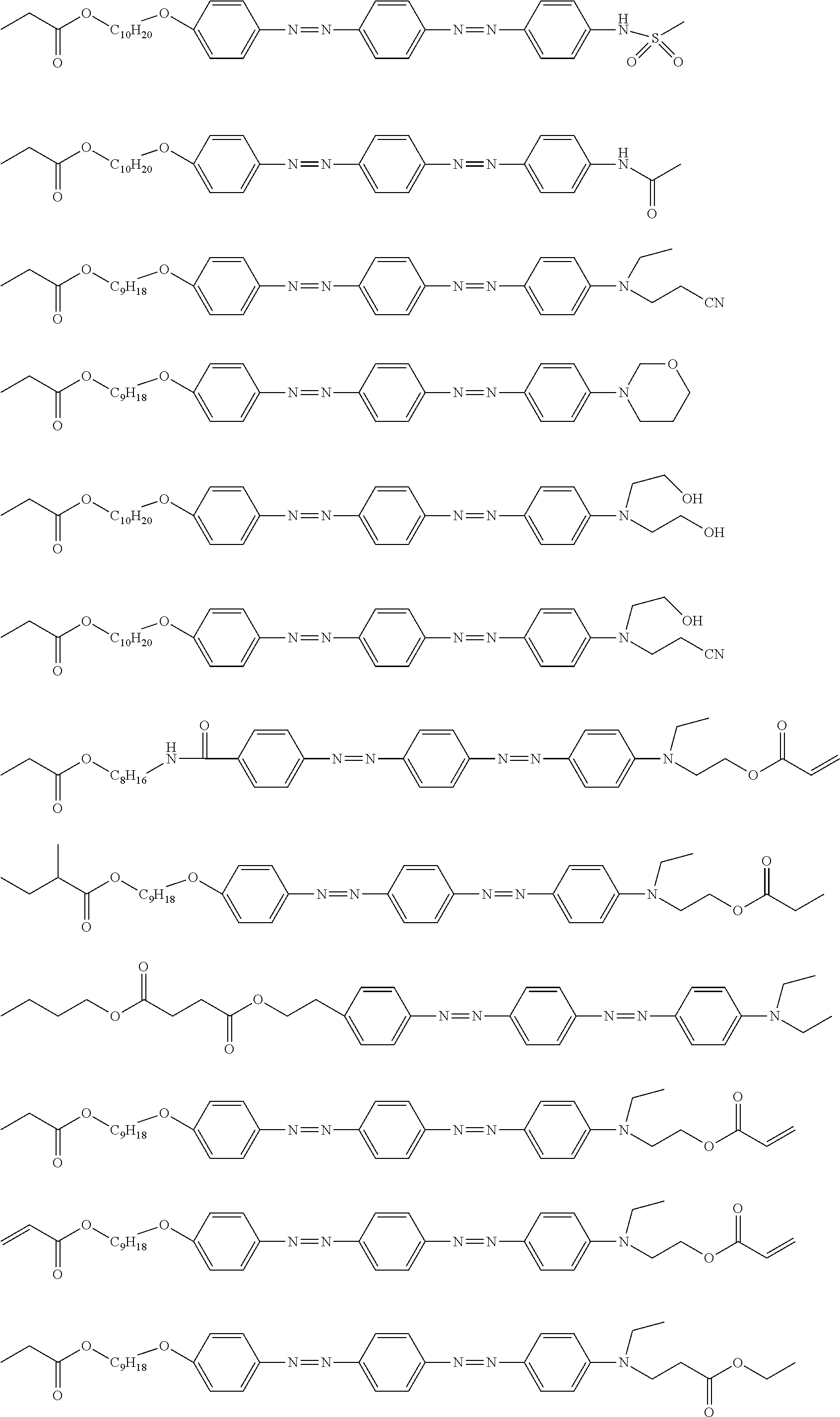

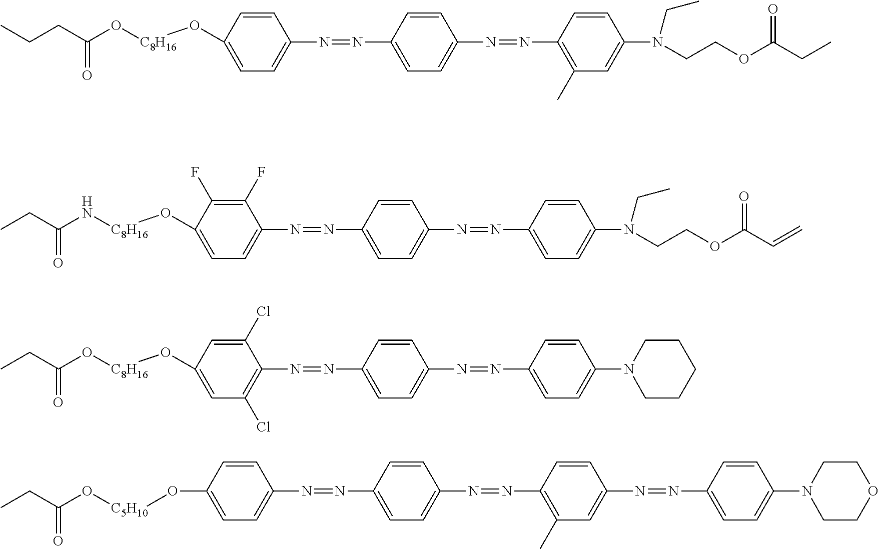

(Difference in Log P Value)

The log P value is an index expressing the hydrophilicity and the hydrophobicity of a chemical structure. An absolute value of a difference (hereinafter, also referred to as “difference in log P value”) between the log P value of a side chain of the first dichroic azo coloring agent compound and the log P value of a side chain of the second dichroic azo coloring agent compound is preferably 2.30 or less, more preferably 2.0 or less, still more preferably 1.5 or less, and particularly preferably 1.0 or less. In a case where the difference in log P value is 2.30 or less, since the affinity between the first dichroic azo coloring agent compound and the second dichroic azo coloring agent compound is enhanced and an aligned structure is more easily formed, the alignment degree of the light absorption anisotropic layer is further improved.

Further, in a case where the first dichroic azo coloring agent compound or the second dichroic azo coloring agent compound has a plurality of side chains, it is preferable that at least one difference in log P value is in the above-described ranges.

Here, the side chain of the first dichroic azo coloring agent compound and the side chain of the second dichroic azo coloring agent compound denote a group bonded to the terminal of the above-described chromophore. For example, R1, R2, and R3 in Formula (1) represent a side chain in a case where the first dichroic azo coloring agent compound is a compound represented by Formula (1), and R4, R5, and R6 in Formula (2) represent a side chain in a case where the second dichroic azo coloring agent compound is a compound represented by Formula (2). Particularly, in a case where the first dichroic azo coloring agent compound is a compound represented by Formula (1) and the second dichroic azo coloring agent compound is a compound represented by Formula (2), it is preferable that at least one of the difference in log P value between R1 and R4, the difference in log P value between R1 and R5, the difference in log P value between R2 and R4, or the difference in log P value between R2 and R5 is in the above-described ranges.

Here, the log P value is an index for expressing the properties of the hydrophilicity and hydrophobicity of a chemical structure and is also referred to as a hydrophilic-hydrophobic parameter. The log P value can be calculated using software such as ChemBioDraw Ultra or HSPiP (Ver. 4.1.07). Further, the log P value can be acquired experimentally by the method of the OECD Guidelines for the Testing of Chemicals, Sections 1, Test No. 117 or the like. In the present invention, a value calculated by inputting the structural formula of a compound to HSPiP (Ver. 4.1.07) is employed as the log P value unless otherwise specified.

(Third Dichroic Azo Coloring Agent Compound)

The third dichroic azo coloring agent compound is a dichroic azo coloring agent compound other than the first dichroic azo coloring agent compound and the second dichroic azo coloring agent compound, and specifically, the chemical structure thereof is different from those of the first dichroic azo coloring agent compound and the second dichroic azo coloring agent compound. In a case where the light absorption anisotropic layer contains the third dichroic azo coloring agent compound, there is an advantage that the tint of the light absorption anisotropic layer is easily adjusted.

The maximum absorption wavelength of the third dichroic azo coloring agent compound is 380 nm or greater and less than 455 nm and preferably in a range of 385 to 454 nm.

Specific examples of the third dichroic azo coloring agent compound include compounds other than the first dichroic azo coloring agent compound and the second dichroic azo coloring agent compound among the compounds represented by Formula (1) described in WO2017/195833A.

Specific examples of the third dichroic coloring agent compound are shown below, but the present invention is not limited thereto. In the following specific examples, n represents an integer of 1 to 10.

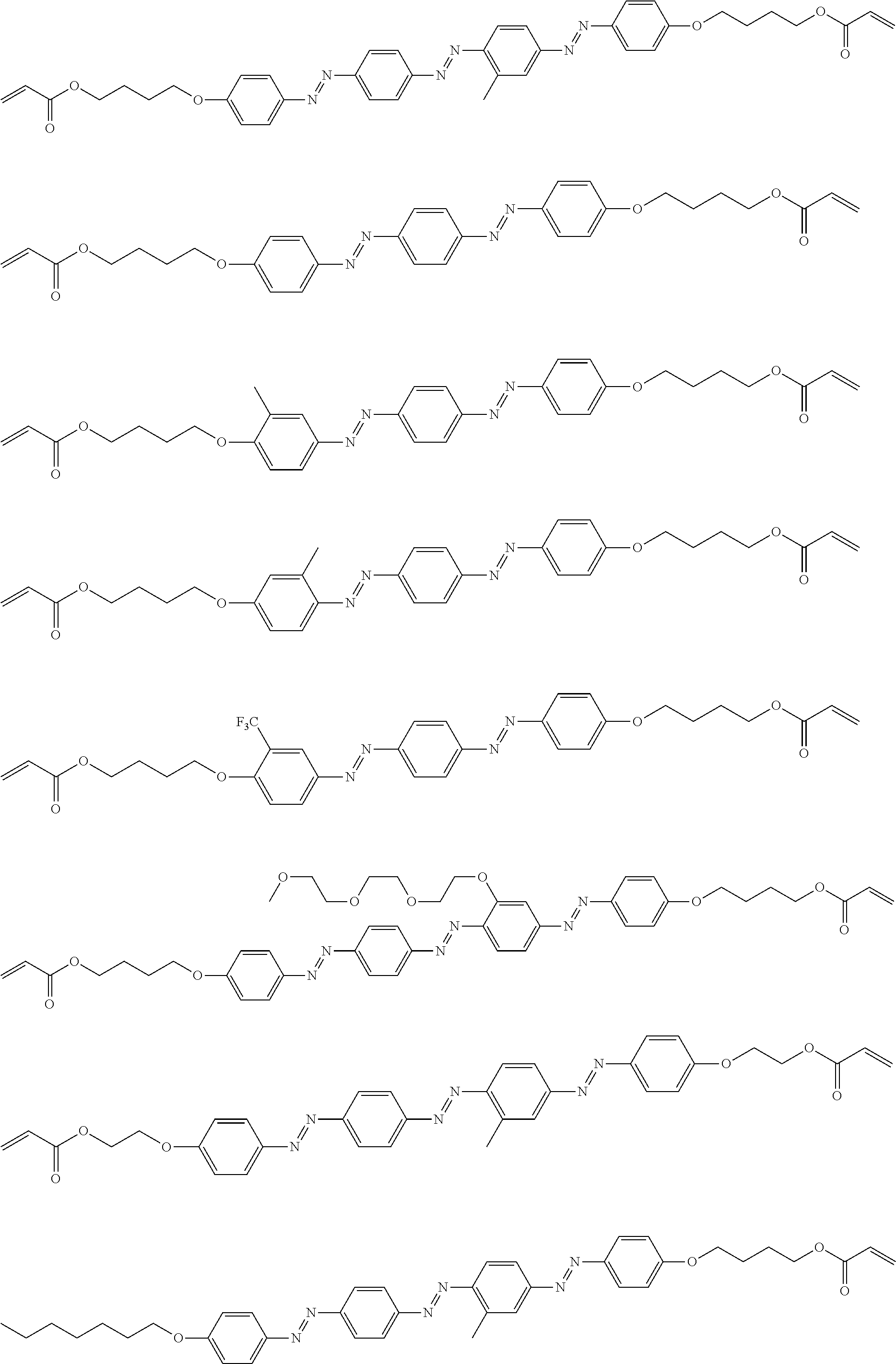

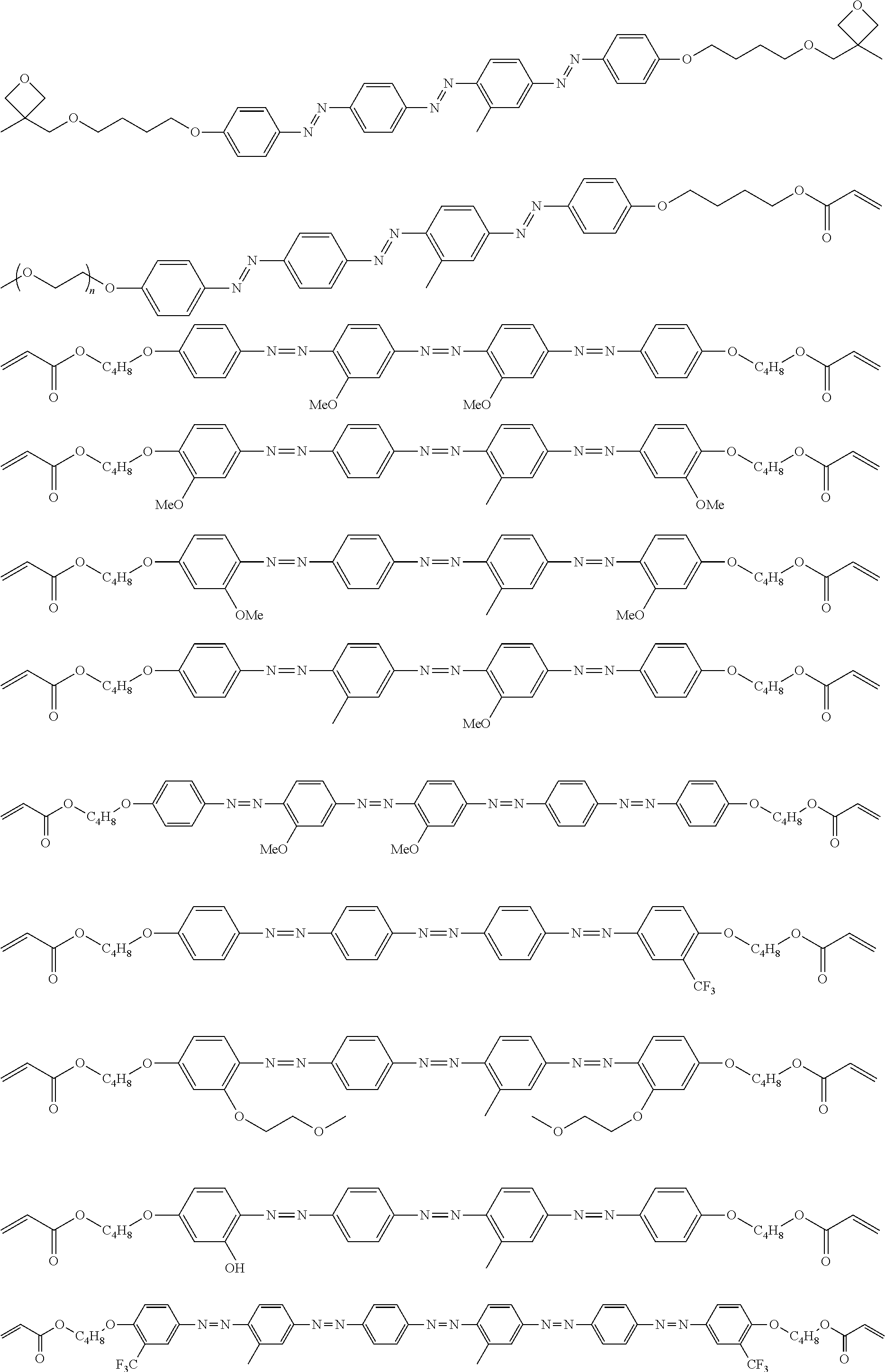

(Content of Dichroic Azo Coloring Agent Compound)

The content of the dichroic azo coloring agent compound is preferably in a range of 15% to 30% by mass, more preferably in a range of 18% to 28% by mass, and still more preferably in a range of 20% to 26% by mass with respect to the total mass of the solid content of the light absorption anisotropic layer. In a case where the content of the dichroic azo coloring agent compound is in the above-described ranges, a light absorption anisotropic layer having a high alignment degree can be obtained even in a case where the light absorption anisotropic layer is formed into a thin film. Therefore, a light absorption anisotropic layer having excellent flexibility is likely to be obtained. Further, in a case where the content thereof is greater than 30% by mass, it is difficult to suppress internal reflection by a refractive index adjusting layer.

The content of the first dichroic azo coloring agent compound is preferably in a range of 40 to 90 parts by mass and more preferably in a range of 45 to 75 parts by mass with respect to 100 parts by mass of the total content of the dichroic azo coloring agent compound in the composition for forming a light absorption anisotropic layer.

The content of the second dichroic azo coloring agent compound is preferably in a range of 6 to 50 parts by mass and more preferably in a range of 8 to 35 parts by mass with respect to 100 parts by mass of the total content of the dichroic azo coloring agent compound in the composition for forming a light absorption anisotropic layer.

The content of the third dichroic azo coloring agent compound is preferably in a range of 3 to 35 parts by mass and more preferably in a range of 5 to 30 parts by mass with respect to 100 parts by mass of the content of the dichroic azo coloring agent compound in the composition for forming a light absorption anisotropic layer.

The content ratio between the first dichroic azo coloring agent compound, the second dichroic azo coloring agent compound, and the third dichroic azo coloring agent compound used as necessary can be optionally set in order to adjust the tint of the light absorption anisotropic layer. Here, the content ratio of the second dichroic azo coloring agent compound to the first dichroic azo coloring agent compound (second dichroic azo coloring agent compound/first dichroic azo coloring agent compound) is preferably in a range of 0.1 to 10, more preferably in a range of 0.2 to 5, and still more preferably in a range of 0.3 to 0.8 in terms of moles. In a case where the content ratio of the second dichroic azo coloring agent compound to the first dichroic azo coloring agent compound is in the above-described ranges, the alignment degree is increased.

<Liquid Crystal Compound>

The composition for forming a light absorption anisotropic layer may contain a liquid crystal compound. In a case where the composition contains a liquid crystal compound, the dichroic substance (particularly, the dichroic azo coloring agent compound) can be aligned with a high alignment degree while the precipitation of the dichroic substance (particularly, the dichroic azo coloring agent compound) is suppressed.

The liquid crystal compound is a liquid crystal compound that does not exhibit dichroism.

As the liquid crystal compound, both a low-molecular-weight liquid crystal compound and a polymer liquid crystal compound can be used, but a polymer liquid crystal compound is more preferable from the viewpoint of obtaining a high alignment degree. Here, the term “low-molecular-weight liquid crystal compound” denotes a liquid crystal compound having no repeating units in the chemical structure. Here, the term “polymer liquid crystal compound” denotes a liquid crystal compound having a repeating unit in the chemical structure.

Examples of the low-molecular-weight liquid crystal compound include liquid crystal compounds described in JP2013-228706A.

Examples of the polymer liquid crystal compound include thermotropic liquid crystal polymers described in JP2011-237513A. Further, the polymer liquid crystal compound may contain a crosslinkable group (such as an acryloyl group or a methacryloyl group) at a terminal.

The liquid crystal compound may be used alone or in combination of two or more kinds thereof.

The content of the liquid crystal compound is preferably in a range of 100 to 600 parts by mass, more preferably in a range of 200 to 450 parts by mass, and still more preferably in a range of 250 to 400 parts by mass with respect to 100 parts by mass of the content of the organic dichroic substance (particularly, the dichroic azo coloring agent compound) in the composition for forming alight absorption anisotropic layer. Ina case where the content of the liquid crystal compound is in the above-described ranges, the alignment degree of the light absorption anisotropic layer is further improved.

From the viewpoint that the alignment degree of the dichroic substance (particularly, the dichroic azo coloring agent compound) is more excellent, it is preferable that the liquid crystal compound is a polymer liquid crystal compound having a repeating unit represented by Formula (3-1) (hereinafter, also referred to as “repeating unit (3-1)”).

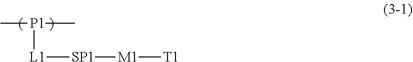

In Formula (3-1), P1 represents the main chain of the repeating unit, L1 represents a single bond or a divalent linking group, SP1 represents a spacer group, M1 represents a mesogen group, and T1 represents a terminal group.

Further, in the repeating unit (3-1), the difference between the log P value of P1, L1, and SP1 and the log P value of M1 is preferably 4 or greater and more preferably 4.5 or greater. The repeating unit is in a state in which the compatibility between the mesogen group and the structure from the main chain to the spacer group is low because the log P value of the main chain, L1, and the spacer group and the log P value of the mesogen group are separated by a predetermined value or greater. In this manner, it is assumed that since the crystallinity of the polymer liquid crystal compound increases, the alignment degree of the polymer liquid crystal compound increases. As described above, it is assumed that in a case where the alignment degree of the polymer liquid crystal compound is high, the compatibility between the polymer liquid crystal compound and the organic dichroic substance (particularly, the dichroic azo coloring agent compound) is decreased (that is, the crystallinity of the dichroic azo coloring agent compound is improved), and the alignment degree of the dichroic azo coloring agent compound is improved. As a result, it is considered that the alignment degree of the light absorption anisotropic layer to be obtained is increased.

Specific examples of the main chain of the repeating unit represented by P1 include groups represented by Formulae (P1-A) to (P1-D). Among these, from the viewpoints of diversity and handleability of a monomer serving as a raw material, a group represented by Formula (P1-A) is preferable.

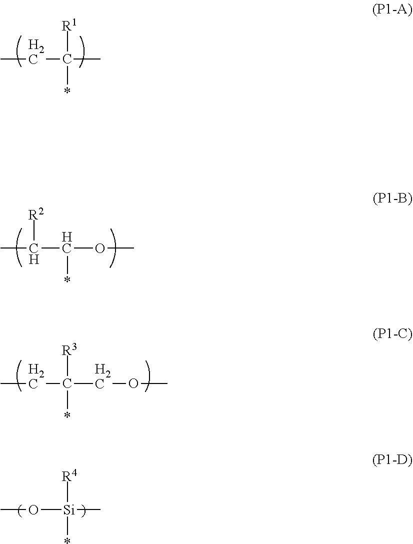

In Formulae (P1-A) to (P1-D), “*” represents a bonding position with respect to L1 in Formula (3-1).

In Formulae (P1-A) to (P1-D), R¹, R², R³, and R⁴ each independently represent a hydrogen atom, a halogen atom, a cyano group, an alkyl group having 1 to 10 carbon atoms, or an alkoxy group having 1 to 10 carbon atoms. The alkyl group may be a linear or branched alkyl group or an alkyl group having a cyclic structure (cycloalkyl group). Further, the number of carbon atoms of the alkyl group is preferably in a range of 1 to 5.

It is preferable that the group represented by Formula (P1-A) is a unit of a partial structure of poly(meth)acrylic acid ester obtained by polymerization of (meth)acrylic acid ester.

It is preferable that the group represented by Formula (P1-B) is an ethylene glycol unit formed by ring-opening polymerization of an epoxy group of a compound containing the epoxy group.

It is preferable that the group represented by Formula (P1-C) is a propylene glycol unit formed by ring-opening polymerization of an oxetane group of a compound containing the oxetane group.

It is preferable that the group represented by Formula (P1-D) is a siloxane unit of a polysiloxane obtained by polycondensation of a compound containing at least one of an alkoxysilyl group or a silanol group. Here, examples of the compound containing at least one of an alkoxysilyl group or a silanol group include a compound containing a group represented by Formula SiR¹⁴(OR¹⁵)₂—. In the formula, R¹⁴ has the same definition as that for R¹⁴ in (P1-D), and a plurality of R⁵'s each independently represent a hydrogen atom or an alkyl group having 1 to 10 carbon atoms.

L1 represents a single bond or a divalent linking group.

Examples of the divalent linking group represented by L1 include —C(O)O—, —OC(O)—, —O—, —S—, —C(O)NR³—, —NR³C(O)—, —SO₂—, and —NR³R⁴—. In the formulae, R³ and R⁴ each independently represent a hydrogen atom or an alkyl group having 1 to 6 carbon atoms which may have a substituent.

In a case where P1 represents a group represented by Formula (P1-A), from the viewpoint that the alignment degree of the light absorption anisotropic layer is more excellent, it is preferable that L1 represents a group represented by —C(O)O—.

In a case where P1 represents a group represented by any of Formulae (P1-B) to (P1-D), from the viewpoint that the alignment degree of the light absorption anisotropic layer is more excellent, it is preferable that L1 represents a single bond.

From the viewpoints of easily exhibiting liquid crystallinity and the availability of raw materials, it is preferable that the spacer group represented by SP1 has at least one structure selected from the group consisting of an oxyethylene structure, an oxypropylene structure, a polysiloxane structure, and an alkylene fluoride structure.

Here, as the oxyethylene structure represented by SP1, a group represented by *—(CH₂—CH₂O)ₙ₁—* is preferable. In the formula, n1 represents an integer of 1 to 20, and * represents a bonding position with respect to L1 or M1 in Formula (3-1). From the viewpoint that the alignment degree of the light absorption anisotropic layer is more excellent, n1 represents preferably an integer of 2 to 10, more preferably an integer of 2 to 4, and most preferably 3. Further, from the viewpoint that the alignment degree of the light absorption anisotropic layer is more excellent, a group represented by *—(CH(CH₃)—CH₂O)ₙ₂—* is preferable as the oxypropylene structure represented by SP1. In the formula, n2 represents an integer of 1 to 3, and “*” represents a bonding position with respect to L1 or M1.

Further, from the viewpoint that the alignment degree of the light absorption anisotropic layer is more excellent, a group represented by *—(Si(CH₃)₂—O)ₙ₃—* is preferable as the polysiloxane structure represented by SP1. In the formula, n3 represents an integer of 6 to 10, and “*” represents a bonding position with respect to L1 or M1.

Further, from the viewpoint that the alignment degree of the light absorption anisotropic layer is more excellent, a group represented by *—(CF₂—CF₂)ₙ₄—* is preferable as the alkylene fluoride structure represented by SP1. In the formula, n4 represents an integer of 6 to 10, and “*” represents a bonding position with respect to L1 or M1.

The mesogen group represented by M1 is a group showing a main skeleton of a liquid crystal molecule that contributes to liquid crystal formation. A liquid crystal molecule exhibits liquid crystallinity which is in an intermediate state (mesophase) between a crystal state and an isotropic liquid state. The mesogen group is not particularly limited and for example, particularly description on pages 7 to 16 of “FlussigeKristalle in Tabellen II” (VEB Deutsche Verlag fur Grundstoff Industrie, Leipzig, 1984) and particularly the description in Chapter 3 of “Liquid Crystal Handbook” (Maruzen, 2000) edited by Liquid Crystals Handbook Editing Committee can be referred to.

As the mesogen group, for example, a group having at least one cyclic structure selected from the group consisting of an aromatic hydrocarbon group, a heterocyclic group, and an alicyclic group is preferable.

From the viewpoint that the alignment degree of the light absorption anisotropic layer is more excellent, the mesogen group contains preferably an aromatic hydrocarbon group, more preferably two to four aromatic hydrocarbon groups, and still more preferably three aromatic hydrocarbon groups.

From the viewpoints of exhibiting the liquid crystallinity, adjusting the liquid crystal phase transition temperature, and the availability of raw materials and synthetic suitability and from the viewpoint that the alignment degree of the light absorption anisotropic layer is more excellent, as the mesogen group, a group represented by Formula (M1-A) or Formula (M1-B) is preferable, and a group represented by Formula (M1-B) is more preferable.

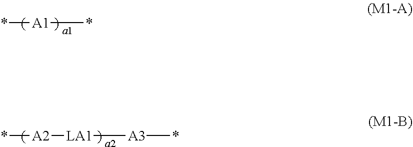

In Formula (M1-A), A1 represents a divalent group selected from the group consisting of an aromatic hydrocarbon group, a heterocyclic group, and an alicyclic group. These groups may be substituted with an alkyl group, a fluorinated alkyl group, an alkoxy group, or a substituent.

It is preferable that the divalent group represented by A1 is a 4- to 6-membered ring. Further, the divalent group represented by A1 may be a monocycle or a fused ring.

Further, “*” represents a bonding position with respect to SP1 or T1.

Examples of the divalent aromatic hydrocarbon group represented by A1 include a phenylene group, a naphthylene group, a fluorene-diyl group, an anthracene-diyl group, and a tetracene-diyl group. From the viewpoints of design diversity of a mesogenic skeleton and the availability of raw materials, a phenylene group or a naphthylene group is preferable, and a phenylene group is more preferable.

The divalent heterocyclic group represented by A1 may be any of aromatic or non-aromatic, but a divalent aromatic heterocyclic group is preferable as the divalent heterocyclic group from the viewpoint of further improving the alignment degree.

The atoms other than carbon constituting the divalent aromatic heterocyclic group include a nitrogen atom, a sulfur atom, and an oxygen atom. In a case where the aromatic heterocyclic group has a plurality of atoms constituting a ring other than carbon, these may be the same as or different from each other.

Specific examples of the divalent aromatic heterocyclic group include a pyridylene group (pyridine-diyl group), a pyridazine-diyl group, an imidazole-diyl group, a thienylene group (thiophene-diyl group), a quinolylene group (quinoline-diyl group), an isoquinolylene group (isoquinoline-diyl group), an oxazole-diyl group, a thiazole-diyl group, an oxadiazole-diyl group, a benzothiazole-diyl group, a benzothiadiazole-diyl group, a phthalimido-diyl group, a thienothiazole-diyl group, a thiazolothiazole-diyl group, a thienothiophene-diyl group, and a thienooxazole-diyl group.

Specific examples of the divalent alicyclic group represented by A1 include a cyclopentylene group and a cyclohexylene group.

In Formula (M1-A), a1 represents an integer of 1 to 10. In a case where a1 represents 2 or greater, a plurality of A1's may be the same as or different from each other.

In Formula (M1-B), A2 and A3 each independently represent a divalent group selected from the group consisting of an aromatic hydrocarbon group, a heterocyclic group, and an alicyclic group. Specific examples and preferred embodiments of A2 and A3 are the same as those for A1 in Formula (M1-A), and thus description thereof will not be repeated. In Formula (M1-B), a2 represents an integer of 1 to 10. In a case where a2 represents 2 or greater, a plurality of A2's may be the same as or different from each other, a plurality of A3's may be the same as or different from each other, and a plurality of LA1's may be the same as or different from each other. From the viewpoint that the alignment degree of the light absorption anisotropic layer is more excellent, a2 represents preferably an integer of 2 or greater and more preferably 2.

In Formula (M1-B), in a case where a2 represents 1, LA1 represents a divalent linking group. In a case where a2 represents 2 or greater, a plurality of LA1's each independently represent a single bond or a divalent linking group, and at least one of the plurality of LA1's is a divalent linking group. In a case where a2 represents 2, from the viewpoint that the alignment degree of the light absorption anisotropic layer is more excellent, it is preferable that one of the two LA1's represents a divalent linking group and the other represents a single bond.

In Formula (M1-B), examples of the divalent linking group represented by LA1 include —O—, —(CH₂)_{g}—, —(CF₂)_{g}—, —Si(CH₃)₂—, —(Si(CH₃)₂O)_{g}—, —(OSi(CH₃)₂)_{g}— (g represents an integer of 1 to 10), —N(Z)—, —C(Z)═C(Z′)—, —C(Z)═N—, —N═C(Z)—, —C(Z)₂—C(Z′)₂—, —C(O)—, —OC(O)—, —C(O)O—, —O—C(O)O—, —N(Z)C(O)—, —C(O)N(Z)—, —C(Z)═C(Z′)—C(O)O—, —O—C(O)—C(Z)═C(Z′)—, —C(Z)═N—, —N═C(Z)—, —C(Z)═C(Z′)—C(O)N(Z″)—, —N(Z″)—C(O)—C(Z)═C(Z′)—, —C(Z)═C(Z′)—C(O)—S—, —S—C(O)—C(Z)═C(Z′)—, —C(Z)═N—N═C(Z′)— (Z, Z′, and Z″ each independently represent a hydrogen atom, a C1 to C4 alkyl group, a cycloalkyl group, an aryl group, a cyano group, or a halogen atom), —C≡C—, —N═N—, —S—, —S(O)—, —S(OXO)—, —(O)S(O)O—, —O(O)S(O)O—, —SC(O)—, and —C(O)S—.

Among these, from the viewpoint that the alignment degree of the light absorption anisotropic layer is more excellent, —C(O)O— is preferable.

LA1 may represent a group obtained by combining two or more of these groups.

Specific examples of M1 include the following structures. In the following specific examples, “Ac” represents an acetyl group.

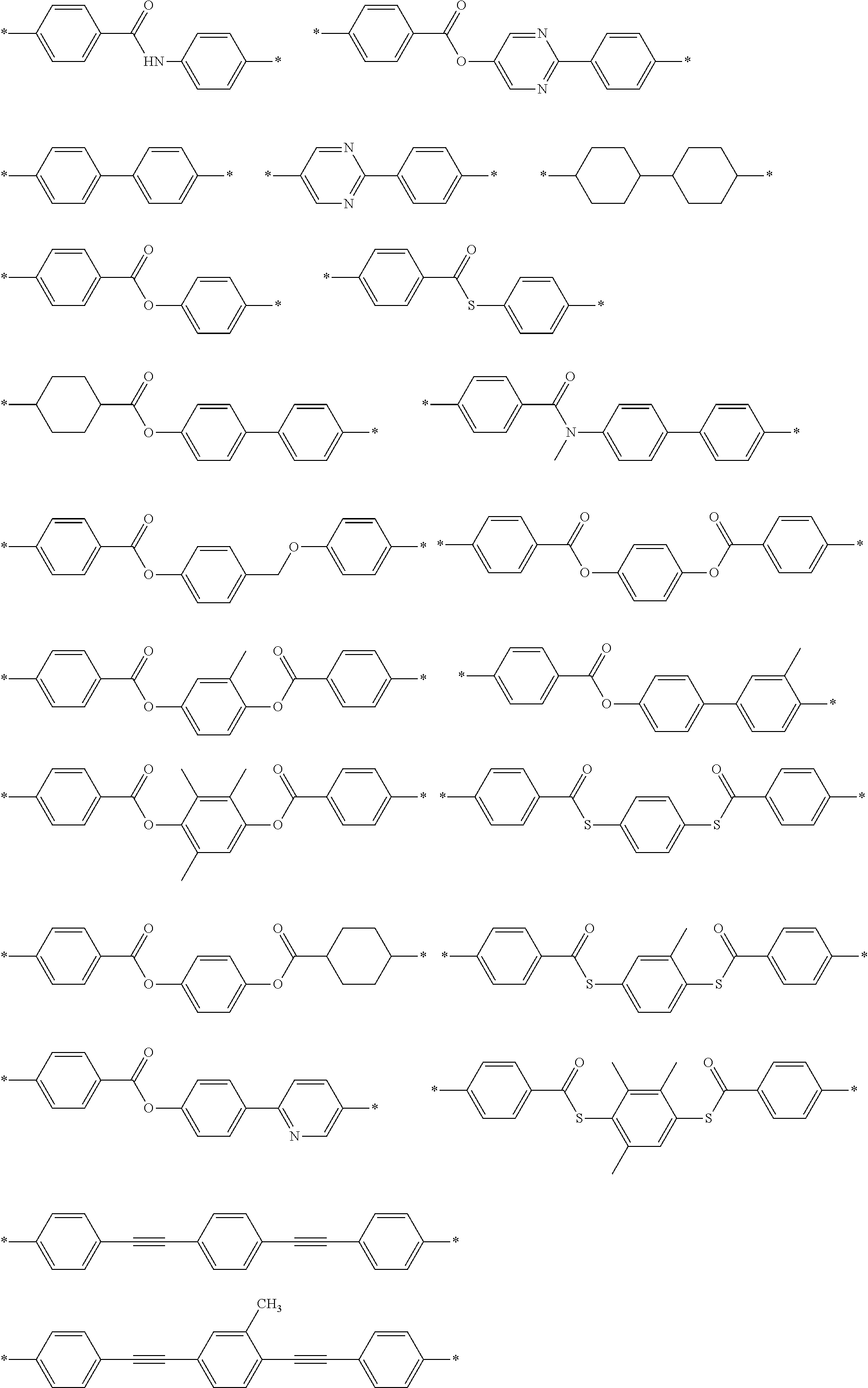

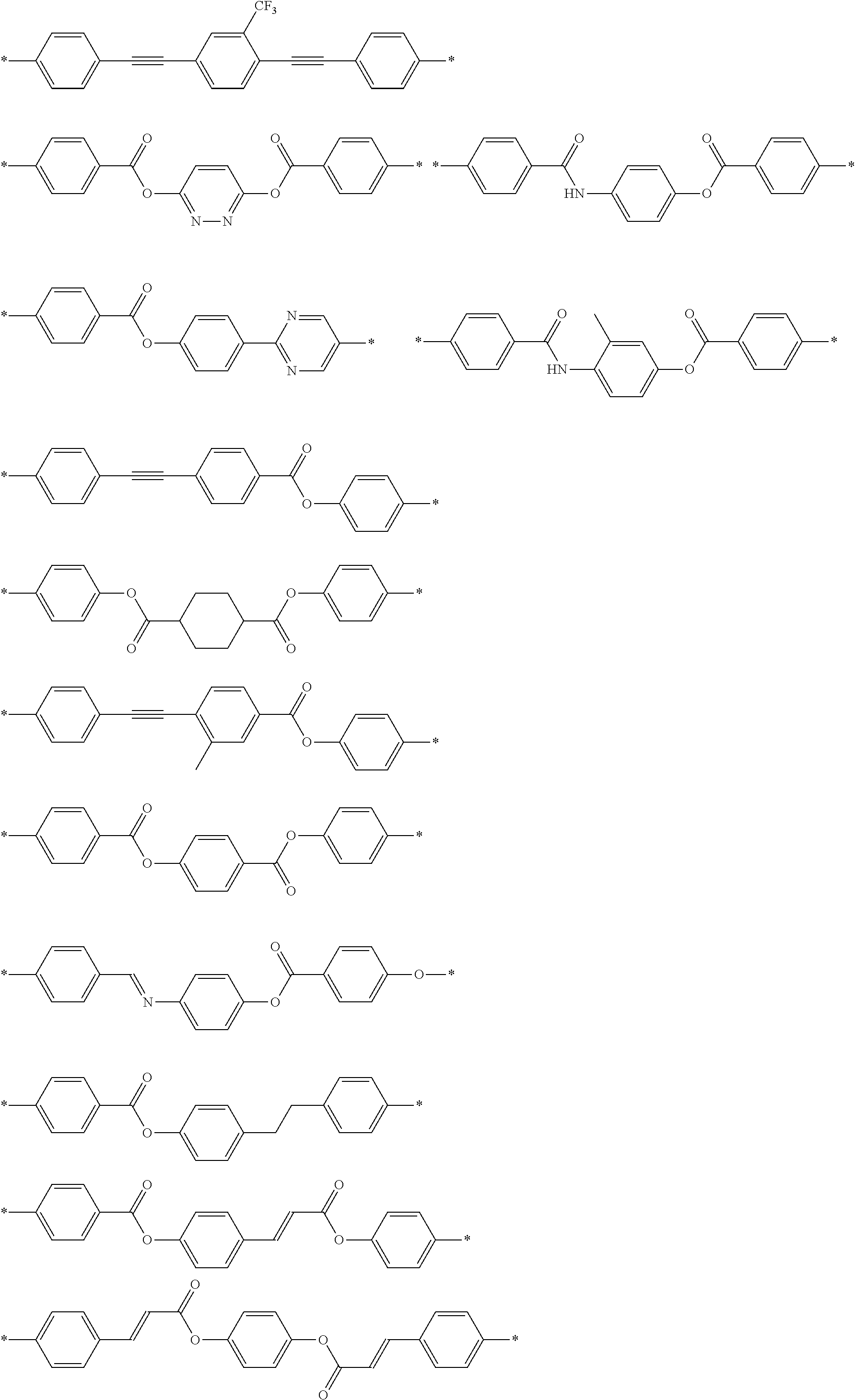

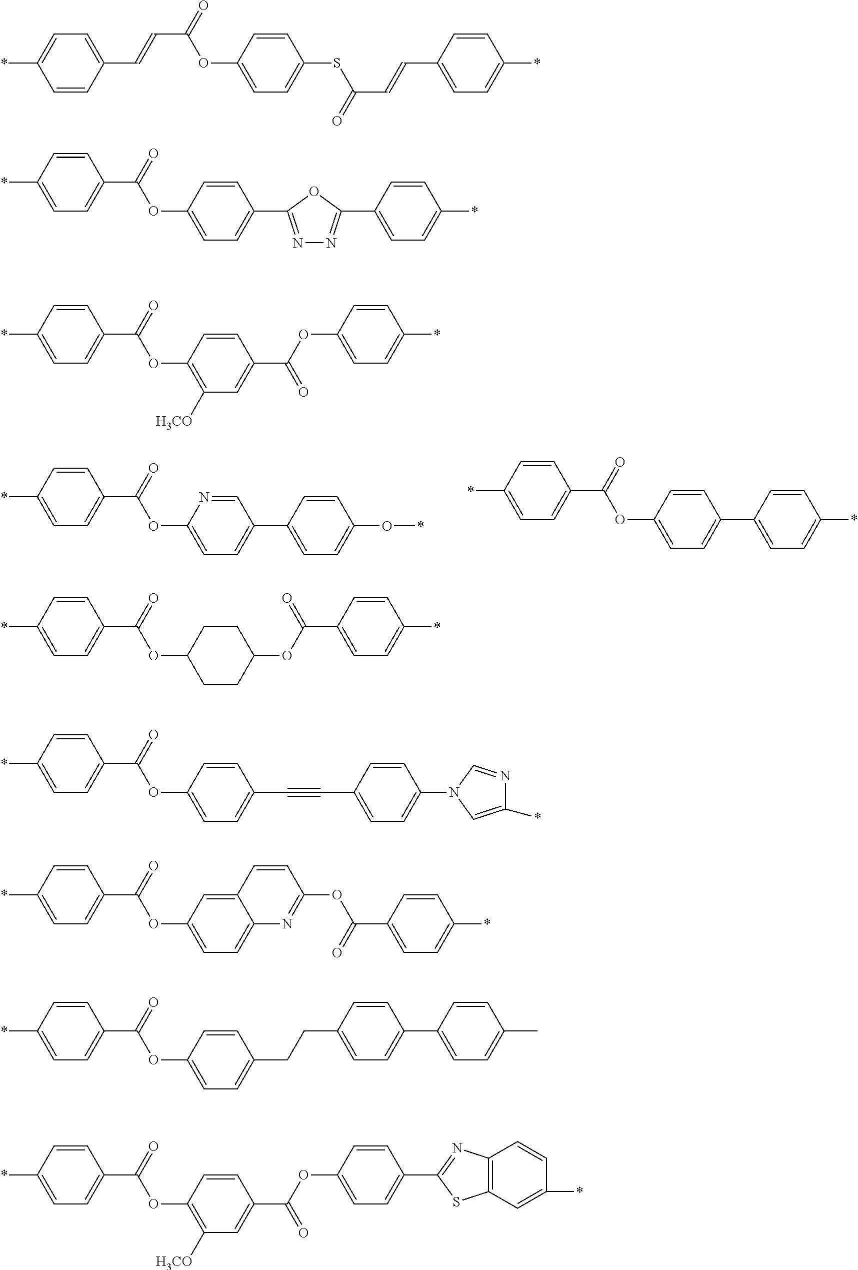

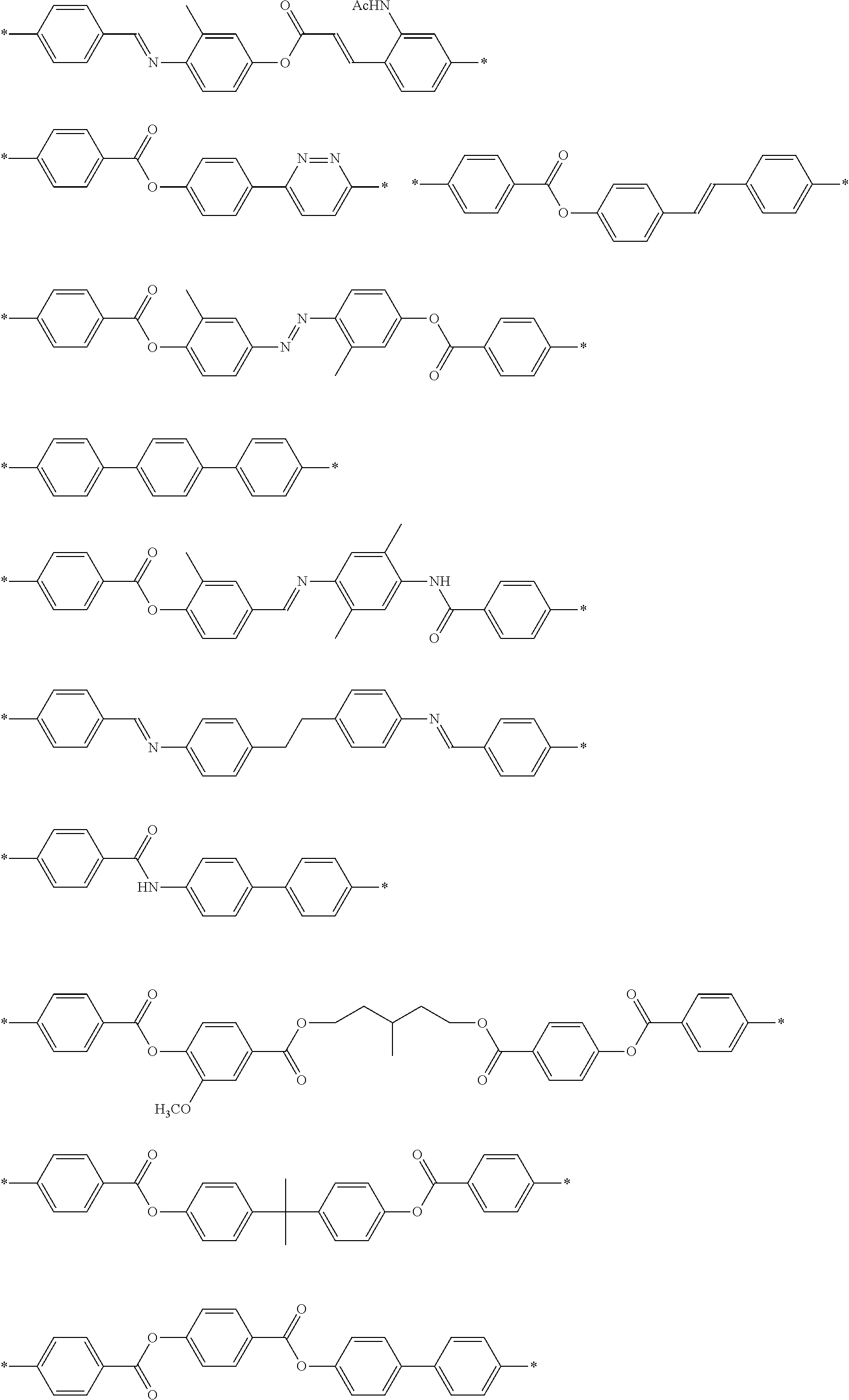

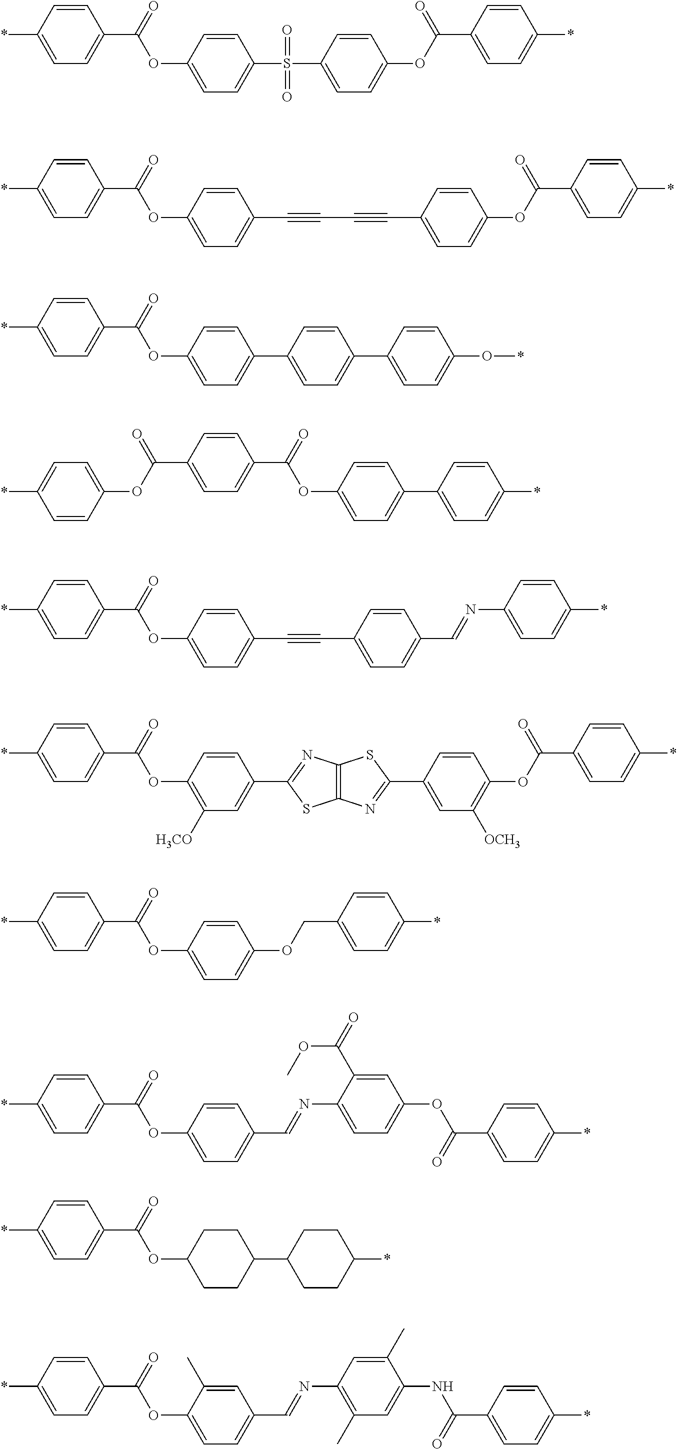

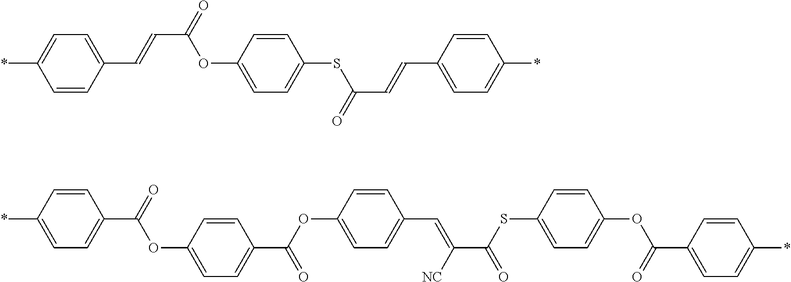 [SMILES: *c1ccc(/C=C/C(=O)Oc2ccc(SC(=O)/C=C/c3ccc(*)cc3)cc2)cc1 ; *c1ccc(C(=O)Oc2ccc(SC(=O)/C(C#N)=C/c3ccc(OC(=O)c4ccc(OC(=O)c5ccc(*)cc5)cc4)cc3)cc2)cc1]

Examples of the terminal group represented by T1 include a hydrogen atom, a halogen atom, a cyano group, a nitro group, a hydroxy group, an alkyl group having 1 to 10 carbon atoms, an alkoxy group having 1 to 10 carbon atoms, an alkylthio group having 1 to 10 carbon atoms, an alkoxycarbonyloxy group having 1 to 10 carbon atoms, an alkoxycarbonyl group having 1 to 10 carbon atoms (ROC(O)—: R represents an alkyl group), an acyloxy group having 1 to 10 carbon atoms, an acylamino group having 1 to 10 carbon atoms, an alkoxycarbonylamino group having 1 to 10 carbon atoms, a sulfonylamino group having 1 to 10 carbon atoms, a sulfamoyl group having 1 to 10 carbon atoms, a carbamoyl group having 1 to 10 carbon atoms, a sulfinyl group having 1 to 10 carbon atoms, a ureido group having 1 to 10 carbon atoms, and a (meth)acryloyloxy group-containing group. Examples of the (meth)acryloyloxy group-containing group include a group represented by -L-A (L represents a single bond or a linking group, specific examples of the linking group are the same as those for L1 and SP1 described above. A represents a (meth)acryloyloxy group).

From the viewpoint that the alignment degree of the light absorption anisotropic layer is more excellent, T1 represents preferably an alkoxy group having 1 to 10 carbon atoms, more preferably an alkoxy group having 1 to 5 carbon atoms, and still more preferably a methoxy group. These terminal groups may be further substituted with these groups or the polymerizable groups described in JP2010-244038A.

From the viewpoint that the alignment degree of the light absorption anisotropic layer is more excellent, the number of atoms in the main chain of T1 is preferably in a range of 1 to 20, more preferably in a range of 1 to 15, still more preferably in a range of 1 to 10, and particularly preferably in a range of 1 to 7. In a case where the number of atoms in the main chain of T1 is 20 or less, the alignment degree of the light absorption anisotropic layer is further improved. Here, the “main chain” in T1 indicates the longest molecular chain bonded to M1, and the number of hydrogen atoms is not included in the number of atoms in the main chain of T1. For example, the number of atoms in the main chain is 4 in a case where T1 represents an n-butyl group, the number of atoms in the main chain is 3 in a case where T1 represents a sec-butyl group.

From the viewpoint that the alignment degree of the light absorption anisotropic layer is more excellent, the content of the repeating unit (3-1) is preferably in a range of 20% to 100% by mass with respect to 100% by mass of all the repeating units of the polymer liquid crystal compound.

In the present invention, the content of each repeating unit contained in the polymer liquid crystal compound is calculated based on the charged amount (mass) of each monomer used for obtaining each repeating unit.

The polymer liquid crystal compound may have only one or two or more kinds of repeating units (3-1). In a case where the polymer liquid crystal compound has two or more kinds of repeating units (3-1), there is an advantage in that the solubility of the polymer liquid crystal compound in a solvent is improved and the liquid crystal phase transition temperature is easily adjusted. In a case where the polymer liquid crystal compound has two or more kinds of repeating units (3-1), it is preferable that the total amount thereof is in the above-described ranges.

In a case where the polymer liquid crystal compound has two kinds of the repeating units (3-1), from the viewpoint that the alignment degree of the light absorption anisotropic layer is more excellent, it is preferable that the terminal group represented by T1 in one unit (repeating unit A) is an alkoxy group and the terminal group represented by T1 in the other unit (repeating unit B) is a group other than the alkoxy group.

From the viewpoint that the alignment degree of the light absorption anisotropic layer is more excellent, as the terminal group represented by T1 in the repeating unit B, an alkoxycarbonyl group, a cyano group, or a (meth)acryloyloxy group-containing group is preferable, and an alkoxycarbonyl group or a cyano group is more preferable.

From the viewpoint that the alignment degree of the light absorption anisotropic layer is more excellent, the ratio (A/B) of the content of the repeating unit A in the polymer liquid crystal compound to the content of the repeating unit B in the polymer liquid crystal compound is preferably in a range of 50/50 to 95/5, more preferably in a range of 60/40 to 93/7, and still more preferably in a range of 70/30 to 90/10.

<Repeating Unit (3-2)>

The polymer liquid crystal compound of the present invention may further have a repeating unit represented by Formula (3-2) (in the present specification, also referred to as “repeating unit (3-2)”). This provides advantages such as improvement of the solubility of the polymer liquid crystal compound in a solvent and ease of adjustment of the liquid crystal phase transition temperature.

The repeating unit (3-2) is different from the repeating unit (3-1) in terms that the repeating unit (3-2) does not contain at least a mesogen group.

In a case where the polymer liquid crystal compound has the repeating unit (3-2), the polymer liquid crystal compound is a copolymer of the repeating unit (3-1) and the repeating unit (3-2) (or may be a copolymer having repeating units A and B) and may be any polymer such as a block polymer, an alternating polymer, a random polymer, or a graft polymer.

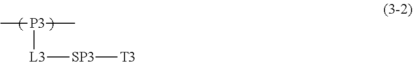

In Formula (3-2), P3 represents the main chain of the repeating unit, L3 represents a single bond or a divalent linking group, SP3 represents a spacer group, and T3 represents a terminal group.

Specific examples of P3, L3, SP3, and T3 in Formula (3-2) are the same as those for P1, L1, SP1, and T1 in Formula (3-1).

Here, from the viewpoint of improving the strength of the light absorption anisotropic layer, it is preferable that T3 in Formula (3-2) contains a polymerizable group.

The content of the repeating unit (3-2) is preferably in a range of 0.5% to 40% by mass and more preferably in a range of 1% to 30% by mass with respect to 100% by mass of all the repeating units of the polymer liquid crystal compound.

The polymer liquid crystal compound may have only one or two or more kinds of repeating units (3-2). In a case where the polymer liquid crystal compound has two or more kinds of repeating units (3-2), it is preferable that the total amount thereof is in the above-described ranges.

(Weight-Average Molecular Weight)

From the viewpoint that the alignment degree of the light absorption anisotropic layer is more excellent, the weight-average molecular weight (Mw) of the polymer liquid crystal compound is preferably in a range of 1000 to 500000 and more preferably in a range of 2000 to 300000. In a case where the Mw of the polymer liquid crystal compound is in the above-described ranges, the polymer liquid crystal compound is easily handled.

In particular, from the viewpoint of suppressing cracking during the coating, the weight-average molecular weight (Mw) of the polymer liquid crystal compound is preferably 10000 or greater and more preferably in a range of 10000 to 300000.

In addition, from the viewpoint of the temperature latitude of the alignment degree, the weight-average molecular weight (Mw) of the polymer liquid crystal compound is preferably less than 10000 and preferably 2000 or greater and less than 10000.

Here, the weight-average molecular weight and the number average molecular weight in the present invention are values measured according to gel permeation chromatography (GPC).
Solvent (eluent): N-methylpyrrolidone
Device name: TOSOH HLC-8220GPC
Column: Connect and use three of TOSOH TSKgel Super AWM-H (6 mm×15 cm)
Column temperature: 25° C.
Sample concentration: 0.1% by mass
Flow rate: 0.35 mL/min
Calibration curve: TSK standard polystyrene (manufactured by TOSOH Corporation), calibration curves of 7 samples with Mw of 2800000 to 1050 (Mw/Mn=1.03 to 1.06) are used.

<Polymerization Initiator>

It is preferable that the composition for forming a light absorption anisotropic layer contains a polymerization initiator.

It is preferable that the polymerization initiator to be used is a photopolymerization initiator capable of initiating a polymerization reaction by irradiation with ultraviolet rays.

Examples of the photopolymerization initiator include α-carbonyl compounds (described in the specifications of U.S. Pat. Nos. 2,367,661A and 2,367,670A), acyloin ether (described in the specification of U.S. Pat. No. 2,448,828A), α-hydrocarbon-substituted aromatic acyloin compounds (described in the specification of U.S. Pat. No. 2,722,512A), polynuclear quinone compounds (described in the specifications of U.S. Pat. Nos. 3,046,127A and 2,951,758A), a combination of a triarylimidazole dimer and a p-aminophenyl ketone (described in the specification of U.S. Pat. No. 3,549,367A), acridine and phenazine compounds (described in the specifications of JP1985-105667A (JP-S60-105667A) and U.S. Pat. No. 4,239,850A), oxadiazole compounds (described in the specification of U.S. Pat. No. 4,212,970A), and acylphosphine oxide compounds (described in JP1988-40799B (JP-S63-40799B), JP1993-29234B (JP-H5-29234B), JP1998-95788A (JP-H10-95788A), and JP1998-29997A (JP-H10-29997A)).

Further, in the present invention, it is also preferable that the polymerization initiator is an oxime-type polymerization initiator, and specific examples thereof include the initiators described in paragraphs [0049] to [0052] of WO2017/170443A.

In a case where the composition for forming a light absorption anisotropic layer contains a polymerization initiator, the content of the polymerization initiator is preferably in a range of 0.01 to 30 parts by mass and more preferably in a range of 0.1 to 15 parts by mass with respect to 100 parts by mass of the total amount of the dichroic substance and the liquid crystal compound in the composition for forming a light absorption anisotropic layer. The durability of the polarizing layer is enhanced in a case where the content of the polymerization initiator is 0.01 parts by mass or greater, and the alignment degree of the polarizing layer is further enhanced in a case where the content thereof is 30 parts by mass or less.

The polymerization initiator may be used alone or in combination of two or more kinds thereof. In a case where the composition contains two or more kinds of polymerization initiators, it is preferable that the total amount of the polymerization initiators is in the above-described ranges.

<Solvent>

From the viewpoints of the workability and the like, it is preferable that the composition for forming a light absorption anisotropic layer contains a solvent.

Examples of the organic solvent include those described in the section of the composition for forming a photo-alignment film according to the embodiment of the present invention.

In a case where the composition for forming a light absorption anisotropic layer contains a solvent, the content of the solvent is preferably in a range of 80% to 99% by mass, more preferably in a range of 83% to 97% by mass, and particularly preferably in a range of 85% to 95% by mass with respect to the total mass of the composition for forming a light absorption anisotropic layer.

These solvents may be used alone or in combination of two or more kinds thereof. In a case where the composition contains two or more kinds of solvents, it is preferable that the total amount of the solvents is in the above-described range.

<Method of Forming Light Absorption Anisotropic Layer>

A method of forming the light absorption anisotropic layer is not particularly limited, and examples thereof include a method of sequentially performing a step of coating the above-described photo-alignment film with the above-described composition for forming a light absorption anisotropic layer to form a coating film (hereinafter, also referred to as “coating film forming step”) and a step of aligning the liquid crystal component contained in the coating film (hereinafter, also referred to as “aligning step”).

Further, the liquid crystal component is a component that also contains a dichroic substance having liquid crystallinity in a case where the above-described dichroic substance has liquid crystallinity, in addition to the above-described liquid crystal compound.

(Coating Film Forming Step)

The coating film forming step is a step of coating the photo-alignment film with the composition for forming a light absorption anisotropic layer to form a coating film.

The photo-alignment film is easily coated with the composition for forming a light absorption anisotropic layer by using the composition for forming a light absorption anisotropic layer which contains the above-described solvent or using a liquid-like material such as a melt obtained by heating the composition for forming a light absorption anisotropic layer.

Examples of the method of coating the photo-alignment film with the composition for forming a light absorption anisotropic layer include known methods such as a roll coating method, a gravure printing method, a spin coating method, a wire bar coating method, an extrusion coating method, a direct gravure coating method, a reverse gravure coating method, a die coating method, a spraying method, and an ink jet method.

(Aligning Step)

The aligning step is a step of aligning the liquid crystal component contained in the coating film. In this manner, a polarizing layer is obtained.

The aligning step may include a drying treatment. Components such as a solvent can be removed from the coating film by performing the drying treatment. The drying treatment may be performed according to a method of allowing the coating film to stand at room temperature for a predetermined time (for example, natural drying) or a method of heating the coating film and/or blowing air to the coating film.

Here, the liquid crystal component contained in the composition for forming a light absorption anisotropic layer may be aligned by the coating film forming step or the drying treatment described above. For example, in an aspect in which the composition for forming a light absorption anisotropic layer is prepared as a coating solution containing a solvent, a coating film having light absorption anisotropy (that is, a light absorption anisotropic film) is obtained by drying the coating film and removing the solvent from the coating film.

In a case where the drying treatment is performed at a temperature higher than or equal to the transition temperature of the liquid crystal component contained in the coating film to the liquid crystal phase, the heat treatment described below may not be performed.

The transition temperature of the liquid crystal component contained in the coating film to the liquid crystal phase is preferably in a range of 10° C. to 250° C. and more preferably in a range of 25° C. to 190° C. from the viewpoint of the manufacturing suitability or the like. It is preferable that the transition temperature is 10° C. or higher from the viewpoint that a cooling treatment or the like for lowering the temperature to a temperature range in which a liquid crystal phase is exhibited is not necessary. Further, it is preferable that the transition temperature is 250° C. or lower from the viewpoint that a high temperature is not required even in a case of setting an isotropic liquid state at a temperature higher than the temperature range in which a liquid crystal phase is temporarily exhibited, and waste of thermal energy and deformation and deterioration of a substrate can be reduced.

It is preferable that the aligning step includes a heat treatment. In this manner, since the liquid crystal component contained in the coating film can be aligned, the coating film after being subjected to the heat treatment can be suitably used as the light absorption anisotropic film.

From the viewpoint of the manufacturing suitability, the heat treatment is performed at a temperature of preferably 10° C. to 250° C. and more preferably 25° C. to 190° C. Further, the heating time is preferably in a range of 1 to 300 seconds and more preferably in a range of 1 to 60 seconds.

The aligning step may include a cooling treatment performed after the heat treatment. The cooling treatment is a treatment of cooling the coating film after being heated to room temperature (20° C. to 25° C.). In this manner, the alignment of the liquid crystal component contained in the coating film can be fixed. The cooling means is not particularly limited and can be performed according to a known method.

The light absorption anisotropic film can be obtained by performing the above-described steps.

In the present aspect, examples of the method of aligning the liquid crystal components contained in the coating films include a drying treatment and a heat treatment, but the method is not limited thereto, and the liquid crystal components can be aligned by a known alignment treatment.

(Other Steps)

A method of forming the light absorption anisotropic layer may include a step of curing the polarizing layer after the aligning step (hereinafter, also referred to as “curing step”).

The curing step is performed by heating the polarizing layer and/or irradiating the polarizing layer with light (exposing the layer to light), for example, in a case where the polarizing layer contains a crosslinkable group (polymerizable group). Between these, it is preferable that the curing step is performed by irradiating the layer with light.

Various light sources such as infrared rays, visible light, and ultraviolet rays can be used as the light source for curing, but ultraviolet rays are preferable. In addition, ultraviolet rays may be applied while the film is heated during curing, or ultraviolet rays may be applied through a filter that transmits only a specific wavelength.

In a case where the exposure is performed while the film is heated, the heating temperature during the exposure depends on the transition temperature of the liquid crystal component contained in the light absorption anisotropic film to a liquid crystal phase, but is preferably 250 to 140° C.

Further, the exposure may be performed under a nitrogen atmosphere. In a case where the curing of the light absorption anisotropic film proceeds by radical polymerization, since the inhibition of polymerization by oxygen is reduced, it is preferable that exposure is performed in a nitrogen atmosphere.

The thickness of the light absorption anisotropic layer is not particularly limited, but is preferably in a range of 100 to 8000 nm and more preferably in a range of 300 to 5000 nm from the viewpoint of the flexibility.

[Image Display Device]

Since the optical laminate according to the embodiment of the present invention can be made thinner by peeling off the base material, the optical laminate can be suitably used in a case of preparing an image display device.

The display element used in the image display device is not particularly limited, and examples thereof include a liquid crystal cell, an organic electroluminescence (hereinafter, abbreviated as “EL”) display panel, and a plasma display panel.

Among these, a liquid crystal cell or an organic EL display panel is preferable, and a liquid crystal cell is more preferable. That is, as the image display device, a liquid crystal display device formed of a liquid crystal cell as a display element or an organic EL display device formed of an organic EL display panel as a display element is preferable, and a liquid crystal display device is more preferable.

[Liquid Crystal Display Device]

The liquid crystal display device which is an example of the image display device is a liquid crystal display device including the above-described optical laminate according to the embodiment of the present invention and a liquid crystal cell.

In addition, in the present invention, it is preferable that the optical laminate according to the embodiment of the present invention is used as a front-side polarizing plate between the polarizing plates provided on both sides of the liquid crystal cell.

Hereinafter, the liquid crystal cell constituting the liquid crystal display device will be described in detail.

<Liquid Crystal Cell>

It is preferable that the liquid crystal cell used for the liquid crystal display device is in a vertical alignment (VA) mode, an optically compensated bend (OCB) mode, an in-plane-switching (IPS) mode, or a twisted nematic (TN) mode, but the present invention is not limited thereto.

In the liquid crystal cell in a TN mode, rod-like liquid crystal molecules (rod-like liquid crystal compound) are substantially horizontally aligned in a case of no voltage application and further twistedly aligned at 60° to 120°. The liquid crystal cell in a TN mode is most frequently used as a color TFT liquid crystal display device and is described in a plurality of documents.

In the liquid crystal cell in a VA mode, rod-like liquid crystal molecules are substantially vertically aligned at the time of no voltage application. The concept of the liquid crystal cell in a VA mode includes (1) liquid crystal cell in a VA mode in a narrow sense where rod-like liquid crystal molecules are aligned substantially vertically in a case of no voltage application and substantially horizontally in a case of voltage application (described in JP1990-176625A (JP-H2-176625A)), (2) liquid crystal cell (in a multi-domain vertical alignment (MVA) mode) (SID97, described in Digest of tech. Papers (proceedings) 28 (1997) 845) in which the VA mode is formed to have multi-domain in order to expand the viewing angle, (3) liquid crystal cell in an axially symmetric aligned microcell (n-ASM) mode in which rod-like liquid crystal molecules are substantially vertically aligned in a case of no voltage application and twistedly multi-domain aligned in a case of voltage application (described in proceedings of Japanese Liquid Crystal Conference, pp. 58 and 59 (1998)), and (4) liquid crystal cell in a super ranged viewing by vertical alignment (SURVIVAL) mode (presented at liquid crystal display (LCD) International 98). Further, the liquid crystal cell may be of any of a patterned vertical alignment (PVA) type, a photo-alignment (optical alignment) type, or a polymer-sustained alignment (PSA) type. Details of these modes are described in JP2006-215326A and JP2008-538819A.

In the liquid crystal cell in an IPS mode, rod-like liquid crystal molecules are aligned substantially parallel to the substrate, and the liquid crystal molecules respond planarly through application of an electric field parallel to the substrate surface. In the IPS mode, black display is carried out in a state where no electric field is applied, and absorption axes of a pair of upper and lower polarizing plates are orthogonal to each other. A method of reducing leakage light during black display in an oblique direction and improve the viewing angle using an optical compensation sheet is disclosed in JP1998-54982A (JP-H10-54982A), JP1999-202323A (JP-H11-202323A), JP1997-292522A (JP-H9-292522A), JP1999-133408A (JP-H11-133408A), JP1999-305217A (JP-H11-305217A), and JP1998-307291A (JP-H10-307291A).

[Organic EL Display Device]

As an organic EL display device which is an example of the image display device according to the embodiment of the present invention, an aspect of a display device including the above-described polarizer according to the embodiment of the present invention, a plate having a λ/4 function (hereinafter, also referred to as “λ/4 plate”), and an organic EL display panel in this order from the viewing side is suitably exemplified.

Here, “plate having a λ/4 function” denotes a plate having a function of converting linearly polarized light having a specific wavelength to circularly polarized light (or converting circularly polarized light into linearly polarized light), and specific examples of an aspect in which the λ/4 plate has a single-layer structure include a stretched polymer film and a phase difference film provided with an optically anisotropic layer having a λ/4 function on a support, and specific examples of an aspect in which the λ/4 plate has a multi-layer structure include a broadband λ/4 plate formed by laminating a λ/4 plate and a λ/2 plate.

Further, the organic EL display panel is a display panel formed using an organic EL element having an organic light-emitting layer (organic electroluminescence layer) interposed between electrodes (between a cathode and an anode). The configuration of the organic EL display panel is not particularly limited, and a known configuration is employed.

### EXAMPLES

Hereinafter, the present invention will be described in more detail with reference to examples. Materials, used amounts, ratios, treatment contents, treatment procedures, and the like described in the following examples can be appropriately changed without departing from the spirit of the present invention. Therefore, the scope of the present invention should not be limitatively interpreted by the following examples.

### Example 1

[Preparation of Cellulose Acylate Film 1]

<Preparation of Core Layer Cellulose Acylate Dope>

The following composition was put into a mixing tank and stirred to dissolve each component, thereby preparing a cellulose acetate solution used as a core layer cellulose acylate dope.

Core layer cellulose acylate dope
Cellulose acetate having acetyl substitution degree of 2.88: 100 parts by mass
Polyester compound B described in example of JP2015-227955A: 12 parts by mass
Compound F shown below: 2 parts by mass
Methylene chloride (first solvent): 430 parts by mass
Methanol (second solvent): 64 parts by mass

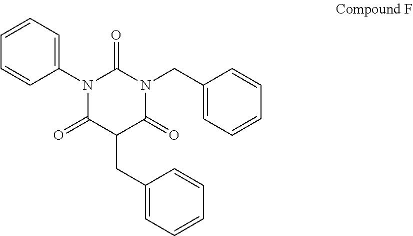 [SMILES: O=C1C(Cc2ccccc2)C(=O)N(c2ccccc2)C(=O)N1Cc1ccccc1]

<Preparation of Outer Layer Cellulose Acylate Dope>

10 parts by mass of the following matting agent solution was added to 90 parts by mass of the above-described core layer cellulose acylate dope, thereby preparing a cellulose acetate solution used as an outer layer cellulose acylate dope.

Matting agent solution
Silica particles with average particle size of 20 nm (AEROSIL R972,
manufactured by Nippon Aerosil Co., Ltd.): 2 parts by mass
Methylene chloride (first solvent): 76 parts by mass
Methanol (second solvent): 11 parts by mass
Core layer cellulose acylate dope described above: 1 parts by mass

<Preparation of Cellulose Acylate Film 1>

The core layer cellulose acylate dope and the outer layer cellulose acylate dope were filtered through filter paper having an average pore size of 34 μm and a sintered metal filter having an average pore size of 10 μm, and three layers which were the core layer cellulose acylate dope and the outer layer cellulose acylate dopes provided on both sides of the core layer cellulose acylate dope were simultaneously cast from a casting port onto a drum at 20° C. (band casting machine).

Next, the film was peeled off in a state where the solvent content was approximately 20% by mass, both ends of the film in the width direction were fixed by tenter clips, and the film was dried while being stretched at a stretching ratio of 1.1 times in the lateral direction.

Thereafter, the film was further dried by being transported between the rolls of the heat treatment device to prepare an optical film having a thickness of 40 μm, and the optical film was used as a cellulose acylate film 1. The in-plane retardation of the obtained cellulose acylate film 1 was 0 nm.

[Preparation of Laminate A1]

As described below, a laminate A1 including the cellulose acylate film 1, the photo-alignment film PA1, the liquid crystal layer P1, the cured layer N1, and the oxygen blocking layer B1 adjacent to each other in this order was prepared.

<Preparation of TAC Film Provided with Photo-Alignment Film>

The cellulose acylate film 1 was continuously coated with the following coating solution PA1 for forming an alignment film using a #4 wire bar. The support on which the coating film was formed was dried with hot air at 140° C. for 120 seconds, and the coating film was irradiated with polarized ultraviolet rays (10 mJ/cm², using an ultra-high pressure mercury lamp) to form a photo-alignment film PA1, thereby obtaining a TAC film provided with a photo-alignment film. The film thickness of the photo-alignment film PA1 was 0.5 μm.

(Coating solution PA1 for forming alignment film)
Polymer A1 shown below: 20.00 parts by mass
Polymer B1 shown below: 80.00 parts by mass
Acid generator SAN-AID SI-B3A: 12.00 parts by mass
DIPEA (N,N-diisopropylethylamine): 0.6 parts by mass
Xylene: 750.00 parts by mass
Methyl isobutyl ketone: 83.00 parts by mass

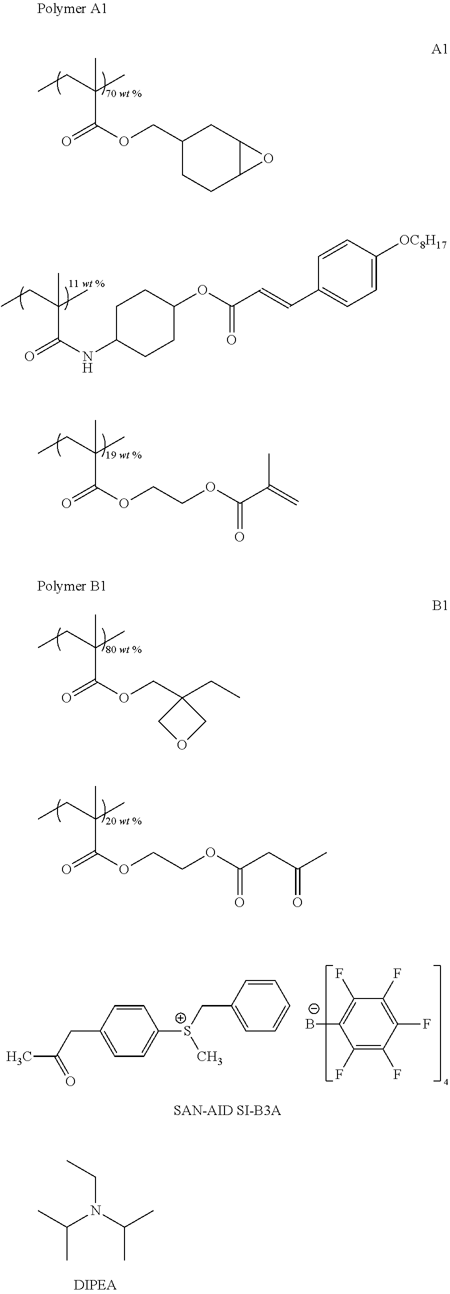

<Formation of Liquid Crystal Layer P1>

A coating layer P1 was formed by continuously coating the photo-alignment film PA1 of the obtained TAC film provided with the photo-alignment film with the following composition P1 for forming a liquid crystal layer using a wire bar.

Next, the coating layer P1 was heated at 140° C. for 30 seconds, and the coating layer P1 was cooled to room temperature (23° C.).

Next, the coating layer was heated at 90° C. for 60 seconds and cooled to room temperature again.

Thereafter, a liquid crystal layer P1 (light absorption anisotropic layer) was formed on the photo-alignment film PA1 by irradiating the coating layer with light (center wavelength of 365 nm) of a light emitting diode (LED) for 2 seconds under an irradiation condition of an illuminance of 200 mW/cm². The thickness of the liquid crystal layer P1 was 0.4 μm.

Composition of composition P1 for forming liquid crystal layer
Dichroic substance D-4 shown below: 0.36 parts by mass
Dichroic substance D-5 shown below: 0.53 parts by mass
Dichroic substance D-6 shown below: 0.31 parts by mass
Polymer liquid crystal compound P-2 shown below: 3.42 parts by mass
Low-molecular-weight liquid crystal compound M-1
shown below: 0.36 parts by mass
Polymerization initiator IRGACURE OXE-02
(manufactured by BASF SE): 0.050 parts by mass
Surfactant F-2 shown below: 0.026 parts by mass
Cyclopentanone: 45.00 parts by mass
Tetrahydrofuran: 45.00 parts by mass
Benzyl alcohol: 5.00 parts by mass

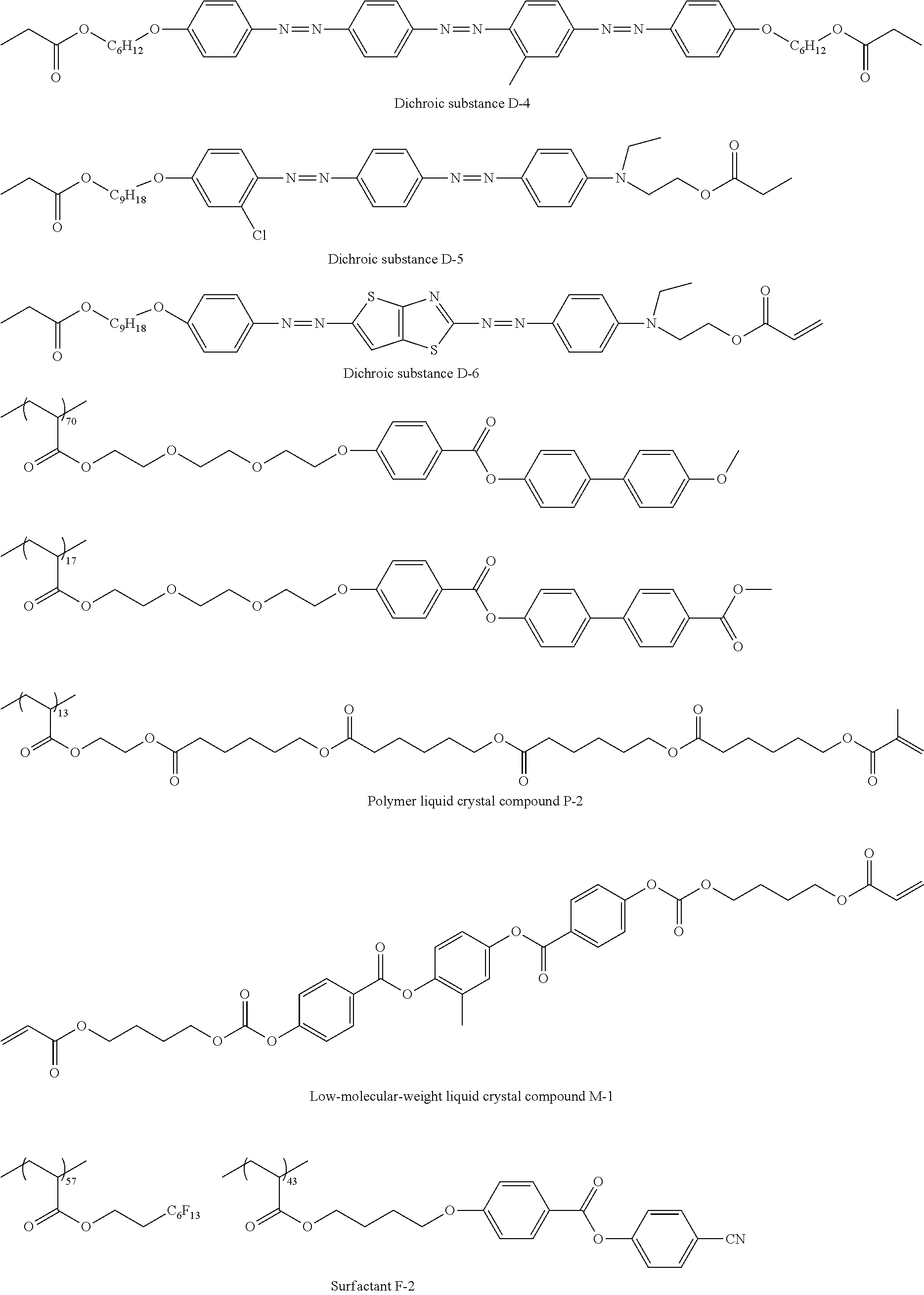

<Formation of Cured Layer N1>

The formed liquid crystal layer P1 was continuously coated with the following composition N1 for forming a cured layer using a wire bar, thereby forming a cured layer N1.

Thereafter, the cured layer N1 was dried at room temperature and irradiated using a high-pressure mercury lamp under an irradiation condition of an illuminance of 28 mW/cm² for 15 seconds, thereby preparing a cured layer N1 on the liquid crystal layer P1.

The film thickness of the cured layer N1 was 0.05 μm (50 nm).

Composition of composition N1 for forming a cured layer
Mixture L1 of rod-like liquid crystal compounds shown below: 2.61 parts by mass
Modified trimethylolpropane triacrylate shown below: 0.11 parts by mass
Photopolymerization initiator I-1 shown below: 0.05 parts by mass
Interface improver F-3 shown below: 0.21 parts by mass
Methyl isobutyl ketone: 297 parts by mass

Mixture L1 of rod-like liquid crystal compounds (the numerical values in the following formulae are denoted in units of % by mass, and R represents a group bonded with respect to an oxygen atom).

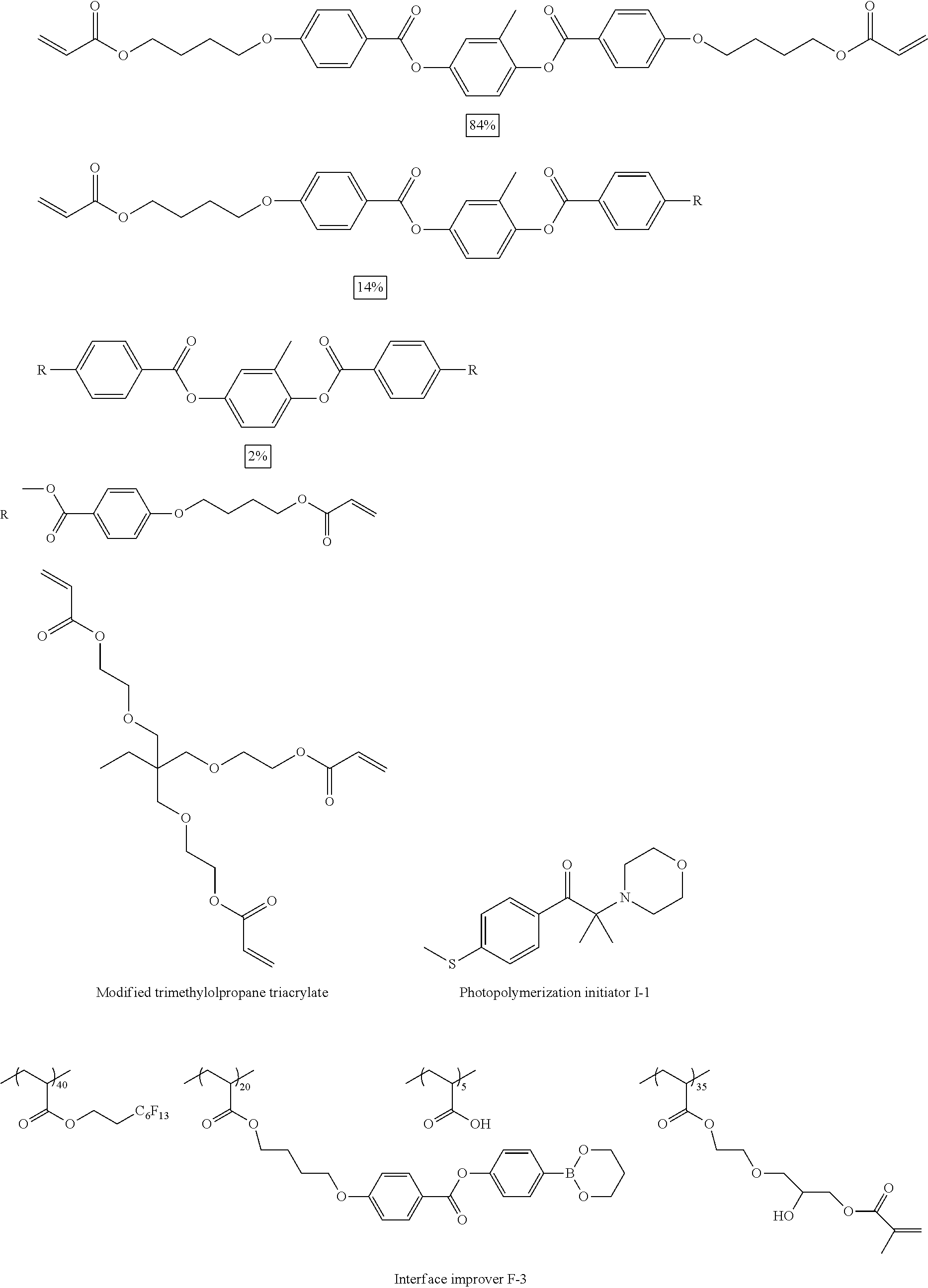

<Formation of Oxygen Blocking Layer B1>

The formed cured layer N1 was continuously coated with a coating solution having the following composition using a wire bar. Thereafter, the cured layer was dried with hot air at 100° C. for 2 minutes, thereby forming a polyvinyl alcohol (PVA) alignment film (oxygen blocking layer B1) having a thickness of 1.1 μm on the cured layer N1.

Composition of composition B1 for forming oxygen blocking layer
Modified polyvinyl alcohol shown below: 3.80 parts by mass
Initiator (IRGACURE 2959): 0.20 parts by mass
Water: 70 parts by mass
Methanol: 30 parts by mass

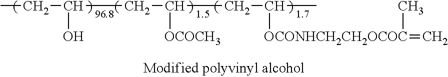

In this manner, a laminate A1 including the cellulose acylate film 1, the photo-alignment film PA1, the liquid crystal layer P1, the cured layer N1, and the oxygen blocking layer B1 adjacent to each other in this order was obtained.

[Preparation of Optical Laminate A1]

In this manner, an optical laminate A1 including the cellulose acylate film 1, the alignment film PA2, the positive C-plate C1, the UV adhesive layer, the positive A-plate A1 (λ/4 plate), the pressure sensitive adhesive A (the pressure sensitive adhesive layer 1), the photo-alignment film PA1, the liquid crystal layer P1 (light absorption anisotropic layer), the cured layer N1, the oxygen blocking layer B1, the pressure sensitive adhesive A (pressure sensitive adhesive layer 2), and the low-reflection surface film CV-LC5 (surface protective layer) adjacent to each other in this order was obtained.

<Preparation of TAC Film A1 Including Positive A-Plate A1>

The cellulose acylate film 1 was continuously coated with a coating solution PA10 for forming an alignment film described below using a wire bar. The support on which the coating film was formed was dried with hot air at 140° C. for 120 seconds, and the coating film was irradiated with polarized ultraviolet rays (10 mJ/cm², using an ultra-high pressure mercury lamp) to form a photo-alignment film PA10 having a thickness of 0.2 μm, thereby obtaining a TAC film with a photo-alignment film.

The photo-alignment film PA10 was coated with the composition A-1 having the composition described below using a bar coater. The coating film formed on the photo-alignment film PA10 was heated to 120° C. with hot air, cooled to 60° C., irradiated with ultraviolet rays having a wavelength of 365 nm with an illuminance of 100 mJ/cm² using a high-pressure mercury lamp in a nitrogen atmosphere, and continuously irradiated with ultraviolet rays with an illuminance of 500 mJ/cm² while being heated at 120° C. so that the alignment of the liquid crystal compound was fixed, thereby preparing a TAC film A1 having a positive A-plate A1.

The thickness of the positive A-plate A1 was 2.5 μm, and the Re (550) was 144 nm. Further, the positive A-plate A1 satisfied the relationship of “Re (450)≤Re (550)≤Re (650)”. Re (450)/Re (550) was 0.82.

(Coating solution PA10 for forming alignment film)
Polymer PA-10 shown below: 100.00 parts by mass
Acid generator PAG-1 shown below: 5.00 parts by mass
Acid generator CPI-110TF shown below: 0.005 parts by mass
Isopropyl alcohol: 16.50 parts by mass
Butyl acetate: 1072.00 parts by mass
Methyl ethyl ketone: 268.00 parts by mass

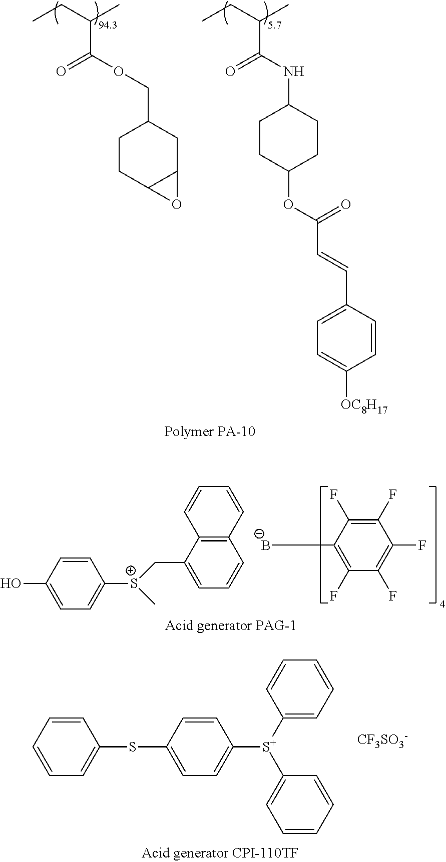

(Composition A-1)
Polymerizable liquid crystal compound L-1 shown below: 43.50 parts by mass
Polymerizable liquid crystal compound L-2 shown below: 43.50 parts by mass
Polymerizable liquid crystal compound L-3 shown below: 8.00 parts by mass
Polymerizable liquid crystal compound L-4 shown below: 5.00 parts by mass
Polymerization initiator PI-1 shown below: 0.55 parts by mass
Leveling agent T-1: 0.20 parts by mass
Cyclopentanone: 235.00 parts by mass

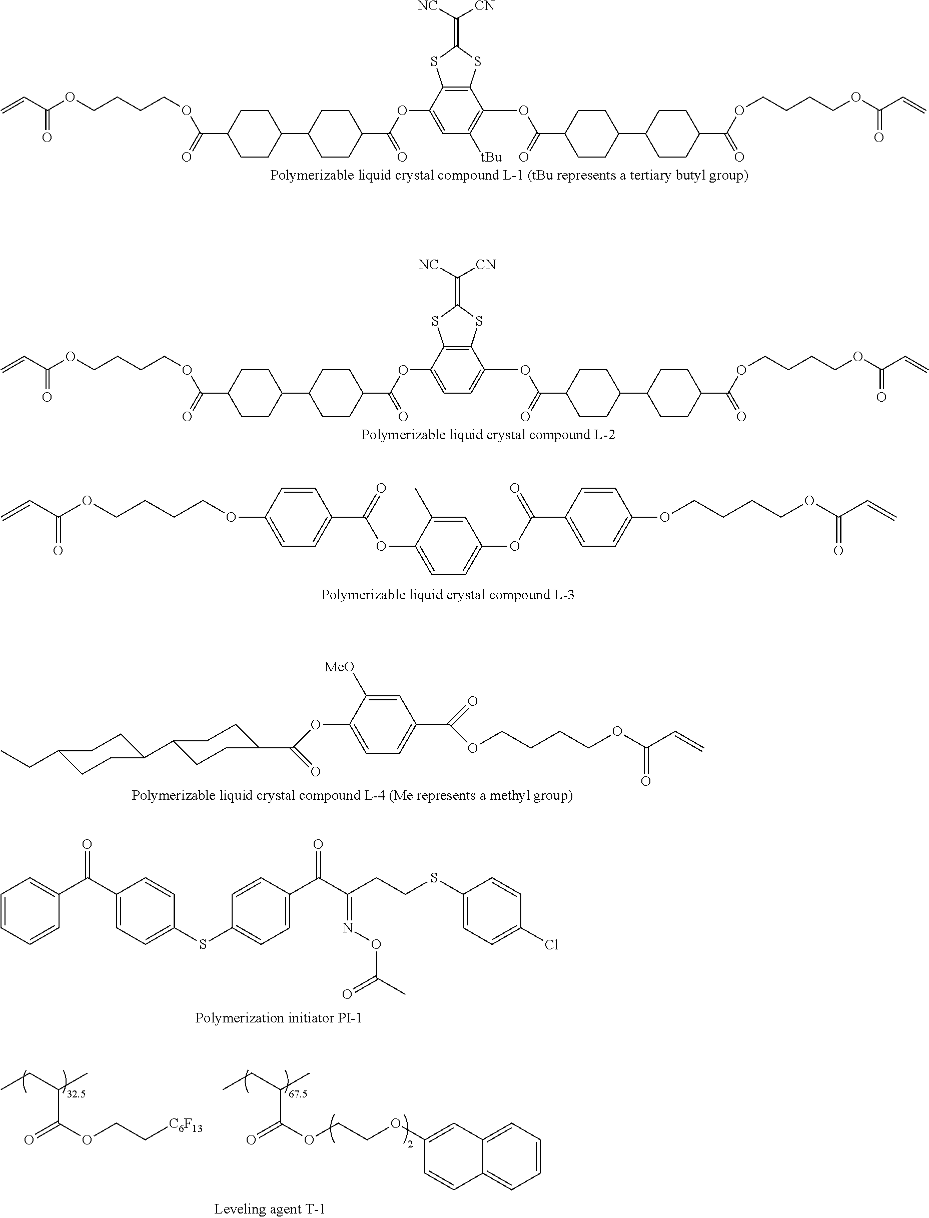

<Preparation of TAC Film C1 Having Positive C-Plate C1>

The above-described cellulose acylate film 1 was used as a temporary support.

The cellulose acylate film 1 was allowed to pass through a dielectric heating roll at a temperature of 60° C., the film surface temperature was increased to 40° C., one surface of the film was coated with an alkaline solution having the following composition such that the coating amount reached 14 ml/m² using a bar coater and heated to 110° C., and the film was transported for 10 seconds under a steam-type far-infrared heater (manufactured by Noritake Co., Ltd.).

Next, the film was coated with pure water such that the coating amount reached 3 ml/m² using the same bar coater.

Next, the process of washing the film with water using a fountain coater and draining the film using an air knife was repeated three times, and the film was transported to a drying zone at 70° C. for 10 seconds and dried, thereby preparing a cellulose acylate film 1 which had been subjected to an alkali saponification treatment.

(Alkaline solution)
Potassium hydroxide: 4.7 parts by mass
Water: 15.8 parts by mass
Isopropanol: 63.7 parts by mass
Fluorine-containing surfactant SF-1 (C₁₄H₂₉O(CH₂CH₂O)₂₀H): 1.0 parts by mass
Propylene glycol: 14.8 parts by mass

The cellulose acylate film 1 that had been subjected to the alkali saponification treatment was continuously coated with a coating solution PA2 for forming an alignment film having the following composition using a #8 wire bar. The obtained film was dried with hot air at 60° C. for 60 seconds and further dried with hot air at 100° C. for 120 seconds, thereby forming an alignment film PA2.

(Coating solution PA2 for forming alignment film)
Polyvinyl alcohol (PVA103, manufactured by Kuraray Co., Ltd.): 2.4 parts by mass
Isopropyl alcohol: 1.6 parts by mass
Methanol: 36 parts by mass
Water: 60 parts by mass

The alignment film PA2 was coated with a coating solution C1 for forming a positive C-plate described below, the obtained coating film was aged at 60° C. for 60 seconds and irradiated with ultraviolet rays with a light dose of 1000 mJ/cm² using an air-cooled metal halide lamp (manufactured by Eye Graphics Co., Ltd.) at an illuminance of 70 mW/cm² in the atmosphere, and the alignment state thereof was fixed to vertically align the liquid crystal compound, thereby preparing a TAC film C1 having a positive C-plate C1 with a thickness of 0.5 μm.

The Rth (550) of the obtained positive C-plate was −60 nm.

(Coating solution C1 for forming positive C-plate)
Liquid crystal compound L-11 shown below: 80 parts by mass
Liquid crystal compound L-12 shown below: 20 parts by mass
Vertically aligned liquid crystal compound (S01): 1 part by mass
Ethylene oxide-modified trimethylolpropane triacrylate (V#360, manufactured by
Osaka Organic Chemical Industry Ltd.): 8 parts by mass
IRGACURE 907 (manufactured by BASF SE): 3 parts by mass
KAYACURE DETX (manufactured by Nippon Kayaku Co., Ltd.): 1 part by mass
Compound B03 shown below: 0.4 parts by mass
Methyl ethyl ketone: 170 parts by mass
Cyclohexanone: 30 parts by mass

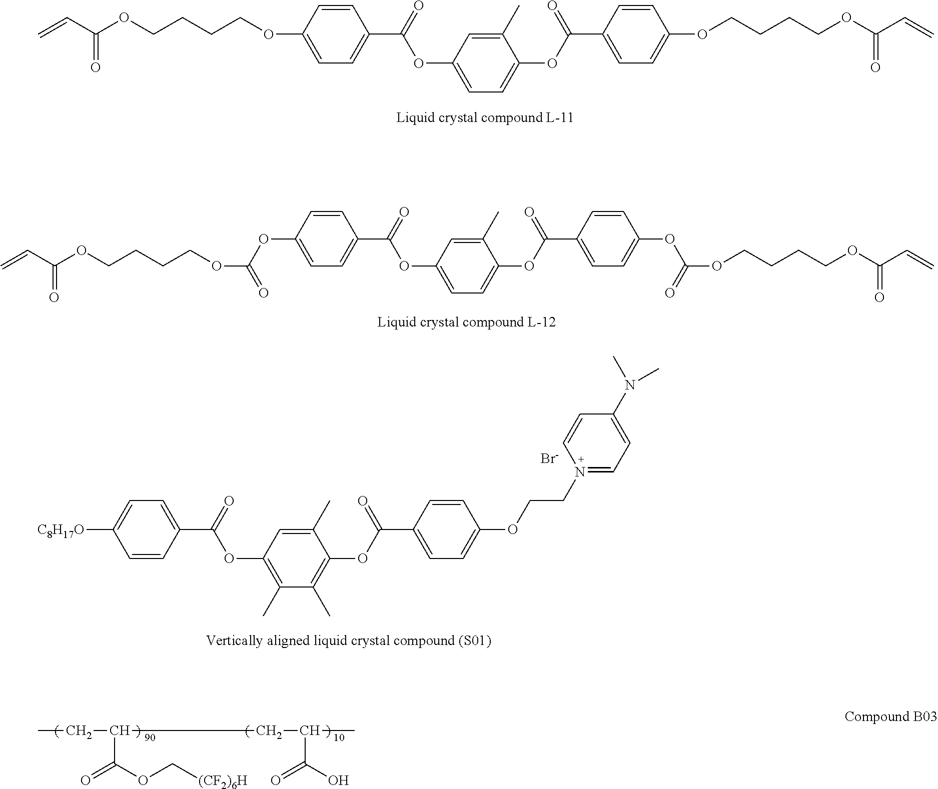

<Preparation of Pressure Sensitive Adhesive N>

Next, an acrylate-based polymer was prepared according to the following procedures.

95 parts by mass of butyl acrylate and 5 parts by mass of acrylic acid were polymerized by a solution polymerization method in a reaction container equipped with a cooling pipe, a nitrogen introduction pipe, a thermometer, and a stirrer, thereby obtaining an acrylate-based polymer (A1) with an average molecular weight of 2000000 and a molecular weight distribution (Mw/Mn) of 3.0.

Next, an acrylate-based pressure sensitive adhesive was prepared with the compositions listed in Table 1 below using the obtained acrylate-based polymer (A1). Each separate film that had been subjected to a surface treatment with a silicone-based release agent was coated with the composition using a die coater, dried in an environment of 90° C. for 1 minute, and irradiated with ultraviolet rays (UV) under the following conditions, thereby obtaining an acrylate-based pressure sensitive adhesive N (pressure sensitive adhesive layer). The composition and film thickness of the acrylate-based pressure sensitive adhesive are listed in Table 1 below. Further, the pressure sensitive adhesive N is a pressure sensitive adhesive layer used for the evaluation of the durability described below.

(UV Irradiation Conditions)
Electrodeless lamp H bulb (Fusion Co., Ltd.)
Illuminance of 600 mW/cm², light dose of 150 mJ/cm²
The UV illuminance and the light dose were measured using “UVPF-36” (manufactured by Eye Graphics Co., Ltd.).

TABLE 1

| | Composition of pressure sensitive adhesive | | | Film |
|---|---|---|---|---|
| | Acrylate- | Isocyanate-based | Silane | thick- |
| | based | crosslinking | coupling | ness |
| | polymer (A1) | agent | agent | (μm) |
| Pressure sensitive | 100 | 1 | 0.2 | 25 |
| adhesive N | | | | |

The details of the components other than the above-described acrylate-based polymer (A1) in Table 1 are as follows.
Isocyanate-based crosslinking agent: trimethylolpropane-modified tolylene diisocyanate (“CORONATE L”, manufactured by Nippon Polyurethane Industry Co., Ltd.)
Silane coupling agent: 3-glycidoxypropyltrimethoxysilane (“KBM-403”, manufactured by Shin-Etsu Chemical Co., Ltd.)

(Preparation of UV Adhesive Composition)

The following UV adhesive composition was prepared.

UV adhesive composition
CEL2021P (manufactured by Daicel Corporation) shown below: 70 parts by mass
1,4-Butanediol diglycidyl ether: 20 parts by mass
2-Ethylhexyl glycidyl ether: 10 parts by mass
CPI-100P: 2.25 parts by mass

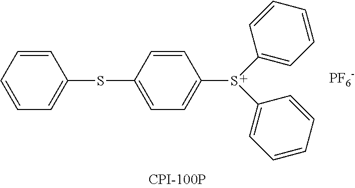

<Preparation of Optical Laminate A1>

The TAC film A1 having the positive A-plate A1 on the phase difference side and the TAC film C1 having the positive C-plate C1 on the phase difference side were bonded to each other by irradiation with UV rays having a light dose of 600 mJ/cm² using the UV adhesive composition. The thickness of the UV adhesive layer was 3 μm. Further, the surfaces bonded to each other with the UV adhesive were respectively subjected to a corona treatment. Next, the photo-alignment film PA10 on the side of the positive A-plate A1 and the cellulose acylate film 1 were removed to obtain a phase difference plate 1.

Next, the laminate A on the oxygen blocking layer side was bonded to a low-reflection surface film CV-LC5 (manufactured by FUJIFILM Corporation) on a support side using Opteria D692 (thickness of 15 μm, storage elastic modulus of 0.004 GPa, manufactured by Lintec Corporation) as a pressure sensitive adhesive A (pressure sensitive adhesive layer 2). Next, only the cellulose acylate film 1 was removed, and the surface after the removal and the phase difference plate 1 on the positive A-plate A1 side were bonded to each other using the pressure sensitive adhesive A (pressure sensitive adhesive layer 1), thereby preparing a laminate of Example 1. Here, the attachment was made such that the angle between the absorption axis of the light absorption anisotropic layer (liquid crystal layer P1) and the slow axis of the positive A-plate A1 reached 45°.

In this manner, an optical laminate A1 of Example 1 including the cellulose acylate film 1, the alignment film PA2, the positive C-plate C1, the UV adhesive layer, the positive A-plate A1 (λ/4 plate), the pressure sensitive adhesive A (the pressure sensitive adhesive layer 1), the photo-alignment film PA1, the liquid crystal layer P1 (light absorption anisotropic layer), the cured layer N1, the oxygen blocking layer B1, the pressure sensitive adhesive A (pressure sensitive adhesive layer 2), and the low-reflection surface film CV-LC5 (surface protective layer) adjacent to each other in this order was obtained.

### Examples 2 to 20 and Comparative Examples 1 to 3

Each laminate and each optical laminate were prepared by the same method as in Example 1 except that the coating solution for forming an alignment film was changed to the composition listed in Table 2 in Examples 2 to 20 and Comparative Examples 1 to 3.

[Evaluation]

The liquid crystal alignment properties and the surface state were evaluated with each of the laminates prepared in Examples 1 to 20 and Comparative Examples 1 to 3, and the durability was evaluated with each of the optical laminates prepared in Examples 1 to 20 and Comparative Examples 1 to 3. These results are listed in Table 2.

[Liquid Crystal Alignment Properties]

Each laminate prepared in Examples 1 to 20 and Comparative Examples 1 to 3 was set on the sample table in a state in which a linear polarizer was inserted on a light source side of an optical microscope (product name, “ECLIPSE E600 POL”, manufactured by Nikon Corporation), the absorbance of the liquid crystal layer (light absorption anisotropic layer) in a wavelength range of 380 nm to 780 nm was measured at a pitch of 1 nm using a multi-channel spectrometer (product name, “QE65000”, manufactured by Ocean Optics, Inc.), and the alignment degree in a wavelength range of 400 nm to 700 nm was calculated by the following equation. Based on the obtained alignment degree, the liquid crystal alignment properties were evaluated according to the following evaluation standards.

Alignment degree: S=((Az0/Ay0)−1)/((Az0/Ay0)+2)

In the equation described above, “Az0” represents the absorbance of the optically anisotropic layer with respect to the polarized light in the absorption axis direction, and “Ay0” represents the absorbance of the optically anisotropic layer with respect to the polarized light in the transmittance axis direction.

A: The alignment degree was 0.96 or greater

B: The alignment degree was 0.90 or greater and less than 0.96

C: The alignment degree was less than 0.90

[Surface State]

Each of the laminates prepared in Examples 1 to 20 and Comparative Examples 1 to 3 was sandwiched between two polarizing plates disposed on crossed nicols and observed, the light absorption anisotropic film was allowed to rotate in a horizontal plane, and the light and dark state was confirmed. The unevenness, the cissing, and the presence or absence of alignment defects during the coating of the upper layer were confirmed based on the light and dark state.

A: Unevenness and cissing were not visually observed as a whole.

B: Unevenness and cissing were partially visually observed.

C: Unevenness and cissing were visually observed as a whole.

[Durability]

The durability of each of the optical laminates prepared in Examples 1 to 20 and Comparative Examples 1 to 3 was evaluated. Specifically, the optical laminate was cut into 10 cm square, and the cellulose acylate film 1 and the alignment film PA2 were removed to expose the positive C-plate C1. Next, the exposed surface of the positive C-plate C1 and an aluminum substrate were bonded to each other using the pressure sensitive adhesive N, allowed to stand in a thermohygrostat at 60° C. and 90% RH for 65 hours, and taken out, and the surface state was visually observed and evaluated according to the following evaluation standards. Further, the surface reflectance of the prepared aluminum substrate was 84%.

AA: Reflection unevenness was not found after the aluminum substrate and the exposed surface were put in the thermohygrostat.

A: Reflection unevenness was almost not found after the aluminum substrate and the exposed surface were put in the thermohygrostat.

B: Reflection unevenness was slightly found after the aluminum substrate and the exposed surface were put in the thermohygrostat.

C: Reflection unevenness was significantly found after the aluminum substrate and the exposed surface were put in the thermohygrostat.

TABLE 2

| | Composition for forming alignment layer | | | | | | | | | | | |
|---|---|---|---|---|---|---|---|---|---|---|---|---|
| | | | | | Content of | | | | Methyl | Evaluation of polarizer | | |
| | | | | | polymer with | SI-B3A | DIPEA | Xylene | isobutyl | Liquid | | |
| | Polymer A | | Polymer B | | respect to 100 | Pasts | Parts | Parts | ketone | crystal | Sur- | |
| | | Parts by | | Parts by | parts by mass | by | by | by | Parts by | alignment | face | |
| | Type | mass | Type | mass | of polymer A | mass | mass | mass | mass | properties | state | Durability |
| Example 1 | A1 | 20 | B1 | 80 | 400 | 12.0 | 0.6 | 750 | 83 | A | A | B |
| Example 2 | A1 | 33 | B1 | 67 | 200 | 8.3 | 0.6 | 750 | 83 | A | A | B |
| Example 3 | A2 | 91 | B2 | 9 | 10 | 8.3 | 0.6 | 750 | 83 | B | B | B |
| Example 4 | A2 | 91 | B3 | 9 | 10 | 8.3 | 0.6 | 750 | 83 | B | B | B |
| Example 5 | A1 | 36 | B4 | 4 | 10 | 8.3 | 0.6 | 750 | 83 | A | B | B |
| Example 6 | A1 | 70 | B4 | 30 | 43 | 8.3 | 0.6 | 750 | 83 | A | A | B |
| Example 7 | A1 | 33 | B4 | 67 | 200 | 8.3 | 0.6 | 750 | 83 | A | A | B |
| Example 8 | A1 | 20 | B4 | 80 | 400 | 8.3 | 0.6 | 750 | 83 | A | A | B |
| Example 9 | A3 | 33 | B5 | 67 | 200 | 8.3 | 0.6 | 750 | 83 | A | A | B |
| Example 10 | A3 | 33 | B6 | 67 | 200 | 8.3 | 0.6 | 750 | 83 | A | A | B |
| Example 11 | A2 | 40 | B7 | 60 | 150 | 11.0 | 0.6 | 750 | 83 | A | A | B |
| Example 12 | A2 | 50 | B8 | 50 | 100 | 8.3 | 0.6 | 750 | 83 | A | A | A |
| Example 13 | A2 | 50 | B9 | 50 | 100 | 8.3 | 0.6 | 750 | 83 | A | A | A |
| Example 14 | A2 | 33 | B10 | 67 | 280 | 8.3 | 0.6 | 750 | 83 | A | A | A |
| Example 15 | 4.2 | 91 | B11 | 9 | 10 | 8.3 | 0.6 | 750 | 83 | A | B | B |
| Example 16 | A2 | 70 | B11 | 30 | 43 | 8.3 | 0.6 | 750 | 83 | A | A | A |
| Example 17 | A2 | 33 | B11 | 67 | 200 | 8.3 | 0.6 | 750 | 83 | A | A | AA |
| Example 18 | A4 | 33 | B11 | 67 | 200 | 8.3 | 0.6 | 750 | 83 | A | A | AA |
| Example 19 | A4 | 33 | B12 | 67 | 200 | 8.3 | 0.6 | 750 | 83 | A | A | B |
| Example 20 | A1 | 71 | B13 | 29 | 40 | 8.3 | 0 6 | 750 | 83 | B | B | B |
| Comparative | A1 | 20 | — | — | — | 8.3 | 0.6 | 750 | 83 | B | C | B |
| Example 1 | | | | | | | | | | | | |
| Comparative | A1 | 33 | B'1 | 67 | 200 | 8.3 | 0 6 | 750 | 83 | C | B | B |
| Example 2 | | | | | | | | | | | | |
| Comparative | A1 | 35 | B'2 | 67 | 200 | 8.3 | 0.6 | 750 | 83 | C | C | C |
| Example 3 | | | | | | | | | | | | |

The structures of the polymer A in Table 2 are shown below.

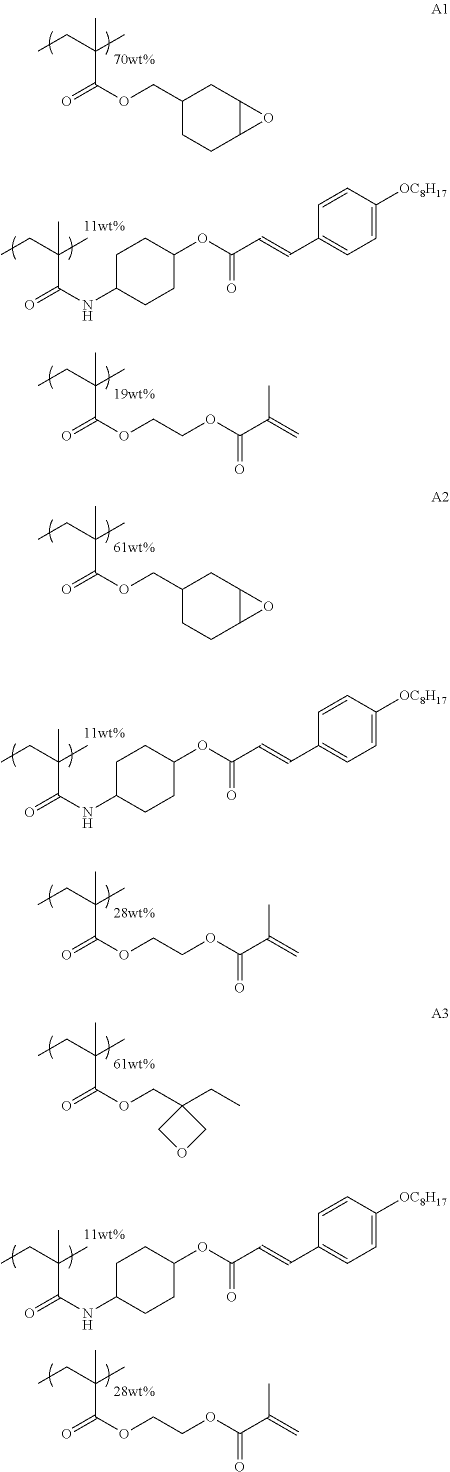

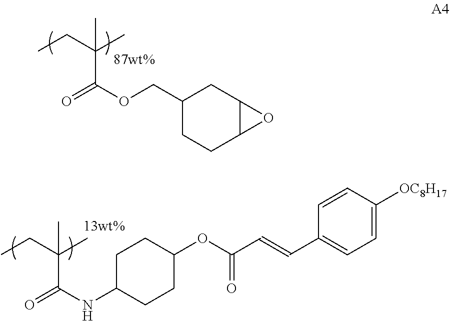

The structural formula of the polymer B in Table 2, the content (% by mass) of the repeating unit, the hydrogen bond element (δh) and the dispersion element (δd) of the Hansen solubility parameter (HSP value), and the Log P value are listed in Tables 3 and 4.

TABLE 3

| | Repeating unit B1 | | | | | Other repeating units | | | | |
|---|---|---|---|---|---|---|---|---|---|---|
| | | | | Hydrogen | | | | | Hydrogen | |
| | | | Dispersion | bond | | | | Dispersion | bond | |
| | | % by | element of | element of | | | % by | element of | element of | |
| | Structure | mass | HSP value | HSP value | Logp | Structure | mass | HSP value | HSP value | LogP |
| B1 | 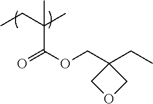 | 80 | 16.8 | 5.3 | 2.1 | 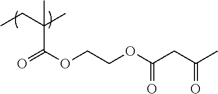 | 20 | 16.8 | 7.6 | 0.6 |
| B2 | 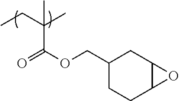 | 60 | 17 | 5.9 | 2.0 | 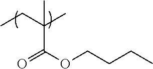 | 40 | 15.9 | 6.4 | 2.8 |
| B3 | 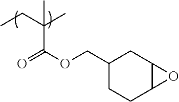 | 60 | 17 | 5.9 | 2.0 | 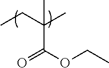 | 40 | 15.8 | 5.6 | 1.6 |
| B4 | 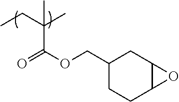 | 60 | 17 | 5.9 | 2.0 | 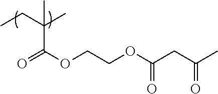 | 40 | 16.8 | 7.6 | 0.6 |
| B5 | 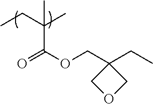 | 80 | 16.8 | 5.3 | 2.1 | 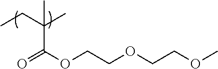 | 20 | 16.2 | 6.4 | 0.5 |
| B6 | 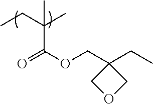 | 100 | 16.8 | 5.3 | 2.1 | | | | | |
| B7 | 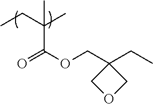 | 60 | 16.8 | 5.3 | 2.1 | 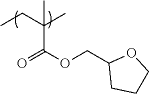 | 40 | 16.8 | 5.7 | 1.5 |

TABLE 4

| | Repeating unit B1 | | | | | Other repeating units | | | | |
|---|---|---|---|---|---|---|---|---|---|---|
| | | | Disper- | Hydro- | | | | Disper- | Hydro- | |
| | | | sion | gen | | | | sion | gen | |
| | | | ele- | bond | | | | ele- | bond | |
| | | % | ment | element | | | % | ment | element | |
| | | by | of HSP | of HSP | | | by | of HSP | of HSP | |
| | Structure | mass | value | value | Logp | Structure | mass | value | value | LogP |
| B8 | 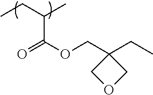 | 60 | 16.9 | 6 | 1.5 | 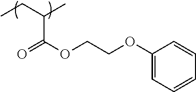 | 40 | 17.9 | 6.4 | 2.3 |
| B9 | 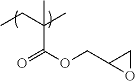 | 40 | 16.8 | 6.4 | 0.6 | 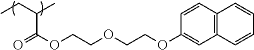 | 60 | 18.6 | 6.6 | 3.3 |
| B10 | 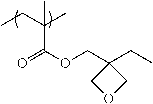 | 60 | 16.8 | 5.3 | 2.1 | 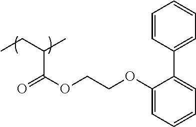 | 40 | 18.6 | 5.1 | 4.2 |
| B11 | 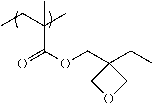 | 40 | 16.8 | 5.3 | 2.1 | 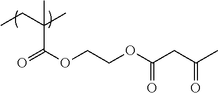 | 40 | 16.8 | 7.6 | 0.6 |
| | | | | | | 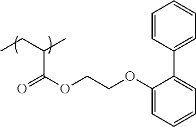 | 20 | 18.6 | 5.1 | 4.2 |
| B12 | 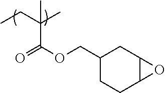 | 100 | 17 | 5.9 | 2.0 | | | | | |
| B13 | 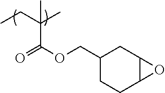 | 40 | 17 | 5.9 | 2.0 | 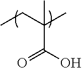 | 10 | 16.1 | 13.4 | 0.7 |
| | | | | | | 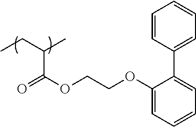 | 50 | 18.6 | 5.1 | 4.2 |

The structural formulae of B1′ and B2′ used in Comparative Examples 2 and 3 in Table 2 are shown below.

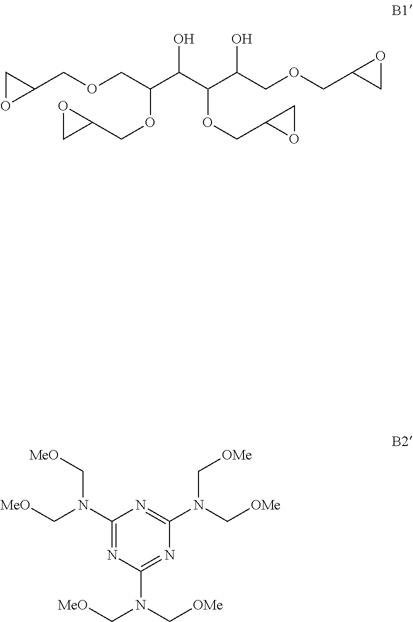 [SMILES: OC(COCC1CO1)C(OCC1CO1)C(O)C(COCC1CO1)OCC1CO1 ; COCN(COC)c1nc(N(COC)COC)nc(N(COC)COC)n1]

As shown in the results of Tables 2 to 4, it was found that in a case where the polymer B was not blended, the liquid crystal alignment properties of the liquid crystal layer provided on the photo-alignment film formed were excellent, but there was room for improvement in the surface state (Comparative Example 1).

Further, it was found that in a case where a compound not corresponding to the polymer B was blended with the composition of Comparative Example 1, the liquid crystal alignment properties of the liquid crystal layer provided on the photo-alignment film formed were poor (Comparative Examples 2 and 3).

On the contrary, it was found that in a case where the polymer A and the polymer B were blended, the surface state was improved while the excellent liquid crystal alignment properties of the liquid crystal layer provided on the photo-alignment film formed were maintained (Examples 1 to 20).

In particular, based on the comparison of Examples 3 to 8, it was found that in a case where the polymer B had greater than 60% by mass of the repeating unit in which the dispersion element (δd) of the HSP value was 16.0 or greater with respect to all the repeating units of the polymer B, the liquid crystal alignment properties of the liquid crystal layer provided on the photo-alignment film formed were further enhanced.

Further, based on the comparison of Examples 11 to 14, 17, and 18, it was found that in a case where the polymer B had 10% by mass or greater of the repeating units having a Log P value of 2.2 or greater with respect to all the repeating units of the polymer B, the durability of the optical laminate including the photo-alignment film formed was improved. Similarly, based on the comparison of Examples 3, 15, and 16, it was found that in a case where the content of the polymer B having 10% by mass or greater of the repeating unit having a Log P value of 2.2 or greater with respect to all the repeating units was greater than 40 parts by mass with respect to 100 parts by mass of the polymer A, the durability of the optical laminate including the photo-alignment film formed was improved.

Further, based on the comparison of Examples 1 to 6, it was found that in a case where the content of the polymer B was greater than 40 parts by mass with respect to 100 parts by mass of the polymer A, the surface state of the liquid crystal layer provided on the photo-alignment film formed was further enhanced.

What is claimed is:

1. A composition for forming a photo-alignment film, comprising:
a polymer A which has a repeating unit A1 containing a photo-aligned group and a repeating unit A2 containing a cationically polymerizable group;
a polymer B which has a repeating unit B1 containing a cationically polymerizable group but does not contain a photo-aligned group; and
at least one acid generator selected from the group consisting of a photoacid generator and a thermal acid generator,
wherein the polymer B has 90% by mass or greater of a repeating unit, in which a hydrogen bond element of a Hansen solubility parameter is less than 10.0, with respect to all repeating units of the polymer B.

2. The composition for forming a photo-alignment film according to claim 1,
wherein the photo-aligned group contained in the repeating unit A1 is a cinnamoyl group.

3. The composition for forming a photo-alignment film according to claim 1,
wherein the cationically polymerizable group of the repeating unit B1 is an epoxy group or an oxetanyl group.

4. The composition for forming a photo-alignment film according to claim 1,
wherein the polymer B has greater than 60% by mass of a repeating unit, in which a dispersion element of the Hansen solubility parameter is 16.0 or greater, with respect to all repeating units of the polymer B.

5. The composition for forming a photo-alignment film according to claim 1,
wherein the polymer B has 10% by mass or greater of a repeating unit having a Log P value of 2.2 or greater, with respect to all repeating units of the polymer B.

6. The composition for forming a photo-alignment film according to claim 1,
wherein a content of the polymer B is greater than 40 parts by mass with respect to 100 parts by mass of the polymer A.

7. The composition for forming a photo-alignment film according to claim 1,
wherein the polymer B has 10% by mass or greater of a repeating unit, in which the hydrogen bond element of the Hansen solubility parameter is 7.0 or greater and less than 10.0, with respect to all repeating units of the polymer B.

8. The composition for forming a photo-alignment film according to claim 1,
wherein the repeating unit B1 is a repeating unit represented by any of Formulae (1) to (4), 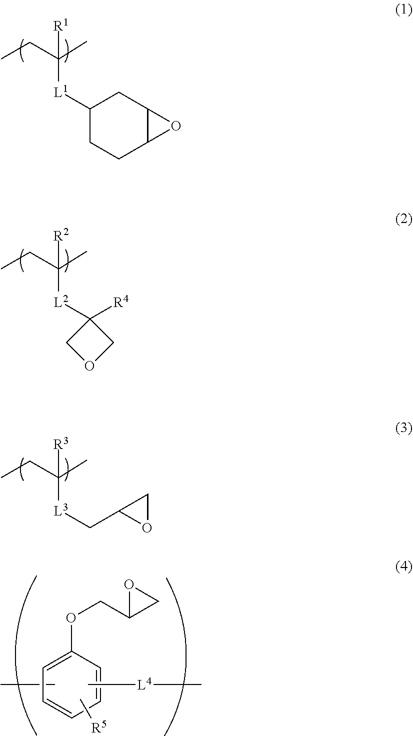
in Formulae (1) to (4),
R¹, R², R³, R⁴, and R⁵ each independently represent a hydrogen atom or a substituent, and
L¹, L², L³, and L⁴ each independently represent a divalent linking group.

9. The composition for forming a photo-alignment film according to claim 1,
wherein the repeating unit B1 is a repeating unit represented by any of Formulae 5 to (7), 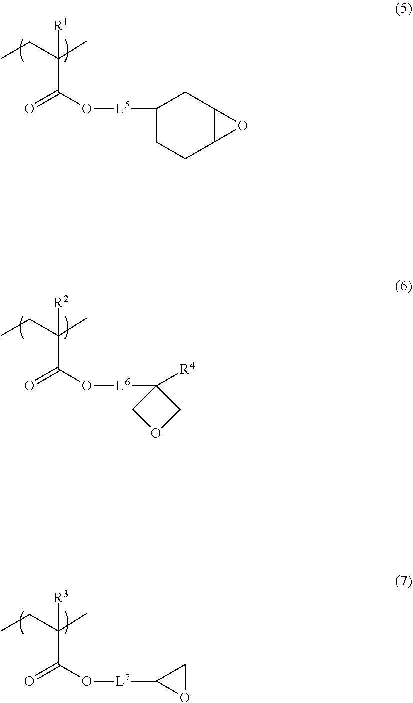
in Formulae (5) to (7),
R¹, R², and R³ each independently represent a hydrogen atom or a substituent, and
L⁵, L⁶, and L⁷ each independently represent a divalent linking group.

10. A photo-alignment film which is formed of the composition for forming a photo-alignment film according to claim 1.

11. An optical laminate comprising:
a photo-alignment film; and
a liquid crystal layer,
wherein the photo-alignment film is the photo-alignment film according to claim 10, and
the liquid crystal layer is a light absorption anisotropic layer containing a dichroic substance.

12. The composition for forming a photo-alignment film according to claim 2,
wherein the cationically polymerizable group of the repeating unit B1 is an epoxy group or an oxetanyl group.

13. The composition for forming a photo-alignment film according to claim 2,
wherein the polymer B has greater than 60% by mass of a repeating unit, in which a dispersion element of the Hansen solubility parameter is 16.0 or greater, with respect to all repeating units of the polymer B.

14. The composition for forming a photo-alignment film according to claim 2,
wherein the polymer B has 10% by mass or greater of a repeating unit having a Log P value of 2.2 or greater, with respect to all repeating units of the polymer B.

15. The composition for forming a photo-alignment film according to claim 2,
wherein a content of the polymer B is greater than 40 parts by mass with respect to 100 parts by mass of the polymer A.

16. The composition for forming a photo-alignment film according to claim 2,
wherein the polymer B has 10% by mass or greater of a repeating unit, in which the hydrogen bond element of the Hansen solubility parameter is 7.0 or greater and less than 10.0, with respect to all repeating units of the polymer B.

17. The composition for forming a photo-alignment film according to claim 2,
wherein the repeating unit B1 is a repeating unit represented by any of Formulae (1) to (4), 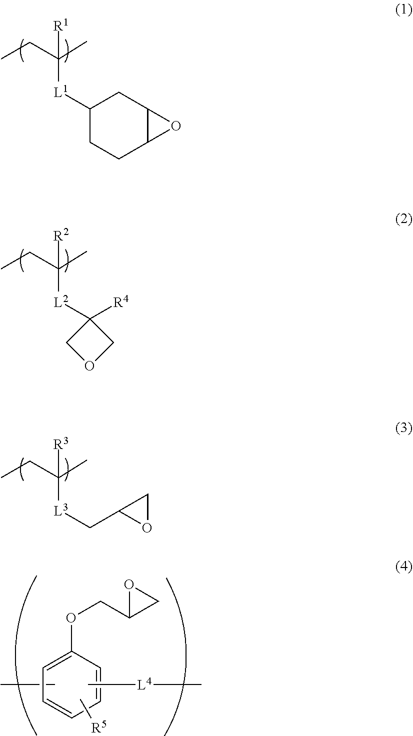
in Formulae (1) to (4),
R¹, R², R³, R⁴, and R⁵ each independently represent a hydrogen atom or a substituent, and
L¹, L², L³, and L⁴ each independently represent a divalent linking group.

18. The composition for forming a photo-alignment film according to claim 2,
wherein the repeating unit B1 is a repeating unit represented by any of Formulae (5) to (7), 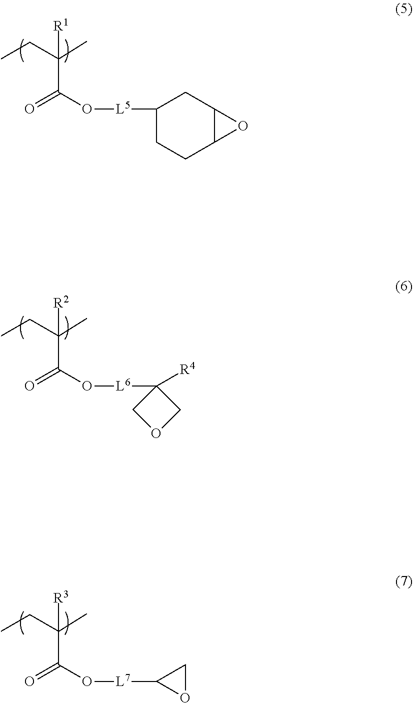
in Formulae (5) to (7),
R¹, R², and R³ each independently represent a hydrogen atom or a substituent, and
L⁵, L⁶, and L⁷ each independently represent a divalent linking group.

19. A photo-alignment film which is formed of the composition for forming a photo-alignment film according to claim 2.

20. An optical laminate comprising:
a photo-alignment film; and
a liquid crystal layer,
wherein the photo-alignment film is the photo-alignment film according to claim 19, and
the liquid crystal layer is a light absorption anisotropic layer containing a dichroic substance.
